(19) United States
(12) Patent Application Publication
(10) Pub. No.: US 2016/0286218 A1
(43) Pub. Date: Sep. 29, 2016

(54) IMAGE ENCODING DEVICE AND METHOD, AND IMAGE DECODING DEVICE AND METHOD

(71) Applicant: SONY CORPORATION, Minato-ku, Tokyo (JP)

(72) Inventor: Kazushi SATO, Kanagawa (JP)

(73) Assignee: SONY CORPORATION, Tokyo (JP)

(21) Appl. No.: 15/034,007

(22) PCT Filed: Dec. 12, 2014
(86) PCT No.: PCT/JP2014/082924

§ 371 Date: May 3, 2016

(30) Foreign Application Priority Data
Dec. 27, 2013 (JP) 2013-272942

(51) Int. Cl. H04N 19/132; H04N 19/187; H04N 19/176; H04N 19/172; H04N 19/174

(52) U.S. Cl. CPC H04N 19/132; H04N 19/172; H04N 19/174; H04N 19/176; H04N 19/187

(57) ABSTRACT

The present disclosure relates to an image encoding device and method, and an image decoding device and method, which are capable of performing an inter-layer associated process smoothly. An enhancement layer image encoding unit sets, when a decoded image of another layer is a reference picture, inter-layer information indicating whether or not the picture is a skip picture or inter-layer information indicating a layer dependency relation when 64 or more layers are included. The enhancement layer image encoding unit performs motion prediction based on the set inter-layer information, and encodes the inter-layer information. The present disclosure can be applied to, for example, an image encoding device that performs a scalable encoding process on image data and an image decoding device that performs a scalable decoding process on image data.

### TECHNICAL FIELD

The present disclosure relates to an image encoding device and method and an image decoding device and method, and more particularly, to an image encoding device and method and an image decoding device and method, which are capable of performing an inter-layer associated process smoothly.

### BACKGROUND ART

Recently, devices for compressing and encoding an image by adopting an encoding scheme of handling image information digitally and performing compression by an orthogonal transform such as a discrete cosine transform and motion compensation using image information-specific redundancy for the purpose of information transmission and accumulation with high efficiency when the image information is handled digitally have become widespread. Moving Picture Experts Group (MPEG), H.264, MPEG-4 Part 10 (Advanced Video Coding) (hereinafter referred to as AVC), and the like are examples of such encoding schemes.

Currently, in order to further improve the encoding efficiency to be higher than in H.264/AVC, Joint Collaboration Team-Video Coding (JCTVC), which is a joint standardization organization of ITU-T and ISO/IEC, has been standardizing an encoding scheme called High Efficiency Video Coding (HEVC) (refer to Non-Patent Document 1).

Meanwhile, the existing image encoding schemes such as MPEG-2 and AVC have a scalability function of dividing an image into a plurality of layers and encoding the plurality of layers.

In other words, for example, for a terminal having a low processing capability such as a mobile telephone, image compression information of only a base layer is transmitted, and a moving image of low spatial and temporal resolutions or a low quality is reproduced, and for a terminal having a high processing capability such as a television or a personal computer, image compression information of an enhancement layer as well as a base layer is transmitted, and a moving image of high spatial and temporal resolutions or a high quality is reproduced. That is, image compression information according to a capability of a terminal or a network can be transmitted from a server without performing the transcoding process.

A scalable extension related to the high efficiency video coding (HEVC) is specified in Non-Patent Document 2. In Non-Patent Documents 1 and 2, layer_id is designated in NAL_unit_header, and the number of layers is designated in a video parameter set (VPS). A syntax related to a layer is indicated by u(6). In other words, a maximum value thereof is 2⁶−1=63. In the VPS, a layer set is specified by the layer_id_included_flag. Further, in the VPS_extension, information indicating whether or not there is a direct dependency relation between layers is transmitted through direct_dependency_flag.

Meanwhile, a skip picture is proposed in Non-Patent Document 3. In other words, if the skip picture is designated in the enhancement layer when the scalable encoding process is performed, an up-sampled image of the base layer is output without change, and the decoding process is not performed on the picture.

As a result, in the enhancement layer, when a load of a CPU is increased, it is possible to reduce a computation amount so that a real-time operation can be performed, and when an overflow of a buffer is likely to occur or when transmission of information about the picture is not performed, it is possible to prevent the occurrence of an overflow.

### CITATION LIST

### Non-Patent Document

Non-Patent Document 1: Benjamin Bross, Woo-Jin Han, Gary J. Sullivan, Jens-Rainer Ohm, Gary J. Sullivan, Ye-Kui Wang, Thomas Wiegand, “High Efficiency Video Coding (HEVC) text specification draft 10 (for FDIS & Consent)”, JCTVC-L1003_v4, Joint Collaborative Team on Video Coding (JCT-VC) of ITU-T SG 16 WP 3 and ISO/IEC JTC 1/SC 29/WG 11 12th Meeting: Geneva, CH, 14-23 Jan. 2013
Non-Patent Document 2: Jianle Chen, Jill Boyce, Yan Ye, Miska M. Hannuksela, “High efficiency video coding (HEVC) scalable extension draft 3”, JCTVC-N1008_v3, Joint Collaborative Team on Video Coding (JCT-VC) of ITU-T SG 16 WP 3 and ISO/IEC JTC 1/SC 29/WG 11 14th Meeting: Vienna, AT, 25 Jul.-2 Aug. 2013
Non-Patent Document 3: Jill Boyce, Xiaoyu Xiu, Yonq He, Yan Ye, “SHVC SKIPPED PICTURE INDICATION”, JCTVC-N0209, September 2013

### SUMMARY OF THE INVENTION

### Problems to be Solved by the Invention

Meanwhile, particularly, at the time of the spatial scalability, when a reference source of a skip picture is another skip picture, an image obtained by performing the up-sampling process twice or more may be output in the enhancement layer. In other words, an image having a resolution much lower than that of a corresponding layer may be output as a decoded image. As described above, it may be difficult to perform an inter-layer associated process smoothly.

The present disclosure was made in light of the foregoing, and it is desirable to enable an inter-layer associated process smoothly.

### Solutions to Problems

An image encoding device according to a first aspect of the present disclosure includes an acquisition unit that acquires inter-layer information indicating whether or not an image of a reference layer referred to by a current image that is subject to an encoding process is a skip mode when the encoding process is performed on an image including three or more layers and an inter-layer information setting unit that sets the current image as the skip mode when the image of the reference layer is the skip mode with reference to the inter-layer information acquired by the acquisition unit, and prohibits execution of the encoding process.

An image encoding method according to the first aspect of the present disclosure includes acquiring, by an image encoding device, inter-layer information indicating whether or not an image of a reference layer referred to by a current image that is subject to an encoding process is a skip mode when the encoding process is performed on an image including three or more layers, setting, by an image encoding device, the current image as the skip mode when the image of the reference layer is the skip mode with reference to the acquired inter-layer information and prohibiting execution of the encoding process.

An image decoding device according to a second aspect of the present disclosure includes an acquisition unit that acquires inter-layer information indicating whether or not an image of a reference layer referred to by a current image that is subject to a decoding process is a skip mode when the decoding process is performed on a bit stream including an encoded image including three or more layers and an inter-layer information setting unit that sets the current image as the skip mode when the image of the reference layer is the skip mode with reference to the inter-layer information acquired by the acquisition unit, and prohibits execution of the decoding process.

An image decoding method according to the second aspect of the present disclosure includes acquiring, by an image decoding device, inter-layer information indicating whether or not an image of a reference layer referred to by a current image that is subject to a decoding process is a skip mode when the decoding process is performed on a bit stream including an encoded image including three or more layers and setting, by the image decoding device, the current image as the skip mode when the image of the reference layer is the skip mode with reference to the acquired inter-layer information and prohibiting execution of the decoding process.

An image encoding device according to a third aspect of the present disclosure includes an acquisition unit that acquires inter-layer information indicating the number of layers of an image including 64 or more layers when an encoding process is performed on the image and an inter-layer information setting unit that sets information related to an extended number of layers in VPS_extension with reference to the inter-layer information acquired by the acquisition unit.

An image encoding method according to third aspect of the present disclosure includes acquiring, by an image encoding device, inter-layer information indicating the number of layers of an image including 64 or more layers when an encoding process is performed on the image and setting, by the image encoding device, information related to the extended number of layers in VPS_extension with reference to the acquired inter-layer information.

An image decoding device according to a fourth aspect of the present disclosure includes a reception unit that receives information related to an extended number of layers set in VPS_extension from a bit stream including an encoded image including 64 or more layers and a decoding unit that performs a decoding process with reference to the information related to the extended number of layers received by the reception unit.

An image decoding method according to the fourth aspect of the present disclosure includes receiving, by an image decoding device, information related to an extended number of layers set in VPS_extension from a bit stream including an encoded image including 64 or more layers and performing, by the image decoding device, a decoding process with reference to the information related to the received extended number of layers.

In the first aspect of the present disclosure, acquired is inter-layer information indicating whether or not an image of a reference layer referred to by a current image that is subject to an encoding process is a skip mode when the encoding process is performed on an image including three or more layers. When the image of the reference layer is the skip mode with reference to the acquired inter-layer information, the current image is set as the skip mode, and execution of the encoding process is prohibited.

In the second aspect of the present disclosure, acquired is inter-layer information indicating whether or not an image of a reference layer referred to by a current image that is subject to a decoding process is a skip mode when the decoding process is performed on a bit stream including an encoded image including three or more layers. When the image of the reference layer is the skip mode with reference to the acquired inter-layer information, the current image is set as the skip mode, and execution of the decoding process is prohibited.

In the third aspect of the present disclosure, acquired is inter-layer information indicating the number of layers of an image including 64 or more layers when an encoding process is performed on the image. Information related to an extended number of layers is set in VPS_extension with reference to the acquired inter-layer information.

In the fourth aspect of the present disclosure, information related to an extended number of layers set in VPS_extension is received from a bit stream including an encoded image including 64 or more layers. A decoding process is performed with reference to the information related to the received extended number of layers.

The image encoding device may be an independent device or may be an internal block configuring a single image processing device or a single image encoding device. Similarly, the image decoding device may be an independent device or may be an internal block configuring a single image processing device or a single image decoding device.

### Effects of the Invention

According to the first and third aspects of the present disclosure, it is possible to encode an image. Particularly, it is possible to perform an inter-layer associated process smoothly.

According to the second and fourth aspects of the present disclosure, it is possible to decode an image. Particularly, it is possible to perform an inter-layer associated process smoothly.

### BRIEF DESCRIPTION OF DRAWINGS

FIG. 1 is a diagram for describing an exemplary configuration of a coding unit.

FIG. 2 is a diagram for describing an example of spatial scalable coding.

FIG. 3 is a diagram for describing an example of temporal scalable coding.

FIG. 4 is a diagram for describing an example of signal to noise ratio (SNR) scalable coding.

FIG. 5 is a diagram illustrating an exemplary syntax of NAL_unit_header.

FIG. 6 is a diagram illustrating an exemplary syntax of a VPS.

FIG. 7 is a diagram illustrating an exemplary syntax of VPS_extension.

FIG. 8 is a diagram illustrating an exemplary syntax of VPS_extension.

FIG. 9 is a block diagram illustrating an exemplary main configuration of a scalable encoding device.

FIG. 10 is a block diagram illustrating an exemplary main configuration of a base layer image encoding unit.

FIG. 11 is a block diagram illustrating an exemplary main configuration of an enhancement layer image encoding unit.

FIG. 12 is a diagram for describing a skip picture.

FIG. 13 is a diagram for describing a skip picture.

FIG. 14 is a diagram for describing a skip picture.

FIG. 15 is a block diagram illustrating an exemplary main configuration of an inter-layer information setting unit.

FIG. 16 is a flowchart for describing an example of the flow of an encoding process.

FIG. 17 is a flowchart for describing an example of the flow of a base layer encoding process.

FIG. 18 is a flowchart for describing an example of the flow of an enhancement layer encoding process.

FIG. 19 is a flowchart for describing an example of the flow of an inter-layer information setting process.

FIG. 20 is a diagram illustrating an exemplary syntax of VPS_extension according to the present technology.

FIG. 21 is a diagram illustrating an exemplary syntax of VPS_extension according to the present technology.

FIG. 22 is a block diagram illustrating an exemplary main configuration of an inter-layer information setting unit.

FIG. 23 is a flowchart for describing an example of the flow of an inter-layer information setting process.

FIG. 24 is a block diagram illustrating an exemplary main configuration of a scalable decoding device.

FIG. 25 is a block diagram illustrating an exemplary main configuration of a base layer image decoding unit.

FIG. 26 is a block diagram illustrating an exemplary main configuration of an enhancement layer image decoding unit.

FIG. 27 is a block diagram illustrating an exemplary main configuration of an inter-layer information reception unit.

FIG. 28 is a flowchart for describing an example of the flow of a decoding process.

FIG. 29 is a flowchart for describing an example of the flow of a base layer decoding process.

FIG. 30 is a flowchart for describing an example of the flow of an enhancement layer decoding process.

FIG. 31 is a flowchart for describing an example of the flow of an inter-layer information reception process.

FIG. 32 is a block diagram illustrating an exemplary main configuration of an inter-layer information reception unit.

FIG. 33 is a flowchart for describing an example of the flow of an inter-layer information reception process.

FIG. 34 is a diagram illustrating an exemplary scalable image coding scheme.

FIG. 35 is a diagram illustrating an exemplary multi-view image coding scheme.

FIG. 36 is a block diagram illustrating an exemplary main configuration of a computer.

FIG. 37 is a block diagram illustrating an exemplary schematic configuration of a television device.

FIG. 38 is a block diagram illustrating an exemplary schematic configuration of a mobile telephone.

FIG. 39 is a block diagram illustrating an exemplary schematic configuration of a recording/reproducing device.

FIG. 40 is a block diagram illustrating an exemplary schematic configuration of an imaging device.

FIG. 41 is a block diagram illustrating a scalable coding application example.

FIG. 42 is a block diagram illustrating another scalable coding application example.

FIG. 43 is a block diagram illustrating another scalable coding application example.

FIG. 44 is a block diagram illustrating an exemplary schematic configuration of a video set.

FIG. 45 is a block diagram illustrating an exemplary schematic configuration of a video processor.

FIG. 46 is a block diagram illustrating another exemplary schematic configuration of a video processor.

### MODE FOR CARRYING OUT THE INVENTION

Hereinafter, modes (hereinafter, referred to as “embodiments”) for carrying out the present disclosure will be described. A description will proceed in the following order.

0. Overview

1. First embodiment (scalable encoding device)

2. Second embodiment (scalable decoding device)

3. Others

4. Third embodiment (computer)

5. Application examples

6. Application example of scalable coding

7. Fourth embodiment (set unit and module processor)

### 0. OVERVIEW

<Coding Scheme>

Hereinafter, the present technology will be described in connection with an application to image encoding and decoding of the high efficiency video coding (HEVC) scheme.

<Coding Unit>

A hierarchical structure based on a macroblock and a sub macroblock is defined in the advanced video coding (AVC). However, a macroblock of 16×16 pixels is not optimal for a large image frame such as an Ultra High Definition (UHD) (4000×2000 pixels) serving as a target of a next generation coding scheme.

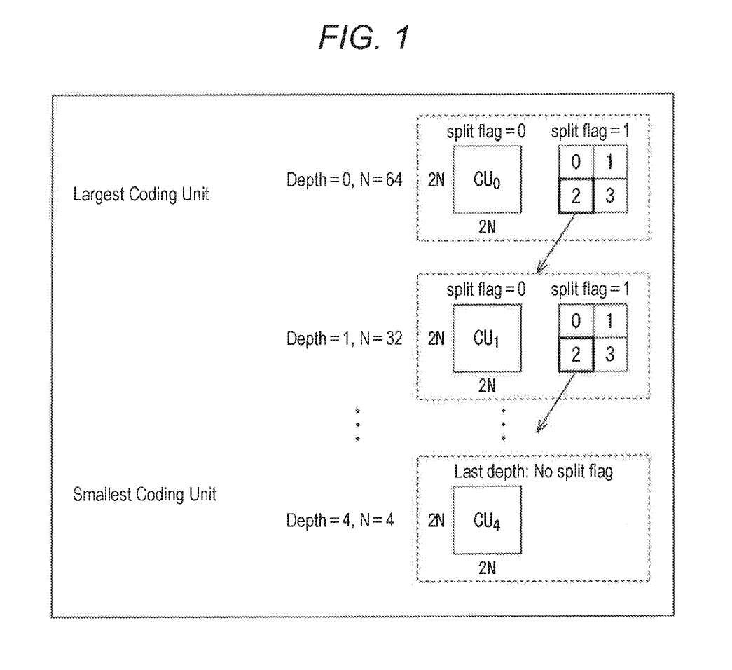

On the other hand, in the HEVC scheme, a coding unit (CU) is defined as illustrated in FIG. 1.

A CU is also referred to as a coding tree block (CTB), and the CU is a partial area of an image of a picture unit undertaking the same role of a macroblock in the AVC scheme. The latter is fixed to a size of 16×16 pixels, but the CU of the former is not fixed and designated in image compression information in each sequence.

For example, a largest coding unit (LCU) and a smallest coding unit (SCU) of a CU are specified in a sequence parameter set (SPS) included in encoded data to be output.

Split-flag=1 is set within a range in which each LCU is not smaller than an SCU, and thus a coding unit can be divided into CUs having a smaller size. In the example of FIG. 1, a size of an LCU is 128, and a largest scalable depth is 5. A CU of a size of 2N×2N is divided into CUs having a size of N×N serving as a layer that is one-level lower when a value of split_flag is 1.

A CU is divided into prediction units (PUs) that are areas (partial areas of an image in units of pictures) serving as processing units of intra or inter prediction and divided into transform units (TUs) that are areas (partial areas of an image in units of pictures) serving as processing units of orthogonal transform. Currently, in the HEVC scheme, any one of 4×4, 8×8, 16×16, and 32×32 can be used as a processing unit of orthogonal transform.

In the case of the coding scheme in which a CU is defined, and various kinds of processes are performed in units of CUs such as the HEVC scheme, a macroblock in the AVC scheme can be considered to correspond to an LCU, and a block (sub block) can be considered to correspond to a CU. A motion compensation block in the AVC scheme can be considered to correspond to a PU. However, since a CU has a hierarchical structure, a size of an LCU of a topmost layer is commonly set to be larger than a macroblock in the AVC scheme, for example, such as 128×128 pixels.

Thus, hereinafter, an LCU is assumed to include a macroblock in the AVC scheme, and a CU is assumed to include a block (sub block) in the AVC scheme. In other words, a “block” used in the following description indicates an arbitrary partial area in a picture, and, for example, a size, shape, and characteristics of a block are not limited. In other words, a “block” includes an arbitrary area (a processing unit) such as a TU, a PU, an SCU, a CU, an LCU, a sub block, a macroblock, or a slice. Of course, a “block” includes any other partial area (processing unit) as well. When it is necessary to limit a size, a processing unit, or the like, it will be appropriately described.

In the present specification, a coding tree unit (CTU) is assumed to be a unit including a coding tree block (CTB) of the LCU (maximum number of CUs) and a parameter used when processing is performed on the LCU base (level). Further, a coding unit (CU) configuring a CTU is assumed to be a unit including a coding block (CB) and a parameter used when processing is performed on the CU base (level).

<Mode Selection>

Meanwhile, in the coding schemes such as the AVC and the HEVC, in order to achieve high coding efficiency, it is important to select an appropriate prediction mode.

As an example of such a selection method, there is a method implemented in reference software (found at http://iphome.hhi.de/suehring/tml/index.htm) of H.264/MPEG-4 AVC called a joint model (JM).

In the JM, it is possible to select two mode determination methods, that is, a high complexity mode and a low complexity mode to be described below. In both modes, cost function values related to the respective prediction modes Mode are calculated, and a prediction mode having a smallest cost function value is selected as an optimal mode for the block to the macroblock.

A cost function in the high complexity mode is represented as in the following Formula (1):

[Mathematical Formula 1]

Cost(ModeεΩ)=D+λ*R (1)

Here, Ω indicates a universal set of a candidate mode for encoding the block to the macroblock, and D indicates differential energy between a decoded image and an input image when encoding is performed in the prediction mode. λ indicates Lagrange's undetermined multiplier given as a function of a quantization parameter. R indicates a total coding amount including orthogonal transform coefficients when encoding is performed in the mode.

In other words, in order to perform encoding in the high complexity mode, it is necessary to perform a temporary encoding process once in all candidate modes in order to calculate the parameters D and R, and thus a large computation amount is required.

A cost function in the low complexity mode is represented by the following Formula (2):

[Mathematical Formula 2]

Cost(ModeεΩ)=DQP2Quant(QP)*HeaderBit (2)

Here, D indicates differential energy between a predicted image and an input image unlike the high complexity mode. QP2Quant(QP) is given as a function of a quantization parameter QP, and HeaderBit indicates a coding amount related to information belonging to a header such as a motion vector or a mode including no orthogonal transform coefficients.

In other words, in the low complexity mode, it is necessary to perform a prediction process in respective candidate modes, but since up to a decoded image is not necessary, it is unnecessary to perform up to an encoding process. Thus, it can be implemented with a computation amount smaller than that in the high complexity mode.

<Scalable Coding>

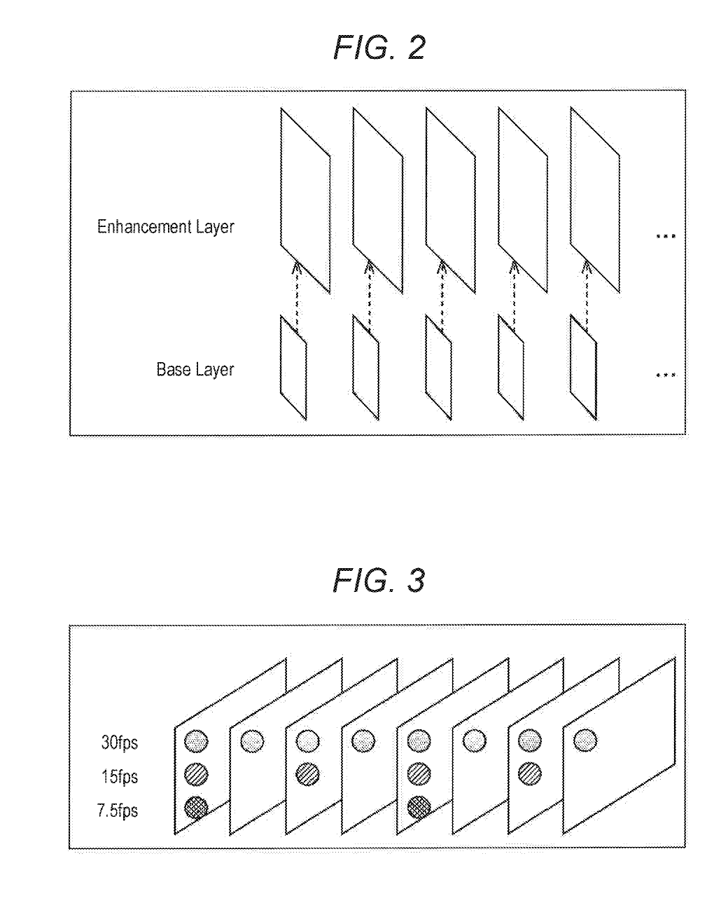

Meanwhile, the image encoding schemes such as the MPEG2 and the AVC have a scalability function as illustrated in FIGS. 2 to 4. Scalable coding refers to a scheme of dividing (hierarchizing) an image into a plurality of layers and performing encoding for each layer.

In hierarchization of an image, an image is divided into a plurality of images (layers) based on a predetermined parameter. Basically, each layer is configured with differential data so that redundancy is reduced. For example, when one image is divided into two layers, that is, a base layer and an enhancement layer, an image of a quality lower than an original image is obtained using only data of the base layer, and an original image (that is, a high quality image) is obtained by combining both data of the base layer and data of the enhancement layer.

As an image is hierarchized as described above, images of various qualities can be easily obtained depending on the situation. For example, for a terminal having a low processing capability such as a mobile telephone, image compression information of only the base layer is transmitted, and a moving image of low spatial and temporal resolutions or a low quality is reproduced, and for a terminal having a high processing capability such as a television or a personal computer, image compression information of the enhancement layer as well as the base layer is transmitted, and a moving image of high spatial and temporal resolutions or a high quality is reproduced. In other words, without performing the transcoding process, image compression information according to a capability of a terminal or a network can be transmitted from a server.

As a parameter having scalability, for example, there is a spatial resolution (spatial scalability) as illustrated in FIG. 2. In the case of the spatial scalability, respective layers have different resolutions. In other words, each picture is hierarchized into two layers, that is, a base layer of a resolution spatially lower than that of an original image and an enhancement layer that is combined with the image of the base layer to obtain an original image (original spatial resolution) as illustrated in FIG. 2. Of course, the number of layers is an example, and each picture can be hierarchized into an arbitrary number of layers.

As another parameter having such scalability, for example, there is a temporal resolution (temporal scalability) as illustrated in FIG. 3. In the case of the temporal scalability, respective layers have different frame rates. In other words, in this case, as illustrated in FIG. 3, an image is hierarchized into layers having different frame rates, a moving image of a high frame rate can be obtained by adding the layer of the high frame rate to the layer of the low frame rate, and an original moving image (an original frame rate) can be obtained by combining all the layers. The number of layers is an example, and each image can be hierarchized into an arbitrary number of layers.

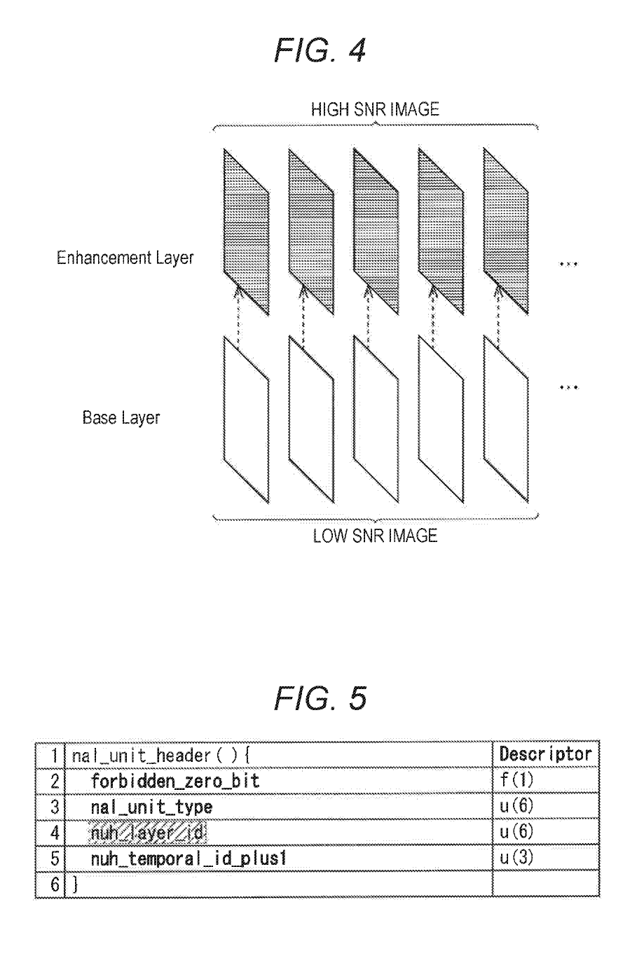

As another parameter having such scalability, for example, there is a signal-to-noise ratio (SNR) (SNR scalability). In the case of the SNR scalability, respective layers have different SNRs. In other words, each picture is hierarchized into two layers, that is, a base layer of a SNR lower than that of an original image and an enhancement layer that is combined with the image of the base layer to obtain an original image (original SNR) as illustrated in FIG. 4. In other words, information related to an image of a low PSNR is transmitted as base layer image compression information, and a high SNR image can be reconstructed by combining the enhancement layer image compression information. Of course, the number of layers is an example, and each picture can be hierarchized into an arbitrary number of layers.

A parameter other than the above-described examples may be applied as a parameter having scalability. For example, there is bit-depth scalability in which the base layer includes an 8-bit image, and a 10-bit image can be obtained by adding the enhancement layer to the base layer.

Further, there is chroma scalability in which the base layer includes a component image of a 4:2:0 format, and a component image of a 4:2:2 format is obtained by adding the enhancement layer to the base layer.

Further, there is a multi-view as a parameter having scalability. In this case, an image is hierarchized into layers of different views.

The layers described in the present embodiment include spatial, temporal, SNR, bit depth, color, and view of scalability coding described above.

Further, a term “layer” used in this specification includes a layer of scalable coding and each view when a multi-view of a multi-view is considered.

Further, the term “layer” used in this specification is assumed to include a main layer (corresponding to sub) and a sublayer. As a specific example, a main layer may be a layer of spatial scalability, and a sublayer may be configured with a layer of temporal scalability.

In the present embodiment, a layer (Japanese) and a layer have the same meaning, a layer (Japanese) will be appropriately described as a layer.

<Syntax in Scalable Extension>

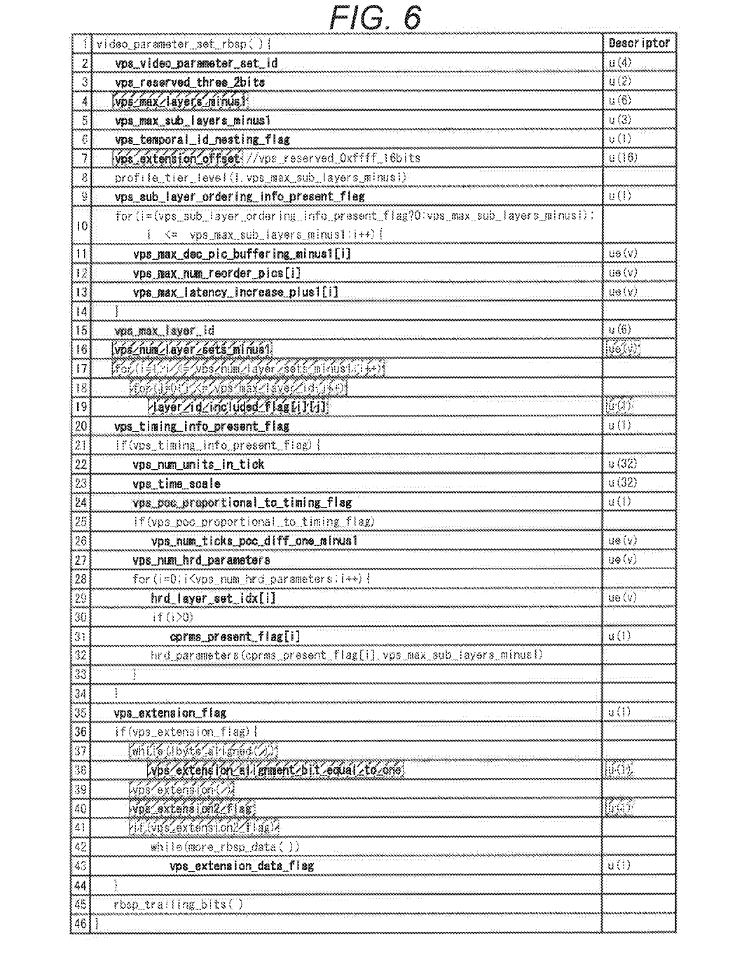

Scalable extension in the HEVC is specified in Non-Patent Document 2. In Non-Patent Documents 1 and 2, layer_id is designated in NAL_unit_header as illustrated in FIG. 5, and the number of layers is designated in the VPS (Video_Parameter_Set) as illustrated in FIG. 6.

FIG. 5 is a diagram illustrating an exemplary syntax of NAL_unit_header. Numbers at the left side are given for the sake of convenience of description. In an example of FIG. 5, nuh_layer_id for designating a layer id is described in a 4th line.

FIG. 6 is a diagram illustrating an exemplary syntax of the VPS. Numbers at the left side are given for the sake of convenience of description. In an example of FIG. 6, vps_max_layers_minus1 for designating a maximum of the number of layers included in a bit stream is described in a 4th line. vps_extension_offset is described in a 7th line.

vps_num_layer_sets_minus1 is described as the number of layer sets in 16th to 18th lines. layer_id_included_flag for specifying a layer set is described in a 19th line. Further, information related to vpe_extension is described in 37th to 41st lines.

As illustrated in the 4th line of FIG. 5 and the 4th line of FIG. 6, a syntax related to a layer is indicated by u(6). In other words, a maximum value thereof is 2⁶−1=63. As illustrated in the 19th line of FIG. 6, in the VPS, a layer set is specified by layer_id_included_flag.

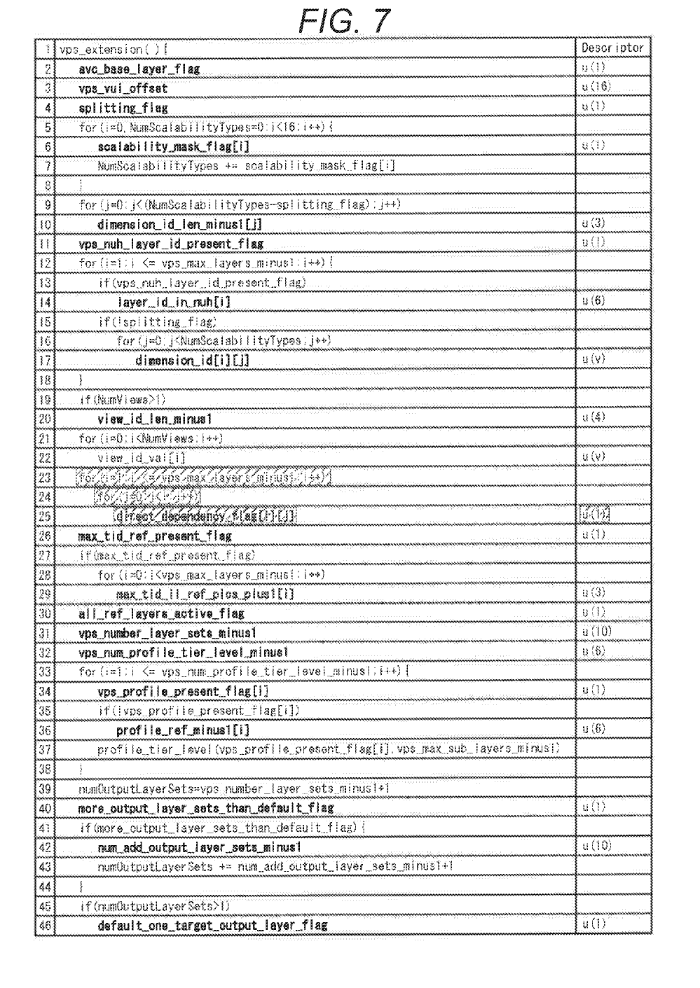

Further, as illustrated in FIG. 7, in VPS_extension, information indicating whether or not there is a direct dependency relation between layers is transmitted through direct_dependency_flag.

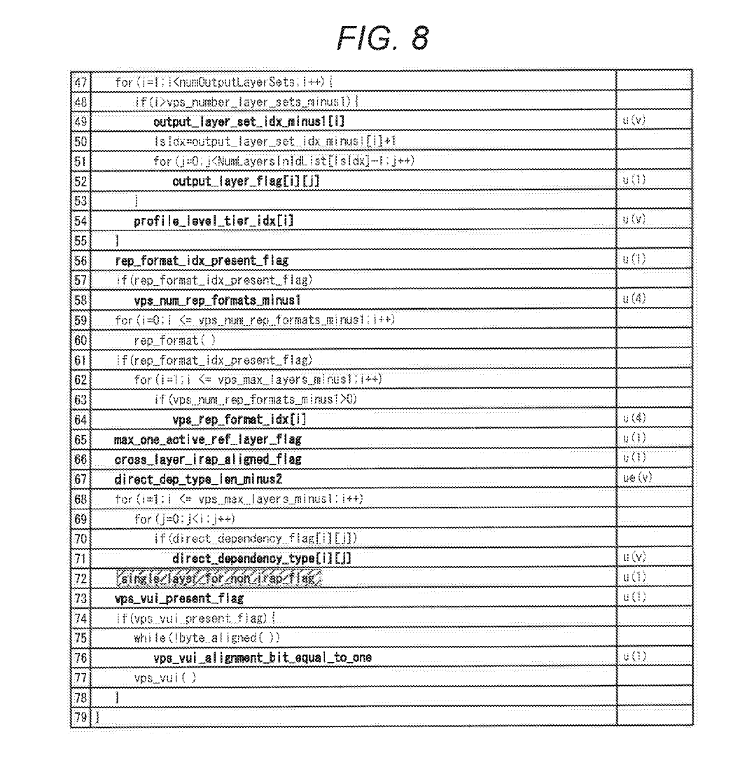

FIGS. 7 and 8 are diagrams illustrating an exemplary syntax of VPS_extension. Numbers at the left side are given for the sake of convenience of description. In the example of FIGS. 7 and 8, direct_dependency_flag is described in 23rd to 25th lines as the information indicating whether or not there is a direct dependency relation between layers.

As described above, in the scalable coding scheme specified in Non-Patent Document 2, a maximum of the number of layers that can be set is 63. In other words, an application including 63 or more layers such as a super multi-view image is not supported.

<Skip Picture>

Further, the following skip picture is proposed in Non-Patent Document 3. In other words, when the scalable encoding process is performed, if a skip picture is designated in the enhancement layer, an up-sampled image of the base layer is output without change, and the decoding process is not performed on the picture.

As a result, in the enhancement layer, when a load of a CPU is increased, it is possible to reduce a computation amount so that a real-time operation can be performed, and when an overflow of a buffer is likely to occur or when transmission of information about the picture is not performed, it is possible to prevent the occurrence of an overflow.

However, at the time of the spatial scalability, when a reference source of a skip picture is a skip picture, an image obtained by performing the up-sampling process twice or more may be output in the enhancement layer. In this case, an image having a resolution much lower than that of a corresponding layer may be output as a decoded image.

As described above, as the number of layers is increased, it becomes difficult to cope with it in the existing standard, and it is necessary to set inter-layer information. In this regard, in the present technology, necessary inter-layer information is set.

### 1. FIRST EMBODIMENT

### Scalable Encoding Device

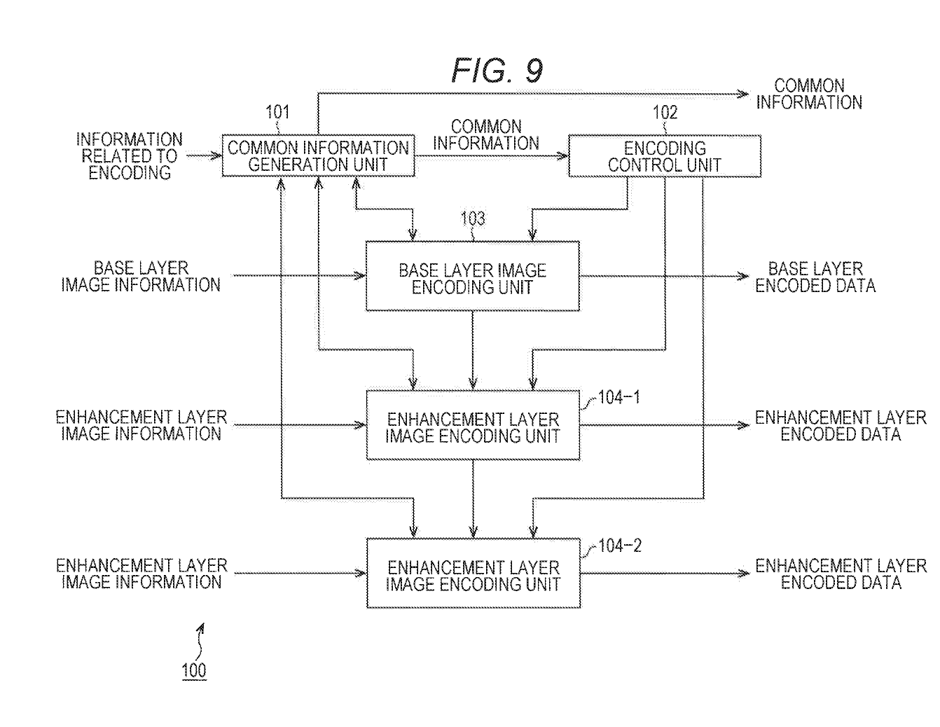

FIG. 9 is a block diagram illustrating an exemplary main configuration of a scalable encoding device.

A scalable encoding device 100 illustrated in FIG. 9 is an image information processing device that performs scalable encoding on image data, and encodes layers of image data hierarchized into the base layer and the enhancement layer.

A parameter (a parameter having scalability) used as a criterion of hierarchization is arbitrary. A scalable encoding device 100 includes a common information generation unit 101, an encoding control unit 102, a base layer image encoding unit 103, an enhancement layer image encoding unit 104-1, and an enhancement layer image encoding unit 104-2. Further, when it is unnecessary to distinguish particularly, the enhancement layer image encoding units 104-1 and 104-2 are referred to collectively as an enhancement layer image encoding unit 104. In an example of FIG. 9, the number of enhancement layer image encoding units 104 is 2 but may be two or more.

The common information generation unit 101 acquires, for example, information related to encoding of image data stored in a NAL unit. The common information generation unit 101 acquires necessary information from the base layer image encoding unit 103, the enhancement layer image encoding unit 104, and the like as necessary. The common information generation unit 101 generates common information serving as information related to all layers based on the information. The common information includes, for example, the VPS and the like. The common information generation unit 101 outputs the generated common information to the outside of the scalable encoding device 100, for example, as the NAL unit. The common information generation unit 101 supplies the generated common information to the encoding control unit 102 as well. In addition, the common information generation unit 101 supplies all or a part of the generated common information to the base layer image encoding unit 103 and the enhancement layer image encoding unit 104 as well as necessary.

The encoding control unit 102 controls encoding of each layer by controlling the base layer image encoding unit 103 and the enhancement layer image encoding unit 104 based on the common information supplied from the common information generation unit 101.

The base layer image encoding unit 103 acquires image information (base layer image information) of the base layer. The base layer image encoding unit 103 encodes the base layer image information without using information of another layer, and generates and outputs encoded data (base layer encoded data) of the base layer.

The enhancement layer image encoding unit 104 acquires image information (enhancement layer image) of the enhancement layer, and encodes the enhancement layer image information. Here, for the sake of convenience of description, the enhancement layers are divided into a current layer being currently processed and a reference layer referred in the current layer.

The enhancement layer image encoding unit 104 acquires image information (the current layer image information) of the current layer (the enhancement layer), and encodes the current layer image information with reference to another layer (the base layer or the enhancement layer which has been encoded first) as necessary.

When a decoded image of another layer is used as the reference picture, the enhancement layer image encoding unit 104 sets inter-layer information necessary for performing a process between layers, that is, inter-layer information indicating whether or not the picture is the skip picture or inter-layer information indicating a layer dependency relation when 64 or more layers are included.

The enhancement layer image encoding unit 104 performs motion prediction by using or prohibiting a skip picture mode at the time of motion prediction based on the set inter-layer information, and encodes the inter-layer information. Alternatively, the enhancement layer image encoding unit 104 performs the motion prediction based on the set inter-layer information, and encodes the inter-layer information.

Further, when the image information of the enhancement layer is encoded, the enhancement layer image encoding unit 104 acquires another enhancement layer decoded image (or a base layer decoded image), performs up-sampling on another enhancement layer decoded image (or a base layer decoded image), and uses an up-sampled image as the reference picture for the motion prediction.

The enhancement layer image encoding unit 104 generates encoded data of the enhancement layer by such encoding, and outputs the generated encoded data of the enhancement layer.

[Base Layer Image Encoding Unit]

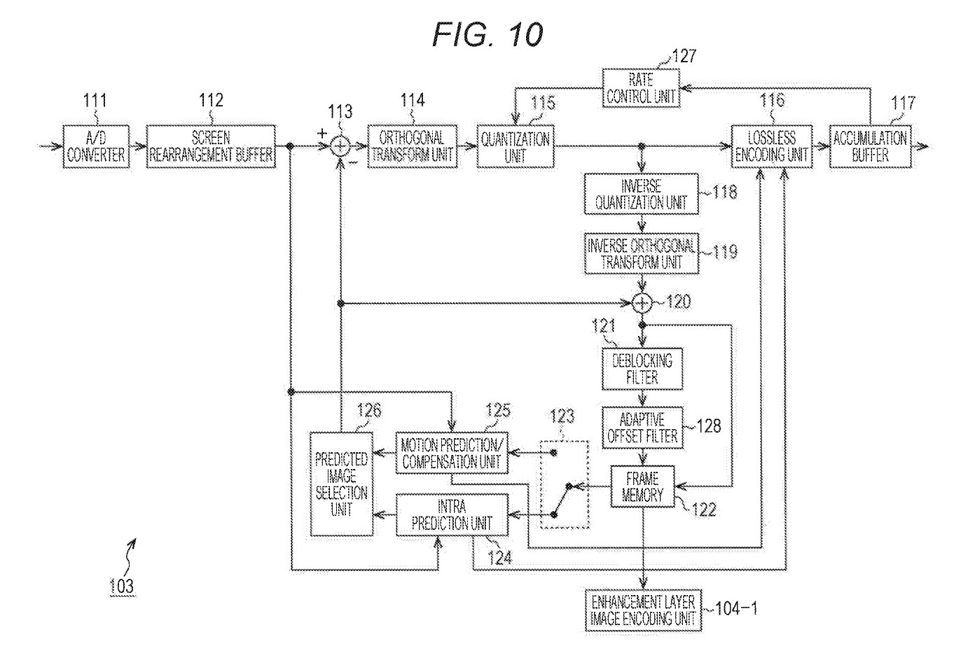

FIG. 10 is a block diagram illustrating an exemplary main configuration of the base layer image encoding unit 103 of FIG. 9. The base layer image encoding unit 103 includes an A/D converter 111, a screen rearrangement buffer 112, an operation unit 113, an orthogonal transform unit 114, a quantization unit 115, a lossless encoding unit 116, an accumulation buffer 117, an inverse quantization unit 118, and an inverse orthogonal transform unit 119 as illustrated in FIG. 10. The base layer image encoding unit 103 includes an operation unit 120, a deblocking filter 121, a frame memory 122, a selection unit 123, an intra prediction unit 124, a motion prediction/compensation unit 125, a predicted image selection unit 126, and a rate control unit 127. The base layer image encoding unit 103 further includes an adaptive offset filter 128 between the deblocking filter 121 and the frame memory 122.

The A/D converter 111 performs A/D conversion on input image data (the base layer image information), and supplies the converted image data (digital data) to be stored in the screen rearrangement buffer 112. The screen rearrangement buffer 112 rearranges the stored image of the display frame order in the encoding frame order according to the group of picture (GOP), and outputs the image in which the order of the frames is rearranged to the operation unit 113. The screen rearrangement buffer 112 supplies the image in which the order of the frames is rearranged to the intra prediction unit 124 and the motion prediction/compensation unit 125 as well.

The operation unit 113 subtracts a predicted image supplied from the intra prediction unit 124 or the motion prediction/compensation unit 125 through the predicted image selection unit 126 from an image read from the screen rearrangement buffer 112, and outputs differential information thereof to the orthogonal transform unit 114. For example, in the case of an image that has undergone intra encoding, the operation unit 113 subtracts the predicted image supplied from the intra prediction unit 124 from the image read from the screen rearrangement buffer 112. Further, for example, in the case of the image that has undergone inter coding, the operation unit 113 subtracts the predicted image supplied from the motion prediction/compensation unit 125 from the image read from the screen rearrangement buffer 112.

The orthogonal transform unit 114 performs orthogonal transform such as discrete cosine transform or Karhunen-Loeve Transform on the differential information supplied from the operation unit 113. The orthogonal transform unit 114 supplies transform coefficients to the quantization unit 115.

The quantization unit 115 performs quantization on the transform coefficients supplied from the orthogonal transform unit 114. The quantization unit 115 sets a quantization parameter based on information related to a target value of a coding amount supplied from the rate control unit 127, and performs the quantization. The quantization unit 115 supplies the quantized transform coefficients to the lossless encoding unit 116.

The lossless encoding unit 116 encodes the transform coefficients quantized in the quantization unit 115 according to an arbitrary coding scheme. Since coefficient data is quantized under control of the rate control unit 127, the coding amount becomes the target value (or approximates to the target value) set by the rate control unit 127.

The lossless encoding unit 116 acquires information indicating an intra prediction mode or the like from the intra prediction unit 124, and acquires information indicating an inter prediction mode, differential motion vector information, and the like from the motion prediction/compensation unit 125. The lossless encoding unit 116 appropriately generates the NAL unit of the base layer including a sequence parameter set (SPS), a picture parameter set (PPS), and the like. Although not illustrated, the lossless encoding unit 116 supplies information necessary when the enhancement layer image encoding unit 104-1 sets the inter-layer information to the enhancement layer image encoding unit 104-1.

The lossless encoding unit 116 encodes various kinds of information according to an arbitrary coding scheme, and includes (multiplexes) the encoded information in encoded data (also referred to as an “encoded stream”). The lossless encoding unit 116 supplies the encoded data obtained by the encoding to be accumulated in the accumulation buffer 117.

Examples of an encoding scheme of the lossless encoding unit 116 include variable length coding and arithmetic coding. As the variable length coding, for example, context-adaptive variable length coding (CAVLC) stated in the H.264/AVC scheme is used. As the arithmetic coding, for example, context-adaptive binary arithmetic coding (CABAC) is used.

The accumulation buffer 117 temporarily holds the encoded data (the base layer encoded data) supplied from the lossless encoding unit 116. The accumulation buffer 117 outputs the held base layer encoded data, for example, to a recording device (recording medium) (not illustrated) at a subsequent stage, a transmission path, or the like at a predetermined timing. In other words, the accumulation buffer 117 is a transmission unit that transmits the encoded data.

The transform coefficients quantized in the quantization unit 115 are also supplied to the inverse quantization unit 118. The inverse quantization unit 118 performs inverse quantization on the quantized transform coefficients according to a method corresponding to the quantization performed by the quantization unit 115. The inverse quantization unit 118 supplies the obtained transform coefficients to the inverse orthogonal transform unit 119.

The inverse orthogonal transform unit 119 performs inverse orthogonal transform on the transform coefficients supplied from the inverse quantization unit 118 according to a method corresponding to the orthogonal transform process performed by the orthogonal transform unit 114. An output (restored differential information) obtained by performing the inverse orthogonal transform is supplied to the operation unit 120.

The operation unit 120 obtains a locally decoded image (decoded image) by adding the predicted image supplied from the intra prediction unit 124 or the motion prediction/compensation unit 125 through the predicted image selection unit 126 to the restored differential information serving as the inverse orthogonal transform result supplied from the inverse orthogonal transform unit 119. The decoded image is supplied to the deblocking filter 121 or the frame memory 122.

The deblocking filter 121 removes block distortion of the reconstructed image by performing a deblocking filter process on the reconstructed image supplied from the operation unit 120. The deblocking filter 121 supplies the image that has undergone the filter process to the adaptive offset filter 128.

The adaptive offset filter 128 performs an adaptive offset filter (sample adaptive offset (SAO)) process for mainly removing ringing on the deblocking filter process result (the reconstructed image from which the block distortion has been removed) supplied from the deblocking filter 121.

More specifically, the adaptive offset filter 128 decides a type of adaptive offset filter process for each largest coding unit (LCU), and obtains an offset used in the adaptive offset filter process. The adaptive offset filter 128 performs the decided type of adaptive offset filter process on the image that has undergone the adaptive deblocking filter process using the obtained offset. Then, the adaptive offset filter 128 supplies the image that has undergone the adaptive offset filter process (hereinafter, referred to as a “decoded image”) to the frame memory 122.

The deblocking filter 121 and the adaptive offset filter 128 supply information such as the filter coefficient used in the filter process to the lossless encoding unit 116 so that the information is encoded as necessary. An adaptive loop filter may be arranged at a subsequent stage to the adaptive offset filter 128.

The frame memory 122 stores the reconstructed image supplied from the operation unit 120 and the decoded image supplied from the adaptive offset filter 128. The frame memory 122 supplies the stored reconstructed image to the intra prediction unit 124 through the selection unit 123 at a predetermined timing or a request from the outside such as the intra prediction unit 124. The frame memory 122 supplies the stored decoded image to the motion prediction/compensation unit 125 through the selection unit 123 at a predetermined timing or based on a request from the outside such as the motion prediction/compensation unit 125.

The frame memory 122 stores the supplied decoded image, and supplies the stored decoded image to the selection unit 123 as the reference image at a predetermined timing. The base layer decoded image of the frame memory 122 is supplied to the enhancement layer image encoding unit 104-1 or the enhancement layer image encoding unit 104-2 as the reference picture as necessary.

The selection unit 123 selects a supply destination of the reference image supplied from the frame memory 122. For example, in the case of the intra prediction, the selection unit 123 supplies the reference image (pixel values of the current picture) supplied from the frame memory 122 to the motion prediction/compensation unit 125. Further, for example, in the case of the inter prediction, the selection unit 123 supplies the reference image supplied from the frame memory 122 to the motion prediction/compensation unit 125.

The intra prediction unit 124 performs the intra prediction (intra-screen prediction) of generating the predicted image using the pixel values of the current pictures serving as the reference image supplied from the frame memory 122 through the selection unit 123. The intra prediction unit 124 performs the intra prediction in a plurality of intra prediction modes that are prepared in advance.

The intra prediction unit 124 generates the predicted images in all the intra prediction modes serving as a candidate, evaluates the cost function values of the predicted images using the input image supplied from the screen rearrangement buffer 112, and selects an optimal mode. When the optimal intra prediction mode is selected, the intra prediction unit 124 supplies the predicted image generated in the optimal mode to the predicted image selection unit 126.

Further, as described above, the intra prediction unit 124 appropriately supplies the intra prediction mode information indicating the employed intra prediction mode and the like to the lossless encoding unit 116 so that the intra prediction mode information is encoded.

The motion prediction/compensation unit 125 performs the motion prediction (the inter prediction) using the input image supplied from the screen rearrangement buffer 112 and the reference image supplied from the frame memory 122 through the selection unit 123. The motion prediction/compensation unit 125 performs the motion compensation process according to a detected motion vector, and generates the predicted image (inter predicted image information). The motion prediction/compensation unit 125 performs the inter prediction in a plurality of inter prediction modes that are prepared in advance.

The motion prediction/compensation unit 125 generates the predicted images in all the inter prediction modes serving as a candidate. The motion prediction/compensation unit 125 evaluates the cost function values of the predicted images using the input image supplied from the screen rearrangement buffer 112, information of a generated differential motion vector, and the like, and selects an optimal mode. When an optimal inter prediction mode is selected, the motion prediction/compensation unit 125 supplies the predicted image generated in the optimal mode to the predicted image selection unit 126.

When information indicating the employed inter prediction mode or the encoded data is decoded, the motion prediction/compensation unit 125 supplies, for example, information necessary for performing the process in the inter prediction mode to the lossless encoding unit 116 so that the information is encoded. Examples of the necessary information include the information of the generated differential motion vector and a flag indicating an index of a prediction motion vector as prediction motion vector information.

The predicted image selection unit 126 selects a supply source of the predicted image to be supplied to the operation unit 113 or the operation unit 120. For example, in the case of the intra encoding, the predicted image selection unit 126 selects the intra prediction unit 124 as the supply source of the predicted image, and supplies the predicted image supplied from the intra prediction unit 124 to the operation unit 113 or the operation unit 120. Further, for example, in the case of the inter encoding, the predicted image selection unit 126 selects the motion prediction/compensation unit 125 as the supply source of the predicted image, and supplies the predicted image supplied from the motion prediction/compensation unit 125 to the operation unit 113 or the operation unit 120.

The rate control unit 127 controls a rate of the quantization operation of the quantization unit 115 based on the coding amount of the encoded data accumulated in the accumulation buffer 117 so that an overflow or an underflow does not occur.

[Enhancement Layer Image Encoding Unit]

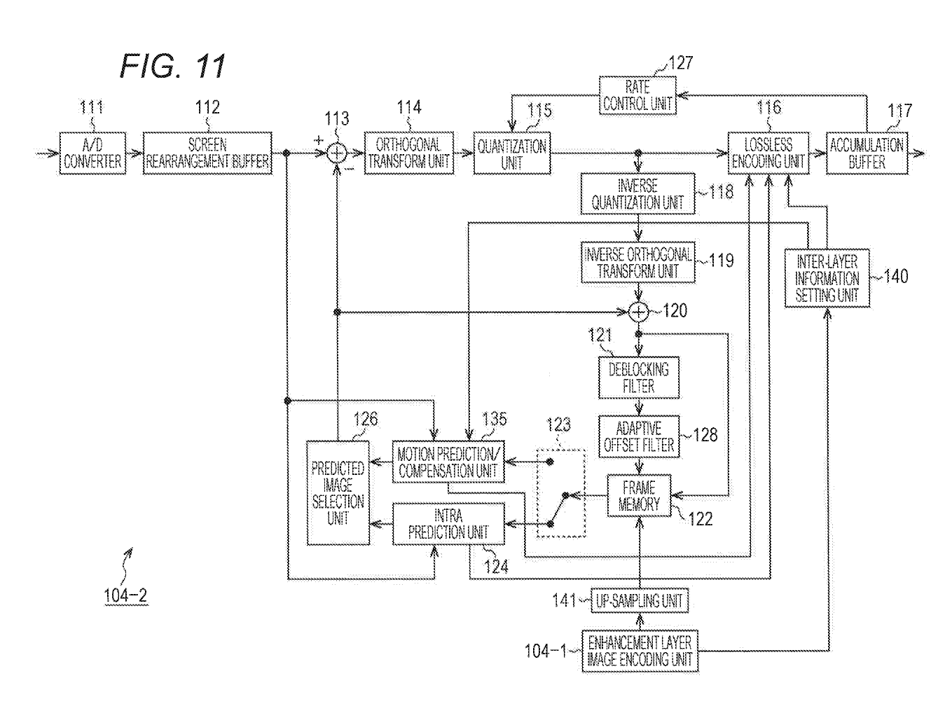

FIG. 11 is a block diagram illustrating an exemplary main configuration of the enhancement layer image encoding unit 104-2 of FIG. 9. The enhancement layer image encoding unit 104-1 has the same configuration as the enhancement layer image encoding unit 104-2 of FIG. 11, and thus a description thereof is omitted. The enhancement layer image encoding unit 104-2 has basically a similar configuration as the base layer image encoding unit 103 of FIG. 10 as illustrated in FIG. 11.

However, respective units of the enhancement layer image encoding unit 104-2 perform a process of encoding current layer image information among the enhancement layers other than the base layer. In other words, the A/D converter 111 of the enhancement layer image encoding unit 104-2 performs A/D conversion on the current layer image information, the accumulation buffer 117 of the enhancement layer image encoding unit 104-2 outputs current layer encoded data, for example, to a recording device (recording medium) (not illustrated) at a subsequent stage, a transmission path, or the like. Although not illustrated, when the enhancement layer image encoding unit 104-2 functions as a reference layer, the lossless encoding unit 116 supplies information necessary when an enhancement layer image encoding unit 104-3 sets the inter-layer information, for example, to the enhancement layer image encoding unit 104-3. In this case, the decoded image of the frame memory 122 is supplied to the enhancement layer image encoding unit 104-3 as the reference picture as necessary.

The enhancement layer image encoding unit 104-2 includes a motion prediction/compensation unit 135 instead of the motion prediction/compensation unit 125. Unlike the base layer image encoding unit 103, an inter-layer information setting unit 140 and an up-sampling unit 141 are added to the enhancement layer image encoding unit 104-2.

The motion prediction/compensation unit 135 performs motion prediction and compensation according to the inter-layer information set by the inter-layer information setting unit 140. In other words, the motion prediction/compensation unit 135 performs basically a similar process to that of the motion prediction/compensation unit 125 except that it refers to the inter-layer information set by the inter-layer information setting unit 140.

The inter-layer information setting unit 140 acquires information related to the reference layer from the enhancement layer image encoding unit 104-1 (or the base layer image encoding unit 103), and sets the inter-layer information that is information necessary for a process between a reference layer and a current layer based on the acquired information related to the reference layer. The inter-layer information setting unit 140 supplies the set inter-layer information to the motion prediction/compensation unit 135 and the lossless encoding unit 116. The lossless encoding unit 116 appropriately generates the VPS or VPS_extension based on the inter-layer information supplied from the inter-layer information setting unit 140.

The up-sampling unit 141 acquires the reference layer decoded image from the enhancement layer image encoding unit 104-1 as the reference picture, and performs up-sampling on the acquired reference picture. The up-sampling unit 141 stores the up-sampled reference picture in the frame memory 122.

<Process Related to Skip Picture>

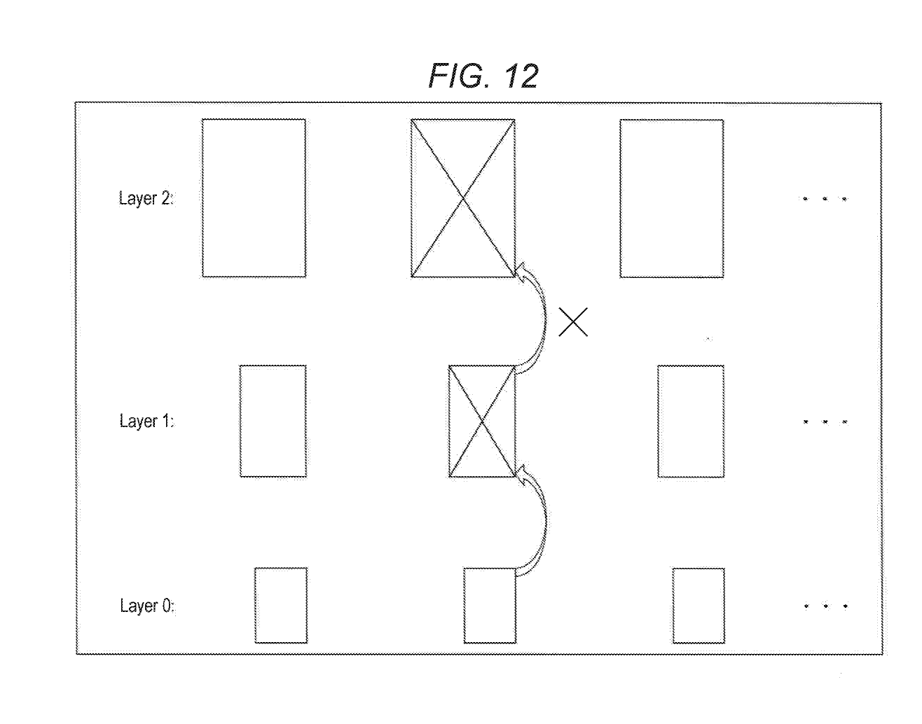

Next, a skip picture serving as one of the inter-layer information according to the present technology will be described with reference to FIG. 12. In an example of FIG. 12, a rectangle indicates a picture, and a cross mark illustrated in a rectangle indicates that the picture is the skip picture.

As illustrated in FIG. 12, in a Layer 2, if there is the skip picture, an up-sampled image of a Layer 1 is used as an output of the picture without change. Here, when the picture of the layer 1 serving as the reference picture of the picture of the layer 2 is also the skip picture, an up-sampled image of a Layer 0 serving as the reference layer of the layer 1 is output as the picture of the layer 2.

In other words, in an example of FIG. 12, since an image obtained by further up-sampling the up-sampled image of the layer 0 is output for the skip picture of the layer 2, the output image becomes a picture having a resolution significantly lower than the other pictures of the layer 2. In other words, in the layer 2, a difference in a resolution between pictures is likely to be observed as image quality degradation.

In this regard, in the present technology, by performing a setting related to the skip picture serving as one of the inter-layer information, the skip picture is prevented from being the reference source of the skip picture.

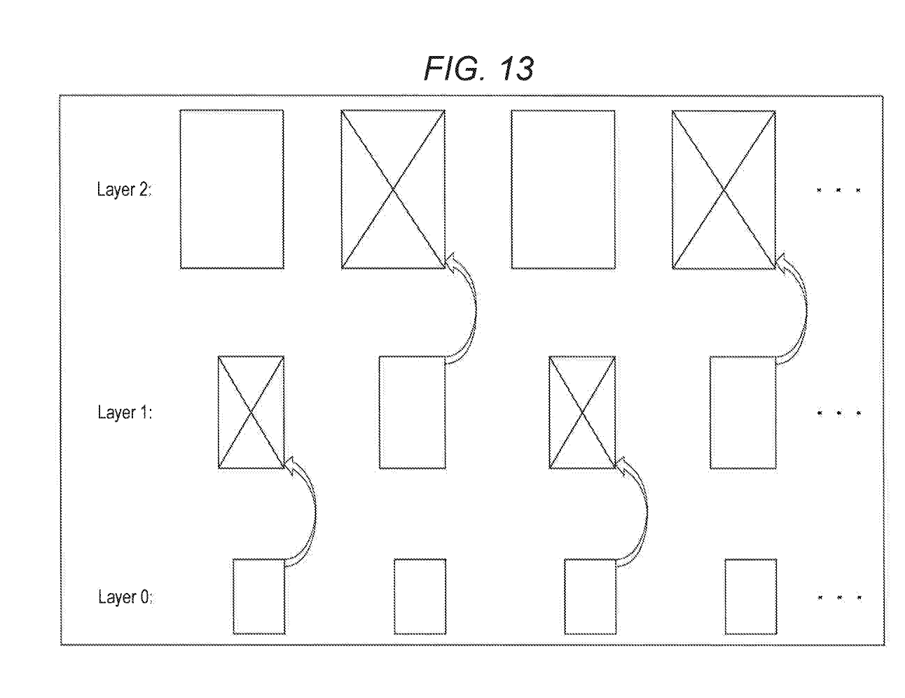

Thus, the skip picture can be alternately set in the layer 1 and the layer 2 as illustrated in FIG. 13.

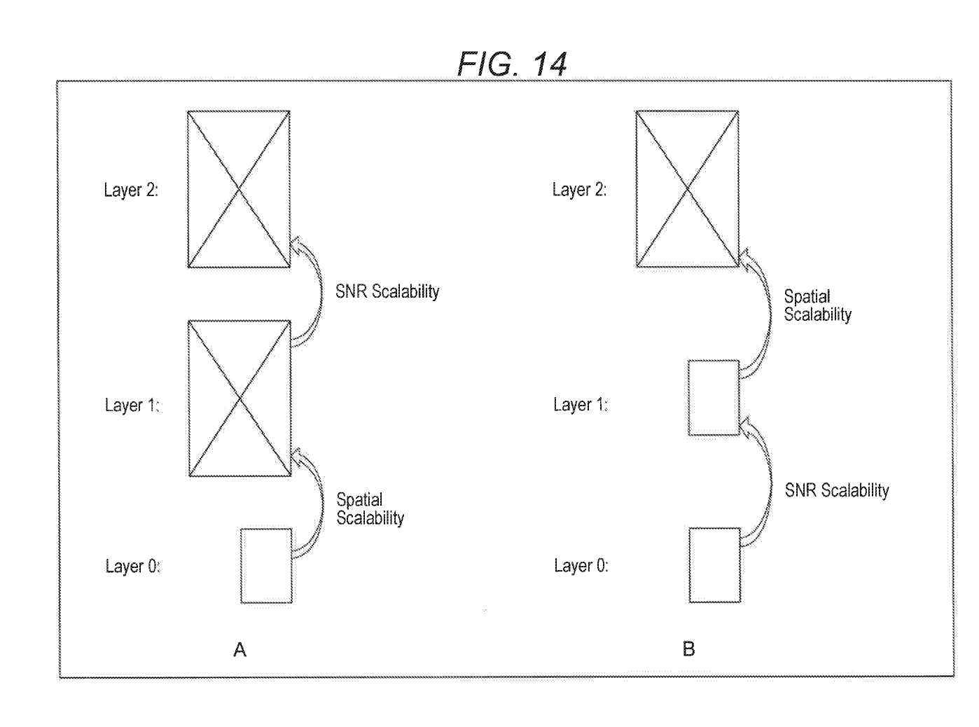

Since there is no reduction in the resolution in the SNR scalability, the above limitation may not be applied when the corresponding layer (the layer 2) and the reference layer (the layer 1) are subject to the SNR scalability as illustrated in A of FIG. 14. In other words, in the case of the SNR scalability, the reference source of the skip picture may be the skip picture.

Further, as illustrated in B of FIG. 14, when the corresponding layer (the layer 2) and the reference layer (the layer 1) are subject to the spatial scalability, but the reference layer (the layer 1) and the layer (the layer 0) to be referred to are subject to the SNR scalability, the limitation according to the present technology may not be applied.

The above process may be applied to all skip modes such as a skip slice and a skip tile as well as the skip picture.

According to the above method, it is possible to prevent degradation in the image quality of the corresponding layer output by second—or more order prediction of the skip picture.

The inter-layer information setting unit for implementing the present technology has the following configuration.

<Exemplary Configuration of Inter-Layer Information Setting Unit>

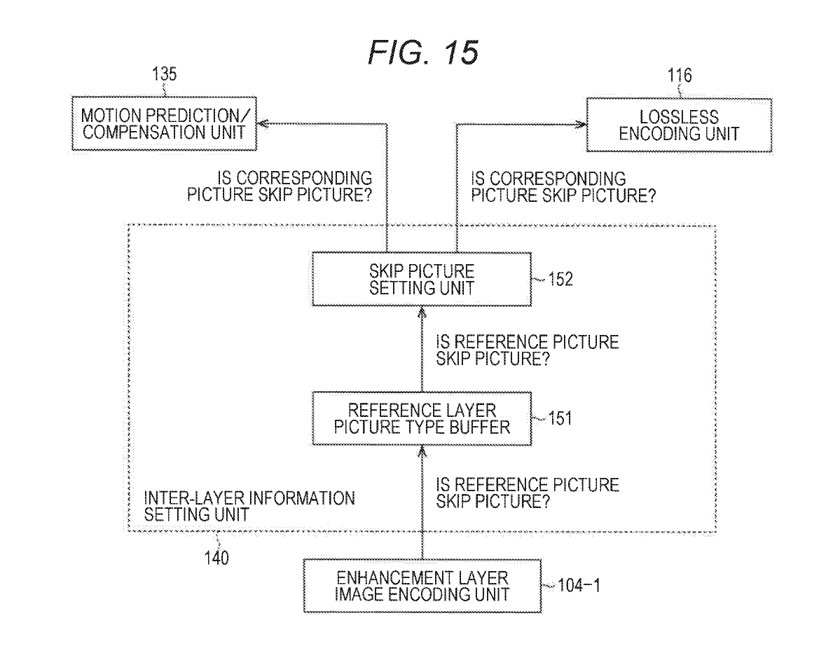

FIG. 15 is a block diagram illustrating an exemplary main configuration of the inter-layer information setting unit 140 of FIG. 11.

The inter-layer information setting unit 140 includes a reference layer picture type buffer 151 and a skip picture setting unit 152 as illustrated in FIG. 15.

Information indicating whether or not the picture in the reference layer is the skip picture is supplied from the enhancement layer image encoding unit 104-1 to the reference layer picture type buffer 151. In other words, the reference layer picture type buffer 151 acquires the information related to whether or not the picture in the reference layer is the skip picture. The information is supplied to the skip picture setting unit 152 as well.

When the picture in the reference layer is not the skip picture, the skip picture setting unit 152 performs a setting related to whether or not the picture in the corresponding layer is the skip picture as the inter-layer information. Then, the skip picture setting unit 152 supplies the set information to the motion prediction/compensation unit 135 and the lossless encoding unit 116.

When the picture in the reference layer is the skip picture, the skip picture setting unit 152 does not perform a setting related to whether or not the picture in the corresponding layer is the skip picture as the inter-layer information. In other words, the picture in the corresponding layer is prohibited from being the skip picture.

The motion prediction/compensation unit 135 performs the motion prediction/compensation process based on the information related to whether or not the picture in the corresponding layer is the skip picture which is supplied from the skip picture setting unit 152. The lossless encoding unit 116 encodes the information related to whether or not the picture in the corresponding layer is the skip picture so that the information is transmitted to the decoding side as information indicating the inter prediction mode.

<Flow of Encoding Process>

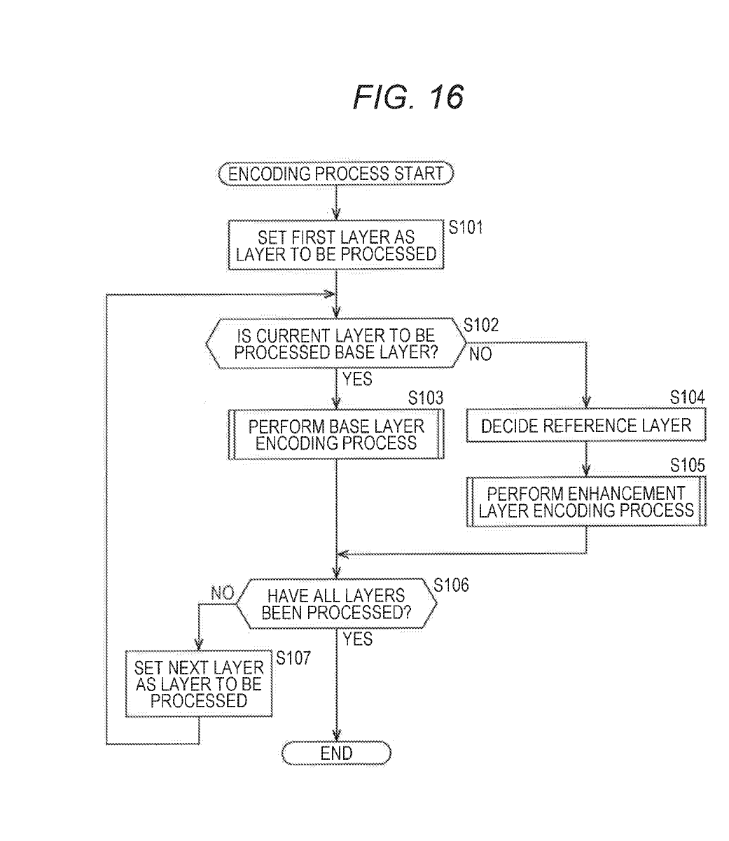

Next, the flow of processes performed by the scalable encoding device 100 will be described. First, an example of the flow of the encoding process will be described with reference to a flowchart of FIG. 16. The scalable encoding device 100 performs the encoding process in units of pictures.

When the encoding process starts, in step S101, the encoding control unit 102 of the scalable encoding device 100 sets a first layer as a layer to be processed.

In step S102, the encoding control unit 102 determines whether or not the current layer to be processed is the base layer. When the current layer is determined to be the base layer, the process proceeds to step S103.

In step S103, the base layer image encoding unit 103 performs the base layer encoding process. When the process of step S103 ends, the process proceeds to step S106.

Further, when the current layer is determined to be the enhancement layer in step S102, the process proceeds to step S104. In step S104, the encoding control unit 102 decides a reference layer corresponding to the current layer (that is, serving as a reference destination). Although not illustrated, the base layer may be the reference layer.

In step S105, the enhancement layer image encoding unit 104-1 or the enhancement layer image encoding unit 104-2 performs a current layer encoding process. When the process of step S105 ends, the process proceeds to step S106.

In step S106, the encoding control unit 102 determines whether or not all layers have been processed. When it is determined that there is a non-processed layer, the process proceeds to step S107.

In step S107, the encoding control unit 102 sets a next non-processed layer as a layer to be processed (a current layer). When the process of step S107 ends, the process returns to step S102. When the process of step S102 to step S107 is repeatedly performed, each layer is encoded.

Then, when all layers are determined to have been processed in step S106, the encoding process ends.

<Flow of Base Layer Encoding Process>

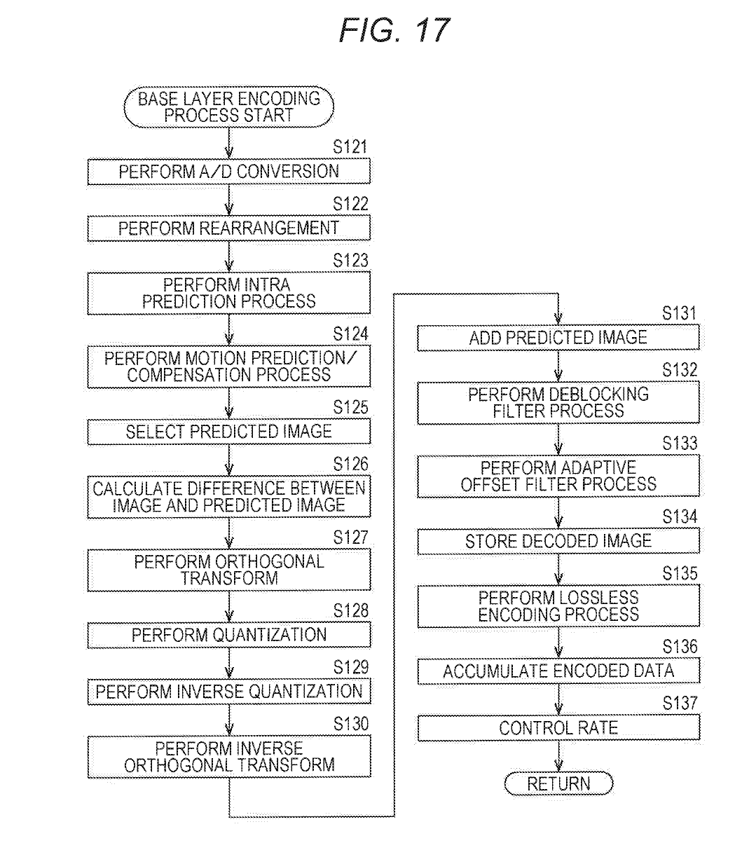

Next, an example of the flow of the base layer encoding process performed in step S103 of FIG. 15 will be described with reference to a flowchart of FIG. 17.

In step S121, the A/D converter 111 of the base layer image encoding unit 103 performs A/D conversion on the input image information (image data) of the base layer. In step S122, the screen rearrangement buffer 112 stores the image information (digital data) of the base layer that has undergone the A/D conversion, and rearranges each picture arranged in the display order in the encoding order.

In step S123, the intra prediction unit 124 performs the intra prediction process of the intra prediction mode. In step S124, the motion prediction/compensation unit 125 performs the motion prediction/compensation process of performing the motion prediction or the motion compensation in the inter prediction mode. In step S125, the predicted image selection unit 126 decides the optimal mode based on the cost function values output from the intra prediction unit 124 and the motion prediction/compensation unit 125. In other words, the predicted image selection unit 126 selects any one of the predicted image generated by the intra prediction unit 124 and the predicted image generated by the motion prediction/compensation unit 125. In step S126, the operation unit 113 calculates a difference between the image rearranged by the process of step S122 and the predicted image selected by the process of step S125. A data amount of differential data is reduced to be smaller than that of original image data. Thus, it is possible to compress a data amount to be smaller than when an image is encoded without change.

In step S127, the orthogonal transform unit 114 performs the orthogonal transform process on the differential information generated by the process of step S126. In step S128, the quantization unit 115 performs the quantization on the orthogonal transform coefficients obtained by the process of step S127 using the quantization parameter calculated by the rate control unit 127.

The differential information quantized by the process of step S128 is locally decoded as follows. In other words, in step S129, the inverse quantization unit 118 performs the inverse quantization on the quantized coefficients (also referred to as “quantization coefficients”) generated by the process of step S128 according to characteristics corresponding to characteristics of the quantization unit 115. In step S130, the inverse orthogonal transform unit 119 performs the inverse orthogonal transform on the orthogonal transform coefficients obtained by the process of step S127. In step S131, the operation unit 120 adds the predicted image to the locally decoded differential information, and generates a locally decoded image (an image corresponding to an input to the operation unit 113).

In step S132, the deblocking filter 121 performs the deblocking filter process on the image generated by the process of step S131. As a result, the block distortion and the like are removed. In step S133, the adaptive offset filter 128 performs the adaptive offset filter process of mainly removing ringing on the deblocking filter process result supplied from the deblocking filter 121.

In step S134, the frame memory 122 stores the image that has undergone the ringing removal and the like performed by the process of step S133. An image that has not undergone the filter process by the deblocking filter 121 and the adaptive offset filter 128 is also supplied from the operation unit 120 to the frame memory 122 and stored in the frame memory 122. The image stored in the frame memory 122 is used in the process of step S123 or the process of step S124 and also supplied to the enhancement layer image encoding unit 104-1.

In step S135, the lossless encoding unit 116 of the base layer image encoding unit 103 encodes the coefficients quantized by the process of step S128. In other words, lossless encoding such as variable length coding or arithmetic coding is performed on data corresponding to a differential image.

At this time, the lossless encoding unit 116 encodes information related to the prediction mode of the predicted image selected by the process of step S125, and adds the encoded information to the encoded data obtained by encoding the differential image. In other words, the lossless encoding unit 116 also encodes the optimal intra prediction mode information supplied from the intra prediction unit 124 or information according to the optimal inter prediction mode supplied from the motion prediction/compensation unit 125, and adds the encoded information to the encoded data. The lossless encoding unit 116 supplies information (information indicating whether or not the picture of the corresponding layer is the skip picture, information related to a dependency relation in the corresponding layer, or the like) necessary when the enhancement layer image encoding unit 104-1 sets the inter-layer information to the enhancement layer image encoding unit 104-1 as necessary.

In step S136, the accumulation buffer 117 accumulates the base layer encoded data obtained by the process of step S135. The base layer encoded data accumulated in the accumulation buffer 117 is appropriately read and transmitted to the decoding side through a transmission path or a recording medium.

In step S137, the rate control unit 127 controls the rate of the quantization operation of the quantization unit 115 based on the coding amount (the generated coding amount) of the encoded data accumulated in the accumulation buffer 117 in step S136 so that an overflow or a underflow does not occur.

When the process of step S137 ends, the base layer encoding process ends, and the process returns to FIG. 16. The base layer encoding process is performed, for example, in units of pictures. In other words, the base layer encoding process is performed on each picture of the current layer. However, the respective processes of the base layer encoding process are performed for each processing unit.

<Flow of Enhancement Layer Encoding Process>

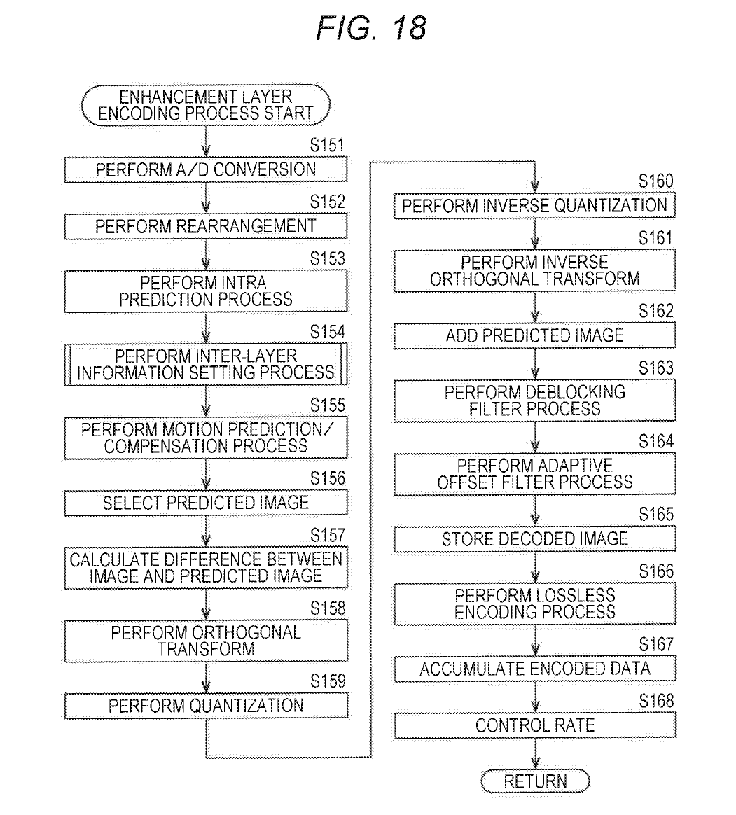

Next, an example of the flow of the enhancement layer encoding process performed in step S105 of FIG. 15 will be described with reference to a flowchart of FIG. 18.

A process of step S151 to step S153 and a process of step S155 to step S168 of the enhancement layer encoding process are performed similarly to the process of step S121 to step S137 of the base layer encoding process of FIG. 17. The respective processes of the enhancement layer encoding process are performed on the enhancement layer image information through the processing units of the enhancement layer image encoding unit 104.

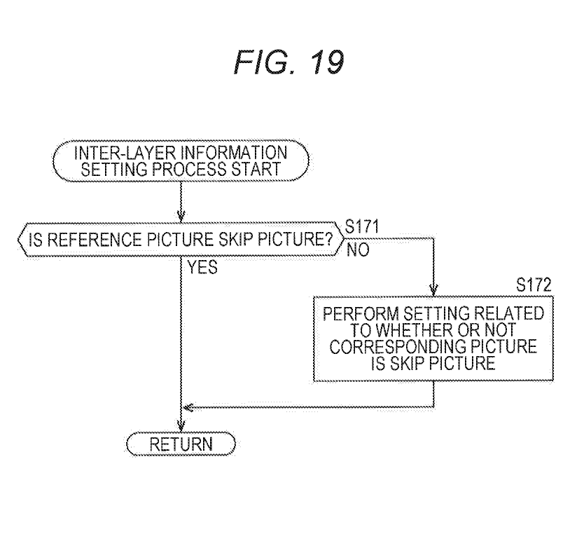

In step S154, the inter-layer information setting unit 140 of the enhancement layer image encoding unit 104 sets the inter-layer information that is information necessary for a process between the reference layer and the current layer based on the information related to the reference layer. The inter-layer information setting process will be described later in detail with reference to FIG. 19.

When the process of step S168 ends, the enhancement layer encoding process ends, and the process returns to FIG. 16. The enhancement layer encoding process is performed, for example, in units of pictures. In other words, the enhancement layer encoding process is performed on each picture of the current layer. However, the respective processes of the enhancement layer encoding process are performed for each processing unit.

<Flow of Inter-Layer Information Setting Process]

Next, an example of the flow of the inter-layer information setting process performed in step S154 of FIG. 18 will be described with reference to a flowchart of FIG. 19.

The information related to whether or not the picture in the reference layer is the skip picture is supplied from the enhancement layer image encoding unit 104-1 to the reference layer picture type buffer 151. The information is supplied to the skip picture setting unit 152 as well.

In step S171, the skip picture setting unit 152 determines whether or not the reference picture is the skip picture with reference to information supplied from the reference layer picture type buffer 151. When the reference picture is determined to be the skip picture in step S171, step S172 is skipped, the inter-layer information setting process ends, and the process returns to FIG. 18.

On the other hand, when the reference picture is determined to be not the skip picture in step S171, the process proceeds to step S172. In step S172, the skip picture setting unit 152 performs a setting related to whether or not the picture in the corresponding layer is the skip picture. Then, the skip picture setting unit 152 supplies the information to the motion prediction/compensation unit 135 and the lossless encoding unit 116. Thereafter, the inter-layer information setting process ends, the process returns to FIG. 18.

In step S155 of FIG. 18, the motion prediction/compensation unit 135 performs the motion prediction/compensation process based on the information related to whether or not the picture in the corresponding layer is the skip picture which is supplied from the skip picture setting unit 152. In step S166 of FIG. 18, the lossless encoding unit 116 encodes the information related to whether or not the picture in the corresponding layer is the skip picture so that the information is transmitted to the decoding side as the information indicating the inter prediction mode.

As described above, in the scalable encoding device of the present technology, when the picture of the reference layer is the skip picture, the image of the corresponding layer is prohibited from being the skip picture, and thus a decrease in the image quality of the current image to be output can be suppressed.

<Process Related to 64 or More Layers>

Next, a method of encoding 64 or more layers when scalable coding is performed using one of the inter-layer information according to the present technology will be described.

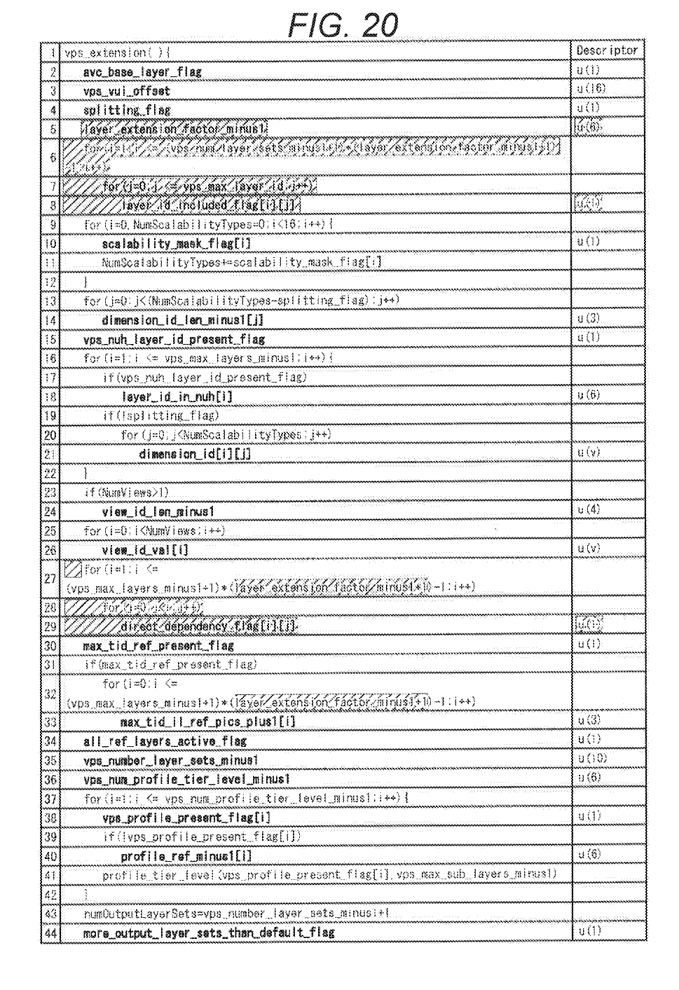

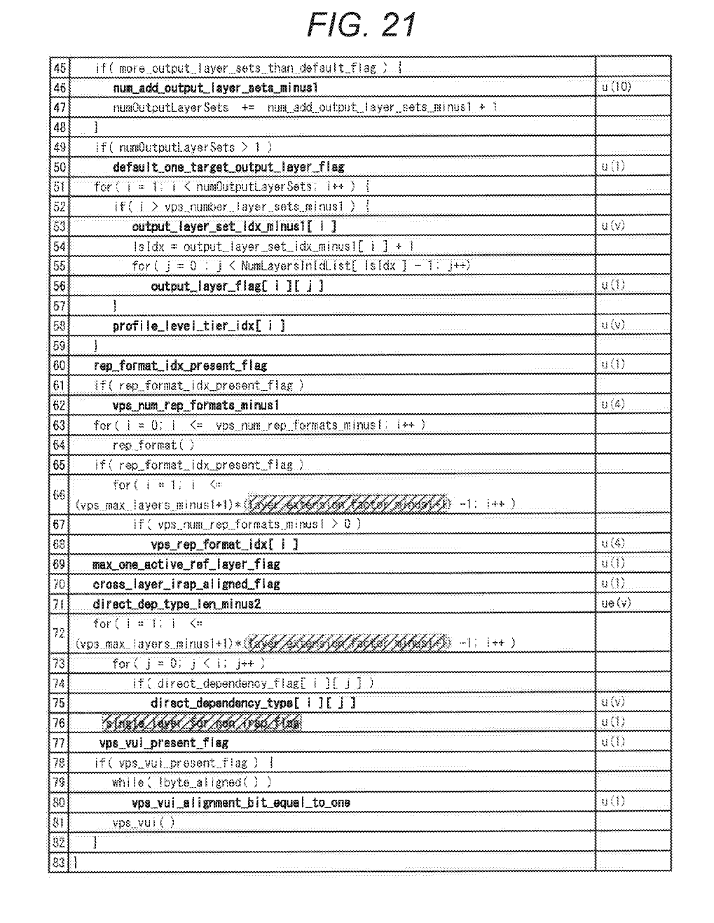

FIGS. 20 and 21 are diagrams illustrating an exemplary syntax of VPS_extension according to the present technology. Numbers at the left side are given for the sake of convenience of description.

For example, in the VPS of FIG. 6, 60 is designated as the number of layers of the image compression information in vps_max_layers_minus1 in the 4th line. In VPS_extension, 3 is designated as an extension factor in layer_extension_factor_minus1 in a 5th line of FIG. 20. In this case, in the image compression information, 180 layers (=60×3=(vps_max_layers_minus1+1)*(layer_extension_factor_minus1+1)) may be included.

When the same number of layers is increased by an addition, a value of 120 (=180−60) has to be designated in VPS_extension, and when an extension process based on layer_extension_factor is performed according to the present technology, the number of layers can be extended using a small number of bits.

In the present technology, a value obtained by subtracting 1 from a value of layer_extension_factor is encoded as layer_extension_factor_minus1 as illustrated in FIGS. 20 and 21. In the present technology, a layer set is defined again by VPS_extension for the number of layers extended by layer_extension_factor as illustrated in FIGS. 20 and 21. In other words, when the value of layer_extension_factor_minus1 is not 0, information related to the layer set is set in VPS_extension.

Through the above method, the scalable encoding process including 64 or more layers can be performed. Further, for example, the syntax element layer_extension_factor_minus1 may be set in VPS_extension only when layer_extension_flag is set in the VPS, and the value of layer_extension_flag is 1.

The inter-layer information setting unit for implementing the present technology has the following configuration.

<Another Exemplary Configuration of Inter-Layer Information Setting Unit>

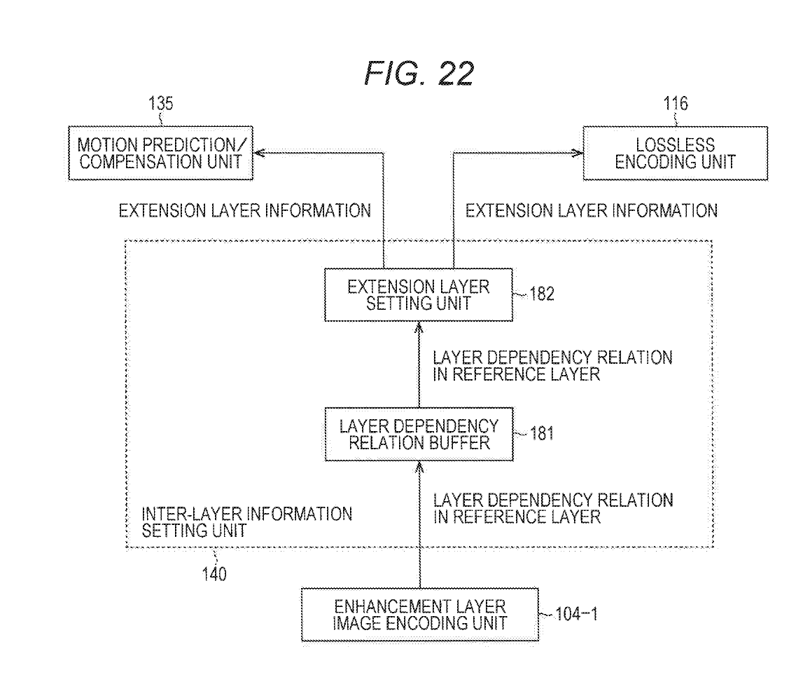

FIG. 22 is a block diagram illustrating an exemplary main configuration of the inter-layer information setting unit 140 of FIG. 11.

The inter-layer information setting unit 140 includes a layer dependency relation buffer 181 and an extension layer setting unit 182 as illustrated in FIG. 22.

The information related to the dependency relation in the reference layer is supplied from the enhancement layer image encoding unit 104-1 to the layer dependency relation buffer 181. In other words, the layer dependency relation buffer 181 acquires the information related to the dependency relation in the reference layer. The information is supplied to the extension layer setting unit 182 as well.

The extension layer setting unit 182 performs a setting related to an extension layer based on a method according to the present technology as the inter-layer information with reference to FIGS. 20 and 21. In other words, when 64 or more layers are included, the extension layer setting unit 182 sets 1 to layer_extension_flag in the VPS, and sets information related to an extension layer in VPS_extension. On the other hand, when 64 or more layers are not included, the extension layer setting unit 182 sets 0 to layer_extension_flag in the VPS, and performs no setting in VPS_extension. Then, the extension layer setting unit 182 supplies the set information related to the extension layer to the motion prediction/compensation unit 135 and the lossless encoding unit 116.

The motion prediction/compensation unit 135 performs the motion prediction/compensation process based on the information related to the extension layer supplied from the extension layer setting unit 182. The lossless encoding unit 116 generates and encodes the VPS or VPS_extension in order to transmit the information related to the extension layer to the decoding side as the information indicating the inter prediction mode.

<Flow of Inter-Layer Information Setting Process>

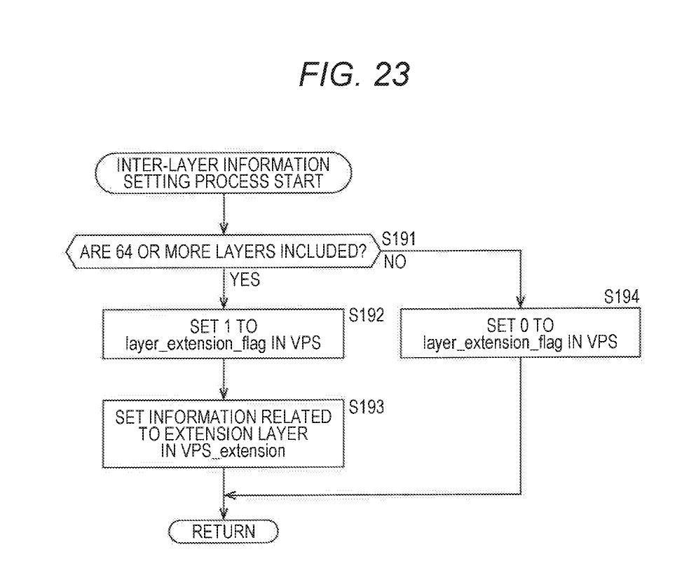

Next, an example of the flow of the inter-layer information setting process performed in step S154 of FIG. 18 will be described with reference to a flowchart of FIG. 23.

The information related to the dependency relation in the reference layer is supplied from the enhancement layer image encoding unit 104-1 to the layer dependency relation buffer 181. The information is supplied to the extension layer setting unit 182 as well.

In step S191, the extension gradation setting unit 182 determines whether or not 64 or more layers are included. When 64 or more layers are determined to be included in step S191, the process proceeds to step S192.

In step S192, the extension gradation setting unit 182 sets 1 to layer_extension_flag in the VPS as illustrated in FIG. 6. In step S193, the extension gradation setting unit 182 sets the information related to the extension layer in VPS_extension. Then, the extension gradation setting unit 182 supplies the information to the motion prediction/compensation unit 135 and the lossless encoding unit 116. Thereafter, the inter-layer information setting process ends, the process returns to FIG. 18.

On the other hand, when 64 or more layers are determined to be not included in step S191, the process proceeds to step S194.

In step S192, the extension gradation setting unit 182 sets 0 to layer_extension_flag in the VPS as illustrated in FIG. 6. Then, the extension gradation setting unit 182 supplies the information to the motion prediction/compensation unit 135 and the lossless encoding unit 116. Thereafter, the inter-layer information setting process ends, the process returns to FIG. 18.

In step S155 of FIG. 18, the motion prediction/compensation unit 135 performs the motion prediction/compensation process based on the information related to the extension layer supplied from the extension gradation setting unit 182. In step S166 of FIG. 18, the lossless encoding unit 116 encodes the information related to the extension layer supplied from the extension gradation setting unit 182 in order to transmit the information to the decoding side as the information indicating the inter prediction mode.

As described above, in the scalable encoding of the present technology, by setting the VPS and VPS_extension, it can be defined for 64 or more layers, and thus it is possible to perform the scalable encoding process including 64 or more layers.

### 2. SECOND EMBODIMENT

### Scalable Decoding Device

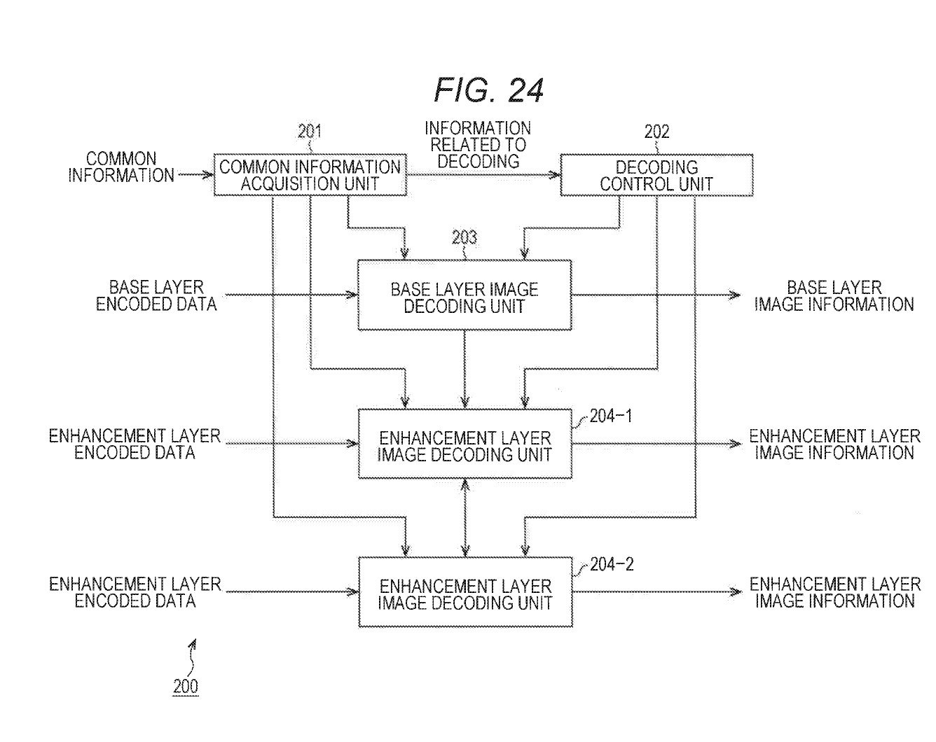

Next, decoding of the encoded data (bit stream) that has undergone the scalable encoding as described above will be described. FIG. 24 is a block diagram illustrating an exemplary main configuration of a scalable decoding device corresponding to the scalable encoding device 100 of FIG. 9. A scalable decoding device 200 illustrated in FIG. 24 performs scalable decoding, for example, on the encoded data obtained by performing the scalable encoding on the image data through the scalable encoding device 100 according to a method corresponding to the encoding method.

The scalable decoding device 200 includes a common information acquisition unit 201, a decoding control unit 202, a base layer image decoding unit 203, an enhancement layer image decoding unit 204-1, and an enhancement layer image decoding unit 204-2 as illustrated in FIG. 24. When it is unnecessary to distinguish particularly, the enhancement layer image decoding units 204-1 and 204-2 are referred to collectively as an “enhancement layer image decoding unit 204.” In an example of FIG. 24, the number of enhancement layer image decoding units 204 is 2 but may be two or more.

The common information acquisition unit 201 acquires the common information (for example, the VPS) transmitted from the encoding side. The common information acquisition unit 201 extracts information related to decoding from the acquired common information, and supplies the information related to the decoding to the decoding control unit 202. The common information acquisition unit 201 appropriately supplies all or a part of the common information to the base layer image decoding unit 203 to the enhancement layer image decoding unit 204-2.

The decoding control unit 202 acquires the information related to the decoding supplied from the common information acquisition unit 201, and controls decoding of each layer by controlling the base layer image decoding unit 203 to the enhancement layer image decoding unit 204-2 based on the information.

The base layer image decoding unit 203 is an image decoding unit corresponding to the base layer image encoding unit 103, and acquires, for example, the base layer encoded data obtained by encoding the base layer image information through the base layer image encoding unit 103. The base layer image decoding unit 203 decodes the base layer encoded data without using information of another layer, reconstructs the base layer image information, and outputs the reconstructed base layer image information.

The enhancement layer image decoding unit 204 is an image decoding unit corresponding to the enhancement layer image encoding unit 104, and acquires, for example, the enhancement layer encoded data obtained by encoding the enhancement layer image information through the enhancement layer image encoding unit 104. The enhancement layer image decoding unit 204 decodes the enhancement layer encoded data. At this time, the enhancement layer image decoding unit 204 acquires the inter-layer information transmitted from the encoding side, and performs the decoding process. The inter-layer information is the inter-layer information necessary for performing a process between layers, that is, the inter-layer information indicating whether or not the picture is the skip picture, the inter-layer information indicating the layer dependency relation when 64 or more layers are included, or the like as described above.

The enhancement layer image decoding unit 204 performs the motion compensation using the received inter-layer information, generates the predicted image, reconstructs the enhancement layer image information using the predicted image, and outputs the enhancement layer image information.

Further, when the image information of the enhancement layer is decoded, the enhancement layer image decoding unit 204 acquires another enhancement layer decoded image (or the base layer decoded image), performs up-sampling on another enhancement layer decoded image, and uses the resulting image as one of the reference pictures for the motion prediction.

[Base Layer Image Decoding Unit]

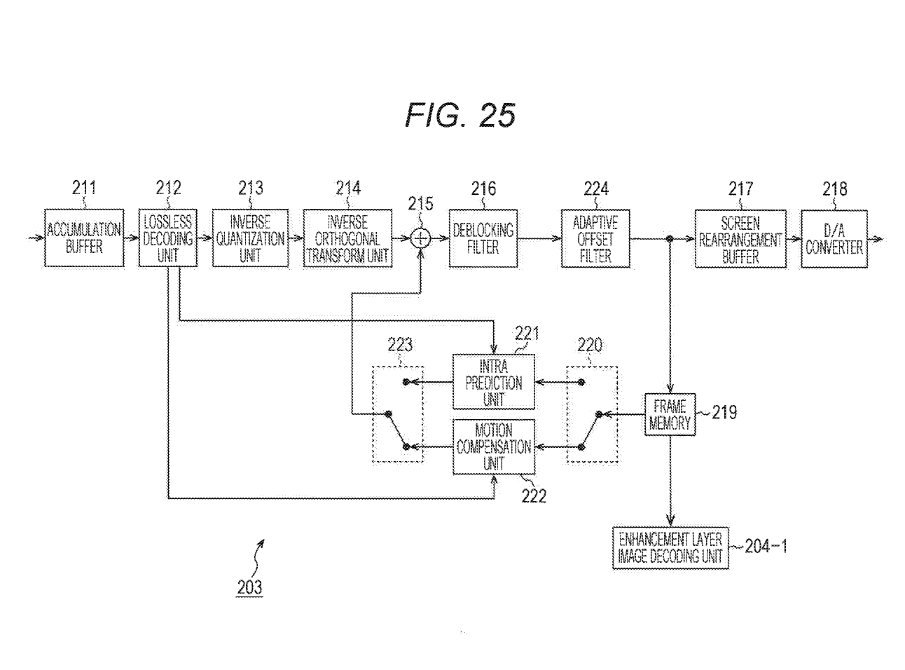

FIG. 25 is a block diagram illustrating an exemplary main configuration of the base layer image decoding unit 203 of FIG. 24. The base layer image decoding unit 203 includes an accumulation buffer 211, a lossless decoding unit 212, an inverse quantization unit 213, an inverse orthogonal transform unit 214, an operation unit 215, a deblocking filter 216, a screen rearrangement buffer 217, and a D/A converter 218 as illustrated in FIG. 25. The base layer image decoding unit 203 further includes a frame memory 219, a selection unit 220, an intra prediction unit 221, a motion compensation unit 222, and a selection unit 223. The base layer image decoding unit 203 includes the deblocking filter 216 and an adaptive offset filter 224 between the screen rearrangement buffer 217 and the frame memory 219.

The accumulation buffer 211 is a reception unit that receives the transmitted base layer encoded data. The accumulation buffer 211 receives and accumulates the transmitted base layer encoded data, and supplies the encoded data to the lossless decoding unit 212 at a predetermined timing. Information necessary for decoding of the prediction mode information and the like is added to the base layer encoded data.

The lossless decoding unit 212 decodes the information that is encoded by the lossless encoding unit 116 and supplied from the accumulation buffer 211 according to the coding scheme of the lossless encoding unit 116. The lossless decoding unit 212 supplies the quantized coefficient data of the differential image obtained by the decoding to the inverse quantization unit 213.

The lossless decoding unit 212 appropriately extracts and acquires the NAL unit including the VPS, the SPS, the PPS, and the like included in the base layer encoded data. The lossless decoding unit 212 extracts information related to the optimal prediction mode from the information, determines one of the intra prediction mode and the inter prediction mode selected in the optimal prediction mode based on the information, and supplies the information related to the optimal prediction mode to one of the intra prediction unit 221 and the motion compensation unit 222, that is, a mode determined to be selected. In other words, for example, when the base layer image encoding unit 103 selects the intra prediction mode as the optimal prediction mode, the information related to the optimal prediction mode is supplied to the intra prediction unit 221. Further, for example, when the base layer image encoding unit 103 selects the inter prediction mode as the optimal prediction mode, the information related to the optimal prediction mode is supplied to the motion compensation unit 222. Although not illustrated, the lossless decoding unit 212 supplies the information necessary when the enhancement layer image decoding unit 204-1 sets the inter-layer information to the enhancement layer image decoding unit 204-1.

The lossless decoding unit 212 extracts, for example, information necessary for the inverse quantization such as the quantization matrix and the quantization parameter from the NAL unit or the like, and supplies the extracted information to the inverse quantization unit 213.

The inverse quantization unit 213 performs the inverse quantization on the quantized coefficient data decoded and obtained by the lossless decoding unit 212 according to the scheme corresponding to the quantization scheme of the quantization unit 115. The inverse quantization unit 213 is a processing unit similar to the inverse quantization unit 118. In other words, the description of the inverse quantization unit 213 can be applied to the inverse quantization unit 118 as well. However, for example, input and output destinations of data need to be appropriately changed and read according to a device. The inverse quantization unit 213 supplies the obtained coefficient data to the inverse orthogonal transform unit 214.

The inverse orthogonal transform unit 214 performs the inverse orthogonal transform on the coefficient data supplied from the inverse quantization unit 213 according to the scheme corresponding to the orthogonal transform scheme of the orthogonal transform unit 114. The inverse orthogonal transform unit 214 is a processing unit similar to the inverse orthogonal transform unit 119. In other words, the inverse orthogonal transform unit 214 can be applied to the inverse orthogonal transform unit 119 as well. However, for example, input and output destinations of data need to be appropriately changed and read according to a device.

The inverse orthogonal transform unit 214 obtains decoded residual data corresponding to residual data that has not undergone the orthogonal transform in the orthogonal transform unit 114 through the inverse orthogonal transform process. The decoded residual data obtained by the inverse orthogonal transform is supplied to the operation unit 215. The predicted image is supplied from the intra prediction unit 221 or the motion compensation unit 222 to the operation unit 215 through the selection unit 223.

The operation unit 215 adds the decoded residual data to the predicted image, and obtains decoded image data corresponding to image data before the predicted image is subtracted by the operation unit 113. The operation unit 215 supplies the decoded image data to the deblocking filter 216.

The deblocking filter 216 removes the block distortion of the decoded image by performing the deblocking filter process on the decoded image. The deblocking filter 216 supplies the image that has undergone the filter process to the adaptive offset filter 224.

The adaptive offset filter 224 performs the adaptive offset filter (sample adaptive offset (SAO)) process for mainly removing ringing on the deblocking filter process result (the decoded image from which the block distortion has been removed) supplied from the deblocking filter 216.

The adaptive offset filter 224 receives a type of adaptive offset filter process of each largest coding unit (LCU) and an offset from the lossless decoding unit 212 (not illustrated). The adaptive offset filter 224 performs the received type of adaptive offset filter process on the image that has undergone the adaptive deblocking filter process using the received offset. Then, the adaptive offset filter 224 supplies the image that has undergone the adaptive offset filter process (hereinafter, referred to as a “decoded image”) to the screen rearrangement buffer 217 and the frame memory 219.

The decoded image output from the operation unit 215 can be supplied to the screen rearrangement buffer 217 and the frame memory 219 without intervention of the deblocking filter 216 and the adaptive offset filter 224. In other words, all or a part of the filter process by the deblocking filter 216 can be omitted. An adaptive loop filter may be arranged at a stage subsequent to the adaptive offset filter 224.

The screen rearrangement buffer 217 rearranges the decoded image. In other words, the screen rearrangement buffer 112 rearranges the order of the frames rearranged in the encoding order in the original display order. The D/A converter 218 performs D/A conversion on the image supplied from the screen rearrangement buffer 217, and outputs the converted image to be displayed on a display (not illustrated).

The frame memory 219 stores the supplied decoded image, and supplies the stored decoded image to the selection unit 220 as the reference image at a predetermined timing or based on a request made from the outside such as the intra prediction unit 221 or the motion compensation unit 222. The decoded image of the frame memory 219 is supplied to the enhancement layer image decoding unit 204-1 or the enhancement layer image decoding unit 204-2 as the reference picture as necessary.

The selection unit 220 selects a supply destination of the reference image supplied from the frame memory 219. When the image that has undergone the intra encoding is decoded, the selection unit 220 supplies the reference image supplied from the frame memory 219 to the intra prediction unit 221. Further, when the image that has undergone the inter encoding is decoded, the selection unit 220 supplies the reference image supplied from the frame memory 219 to the motion compensation unit 222.

For example, information indicating the intra prediction mode obtained by decoding the header information is appropriately supplied from the lossless decoding unit 212 to the intra prediction unit 221. The intra prediction unit 221 performs the intra prediction using the reference image acquired from the frame memory 219 in the intra prediction mode used in the intra prediction unit 124, and generates the predicted image. The intra prediction unit 221 supplies the generated predicted image to the selection unit 223.

The motion compensation unit 222 acquires information (the optimal prediction mode information, the reference image information, and the like) obtained by decoding the header information from the lossless decoding unit 212.

The motion compensation unit 222 performs the motion compensation using the reference image acquired from the frame memory 219 in the inter prediction mode indicated by the optimal prediction mode information acquired from the lossless decoding unit 212, and generates the predicted image.

The motion compensation unit 222 supplies the generated predicted image to the selection unit 223.

The selection unit 223 supplies the predicted image supplied from the intra prediction unit 221 or the predicted image supplied from the motion compensation unit 222 to the operation unit 215. Then, the operation unit 215 adds the predicted image generated using the motion vector to the decoded residual data (the differential image information) supplied from the inverse orthogonal transform unit 214, and thus the original image is decoded.

<Enhancement Layer Image Decoding Unit>

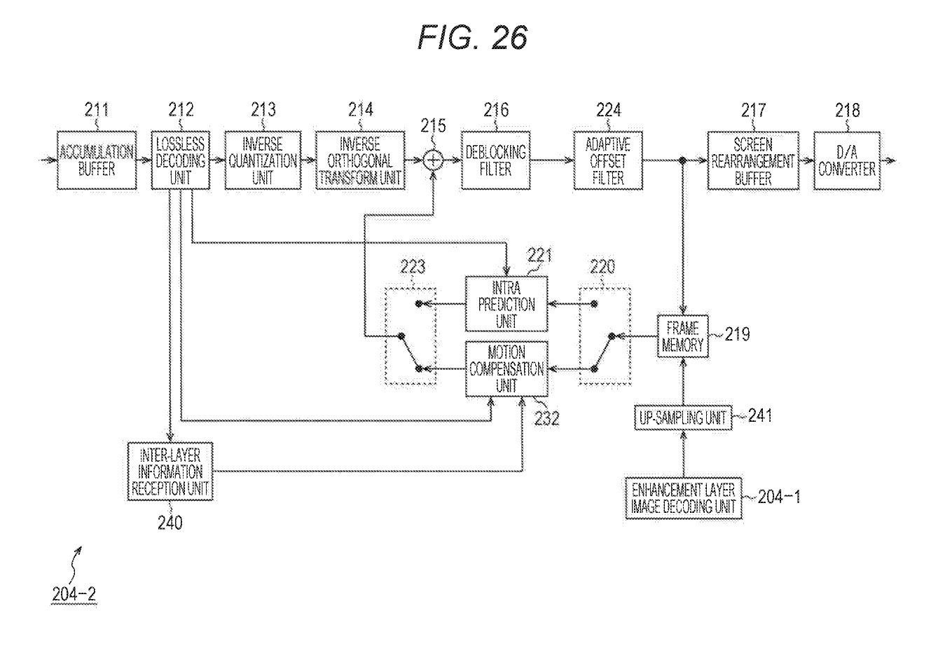

FIG. 26 is a block diagram illustrating an exemplary main configuration of the enhancement layer image decoding unit 204-2 of FIG. 24. The enhancement layer image decoding unit 204-1 has the same configuration as the enhancement layer image encoding unit 104-2 of FIG. 26, and thus a description thereof is omitted. The enhancement layer image decoding unit 204-2 has basically a similar configuration to the base layer image decoding unit 203 of FIG. 25 as illustrated in FIG. 26.

However, respective units of the enhancement layer image decoding unit 204-2 perform a process of decoding the enhancement layer encoded data other than the base layer. In other words, the accumulation buffer 211 of the enhancement layer image decoding unit 204-2 stores the enhancement layer encoded data, and the D/A converter 218 of the enhancement layer image decoding unit 204-2 outputs the enhancement layer image information, for example, to a recording device (recording medium) (not illustrated) at a subsequent stage, a transmission path, or the like. Although not illustrated, when the enhancement layer image decoding unit 204-2 functions as the reference layer, the lossless decoding unit 212 supplies information necessary when the enhancement layer image decoding unit 204-3 sets the inter-layer information, for example, to the enhancement layer image decoding unit 204-3. In this case, the decoded image of the frame memory 219 is supplied to the enhancement layer image decoding unit 204-3 as the reference picture as necessary.

The enhancement layer image decoding unit 204-2 includes a motion compensation unit 232 instead of the motion compensation unit 222. Unlike the base layer image decoding unit 203, an inter-layer information reception unit 240 and an up-sampling unit 241 are added to the enhancement layer image encoding unit 204-2.

The motion compensation unit 232 performs the motion compensation according to the inter-layer information set by the inter-layer information setting unit 240. In other words, the motion compensation unit 232 performs basically a similar process to that of the motion compensation unit 222 except that it refers to the inter-layer information received by the inter-layer information reception unit 240.

The inter-layer information reception unit 240 receives the inter-layer information supplied from the lossless decoding unit 212, and supplies the received inter-layer information to the motion compensation unit 232.

The up-sampling unit 241 acquires the reference layer decoded image from the enhancement layer image decoding unit 204-1 as the reference picture, and performs up-sampling on the acquired reference picture. The up-sampling unit 241 stores the up-sampled reference picture in the frame memory 219.

<Inter-Layer Information Reception Unit>

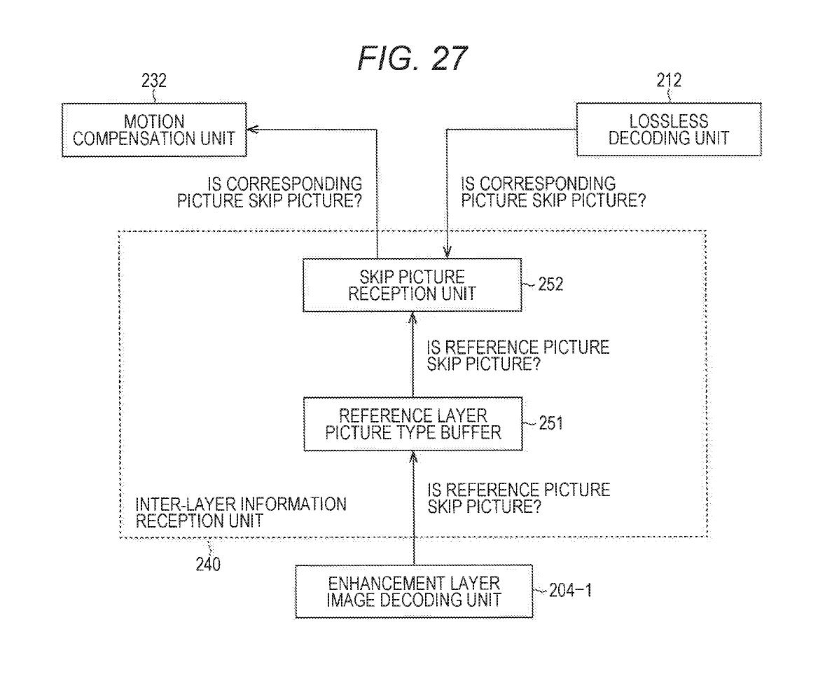

FIG. 27 is a block diagram illustrating an exemplary main configuration of the inter-layer information reception unit 240 of FIG. 26. The inter-layer information reception unit 240 of FIG. 27 has a configuration corresponding to the inter-layer information setting unit 140 of FIG. 15.

In other words, the inter-layer information reception unit 240 includes a reference layer picture type buffer 251 and a skip picture reception unit 252 as illustrated in FIG. 27.

The information related to whether or not the picture in the reference layer is the skip picture is supplied from the enhancement layer image decoding unit 204-1 to the reference layer picture type buffer 251. The information is supplied to the skip picture reception unit 252 as well. Although the reference layer picture type buffer 251 is arranged in the example of FIG. 27, but when information obtained from the bit stream indicates that the picture of the corresponding layer is the skip picture, since the encoding side knows that the picture of the reference layer is not the skip picture, the reference layer picture type buffer 251 may not be arranged at the decoding side.

When the picture in the reference layer is not the skip picture, the skip picture reception unit 252 receives the information related to whether or not the picture in the corresponding layer is the skip picture from the lossless decoding unit 212 as the inter-layer information. Then, the skip picture reception unit 252 supplies the received information to the motion compensation unit 232.

When the picture in the reference layer is the skip picture, the skip picture reception unit 252 does not receive the information related to whether or not the picture in the corresponding layer is the skip picture from the lossless decoding unit 212 as the inter-layer information. In other words, the picture in the corresponding layer is prohibited from being the skip picture.

The motion compensation unit 232 performs the motion compensation process based on the information related to whether or not the picture in the corresponding layer is the skip picture which is supplied from the skip picture reception unit 252.

<Flow of Decoding Process>

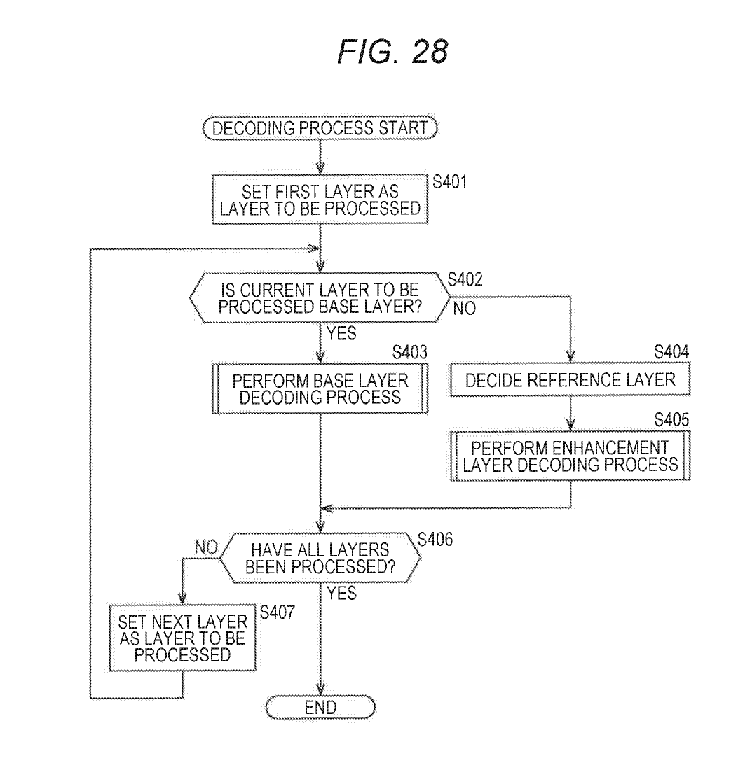

Next, the flow of respective processes performed by the scalable decoding device 200 will be described. First, an example of the flow of the decoding process will be described with reference to a flowchart of FIG. 28. The scalable decoding device 200 performs the decoding process in units of pictures.

When the decoding process starts, in step S401, the decoding control unit 202 of the scalable decoding device 200 sets a first layer as a layer to be processed.

In step S402, the decoding control unit 202 determines whether or not the current layer to be processed is the base layer. When the current layer is determined to be the base layer, the process proceeds to step S403.

In step S403, the base layer image decoding unit 203 performs the base layer decoding process. When the process of step S403 ends, the process proceeds to step S406.

In step S402, when the current layer is determined to be the enhancement layer, the process proceeds to step S404. In step S404, the decoding control unit 202 decides reference layer corresponding to the current layer (that is, serving as a reference destination). Although not illustrated, the base layer may be the reference layer.

In step S405, the enhancement layer image decoding unit 204 performs the enhancement layer decoding process. When the process of step S405 ends, the process proceeds to step S406.

In step S406, the decoding control unit 202 determines whether or not all layers have been processed. When it is determined that there is a non-processed layer, the process proceeds to step S407.

In step S407, the decoding control unit 202 sets a next non-processed layer as a layer to be processed (a current layer). When the process of step S407 ends, the process returns to step S402. When the process of step S402 to step S407 is repeatedly performed, and thus each layer is decoded.

Then, when all layers are determined to have been processed in step S406, the decoding process ends.

<Flow of Base Layer Decoding Process>

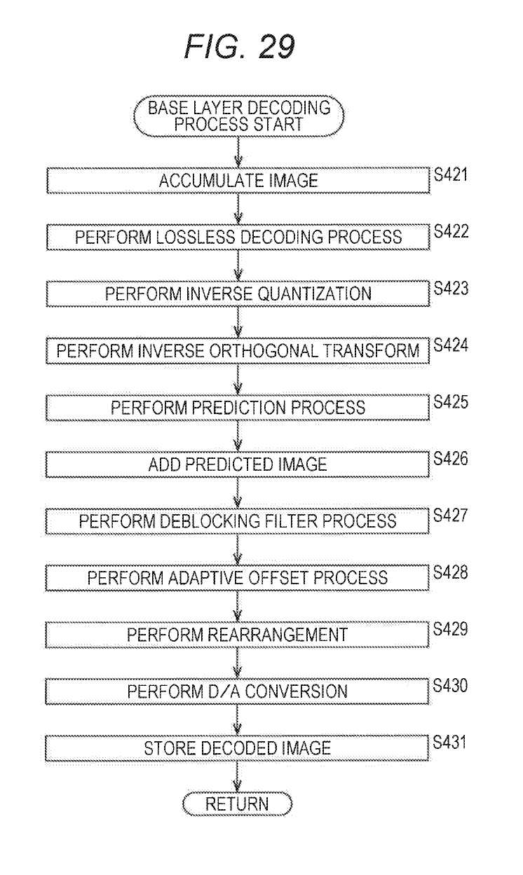

Next, an example of the flow of the base layer decoding process performed in step S403 of FIG. 28 will be described with reference to a flowchart of FIG. 29.

When the base layer decoding process starts, in step S421, the accumulation buffer 211 of the base layer image decoding unit 203 accumulates the bit stream of the base layer transmitted from the encoding side. In step S422, the lossless decoding unit 212 decodes the bit stream (the encoded differential image information) of the base layer supplied from the accumulation buffer 211. In other words, an I picture, a P picture, and a B picture encoded by the lossless encoding unit 116 are decoded. At this time, various kinds of information other than the differential image information included in the bit stream such as the header information are also decoded. The lossless decoding unit 212 supplies the information necessary when the enhancement layer image decoding unit 204-1 sets the inter-layer information (the information indicating whether or not the picture of the corresponding layer is the skip picture, the information related to a dependency relation in the corresponding layer, or the like) to the enhancement layer image decoding unit 204-1 as necessary.

In step S423, the inverse quantization unit 213 performs the inverse quantization on the quantized coefficients obtained by the process of step S422.

In step S424, the inverse orthogonal transform unit 214 performs the inverse orthogonal transform on the current block (the current TU).

In step S425, the intra prediction unit 221 or the motion compensation unit 222 performs the prediction process, and generates the predicted image. In other words, the prediction process is performed in the prediction mode which is determined to be applied at the time of encoding by the lossless decoding unit 212. More specifically, for example, when the intra prediction is applied at the time of encoding, the intra prediction unit 221 generates the predicted image in the intra prediction mode that is optimal at the time of encoding. Further, for example, when the inter prediction is applied at the time of encoding, the motion compensation unit 222 generates the predicted image in the inter prediction mode that is optimal at the time of encoding.

In step S426, the operation unit 215 adds the predicted image generated in step S425 to the differential image information generated by the inverse orthogonal transform process of step S424. Accordingly, the original image is decoded.

In step S427, the deblocking filter 216 performs the deblocking filter process on the decoded image obtained in step S426. As a result, the block distortion and the like are removed. In step S428, the adaptive offset filter 224 performs the adaptive offset filter process of mainly removing ringing on the deblocking filter process result supplied from the deblocking filter 216.

In step S429, the screen rearrangement buffer 217 rearranges the image that has undergone the ringing removal and the like in step S428. In other words, the screen rearrangement buffer 112 rearranges the order of the frames rearranged for encoding to the original display order.

In step S430, the D/A converter 218 performs the D/A conversion on the image in which the order of the frames is rearranged in step S429. The image is output to a display (not illustrated), and the image is displayed.

In step S431, the frame memory 219 stores the image that has undergone the adaptive offset filter process in step S428. The image stored in the frame memory 219 is used in the process of step S425 and also supplied to the enhancement layer image decoding unit 204-1.

When the process of step S431 ends, the base layer decoding process ends, and the process returns to FIG. 28. The base layer decoding process is performed, for example, in units of pictures. In other words, the base layer decoding process is performed on each picture of the current layer. However, the respective processes of the base layer decoding process are performed for each processing unit.

<Flow of Enhancement Layer Decoding Process>

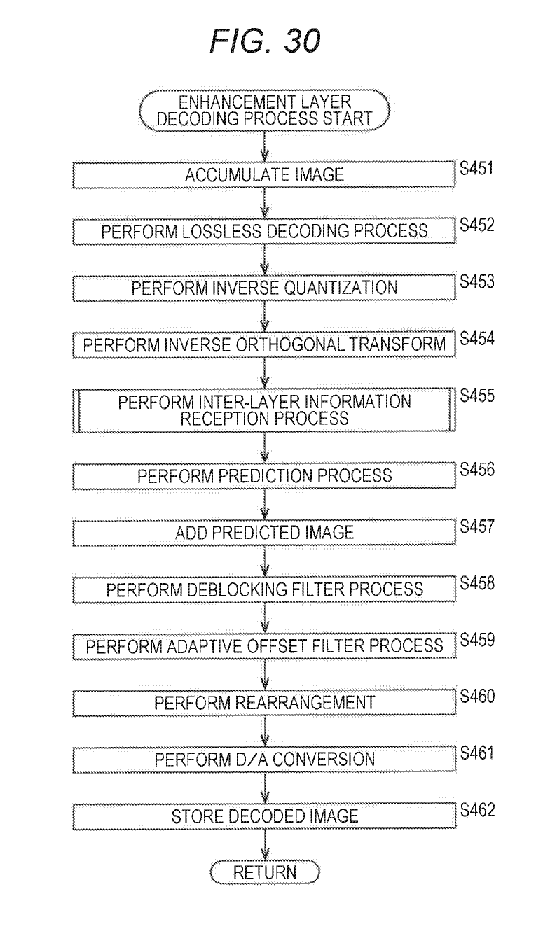

Next, an example of the flow of the enhancement layer decoding process performed in step S405 of FIG. 28 will be described with reference to a flowchart of FIG. 30.

A process of step S451 to step S454 and a process of step S456 to step S462 of the enhancement layer decoding process are performed, similarly to the process of step S421 to step S431 of the base layer decoding process. The respective processes of the enhancement layer decoding process are performed on the enhancement layer encoded data through the processing units of the enhancement layer image decoding unit 204.

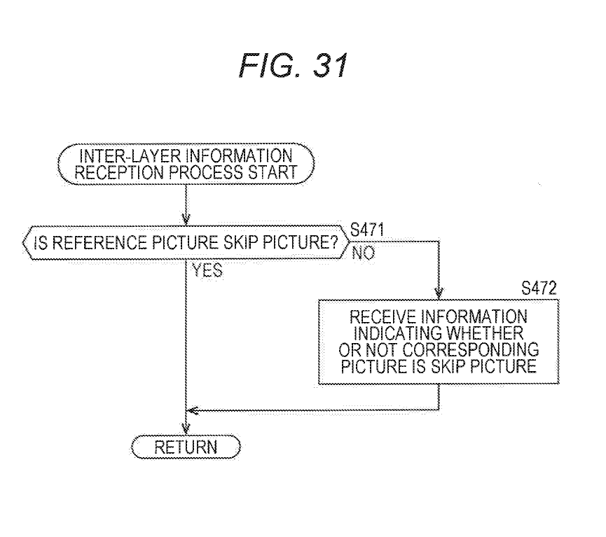

In step S455, the inter-layer information reception unit 240 of the enhancement layer image decoding unit 204 receives the inter-layer information that is information necessary for a process between the reference layer and the current layer based on the information related to the reference layer. The inter-layer information reception process will be described later in detail with reference to FIG. 31.

When the process of step S462, the enhancement layer decoding process ends, and the process returns to FIG. 28. The enhancement layer decoding process is performed, for example, in units of pictures. In other words, the enhancement layer decoding process is performed on each picture of the current layer. The respective processes of the enhancement layer decoding process are performed for each processing unit.

<Flow of Inter-Layer Information Reception Process>

Next, an example of the flow of the inter-layer information reception process performed in step S455 of FIG. 30 will be described with reference to a flowchart of FIG. 31.

The information related to whether or not the picture in the reference layer is the skip picture is supplied from the enhancement layer image decoding unit 204-1 to the reference layer picture type buffer 251. The information is supplied to the skip picture reception unit 252 as well.

In step S471, the skip picture reception unit 252 determines whether or not the reference picture is the skip picture with reference to information supplied from the reference layer picture type buffer 251. When the reference picture is determined to be the skip picture in step S471, step S472 is skipped, the inter-layer information reception process ends, and the process returns to FIG. 30.

On the other hand, when the reference picture is determined to be not the skip picture in step S471, the process proceeds to step S472. In step S472, the skip picture reception unit 252 receives the information related to whether or not the picture in the corresponding layer is the skip picture from the lossless decoding unit 212. Then, the skip picture reception unit 252 supplies the information to the motion compensation unit 232. Thereafter, the inter-layer information setting process ends, and the process returns to FIG. 30.

In step S456 of FIG. 30, the motion compensation unit 232 performs the motion compensation process based on the information related to whether or not the picture in the corresponding layer is the skip picture which is supplied from the skip picture reception unit 252.

As described above, in the scalable decoding device of the present technology, when the picture of the reference layer is the skip picture, the image of the corresponding layer is prohibited from being the skip picture, and thus a decrease in the image quality of the current image to be output can be suppressed.

<Another Exemplary Configuration of Inter-Layer Information Setting Unit>

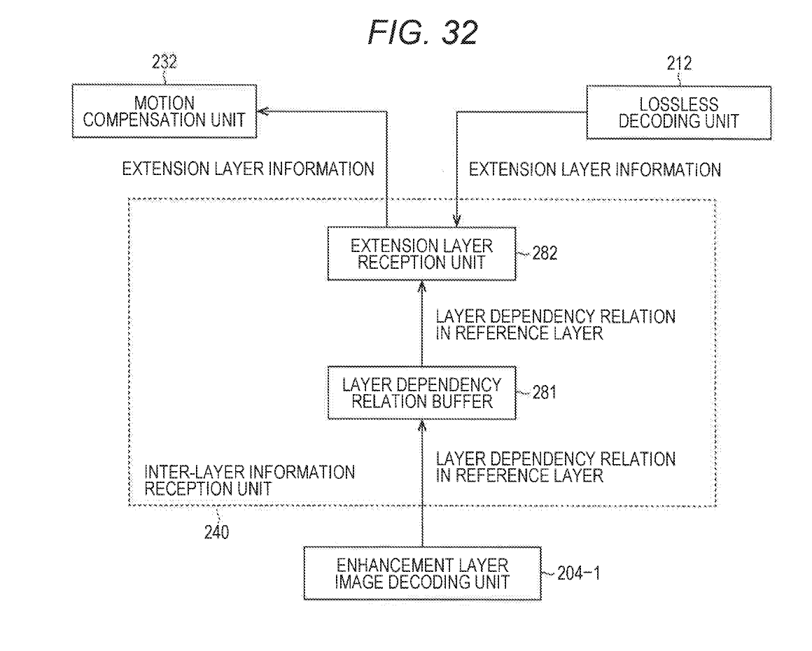

FIG. 32 is a block diagram illustrating an exemplary main configuration of the inter-layer information reception unit 240 of FIG. 26. The inter-layer information reception unit 240 of FIG. 32 has a configuration corresponding to the inter-layer information setting unit 140 of FIG. 22.

The inter-layer information reception unit 240 includes a layer dependency relation buffer 281 and an extension layer reception unit 282 as illustrated in FIG. 32.

The information related to the dependency relation in the reference layer is supplied from the enhancement layer image decoding unit 204-1 to the layer dependency relation buffer 281. The information is supplied to the extension layer reception unit 282 as well. Although the layer dependency relation buffer 281 is arranged in the example of FIG. 32, since the information related to the dependency relation in the reference layer is obtained from the bit stream at the decoding side, the layer dependency relation buffer 281 may not be arranged.

The extension layer reception unit 282 receives the information related to the extension layer from the lossless decoding unit 212 as the inter-layer information. First, the extension layer reception unit 282 receives layer_extension_flag in the VPS from the lossless decoding unit 212.

When layer_extension_flag=1, the extension layer reception unit 282 receives the information related to the extension layer in VPS_extension from the lossless decoding unit 212. Then, the extension layer reception unit 282 supplies the received information related to the extension layer to the motion compensation unit 232.

When layer_extension_flag=0, the extension layer reception unit 282 does not receive the information related to the extension layer in VPS_extension from the lossless decoding unit 212. In other words, the reception of the information is prohibited.

The motion compensation unit 232 performs the motion compensation process based on the information related to the extension layer supplied from the extension layer reception unit 282.

<Flow of Inter-Layer Information Reception Process>

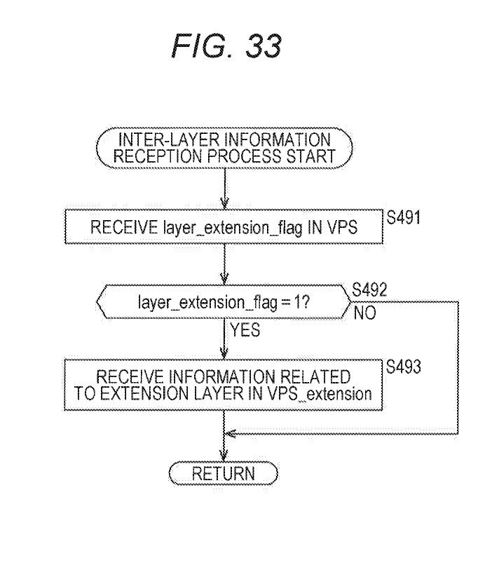

Next, an example of the flow of the inter-layer information reception process performed in step S455 of FIG. 30 will be described with reference to a flowchart of FIG. 33.

The information related to the dependency relation in the reference layer is supplied from the enhancement layer image decoding unit 204-1 to the layer dependency relation buffer 281. The information is supplied to the extension layer reception unit 282 as well.

In step S491, the extension layer reception unit 282 receives layer_extension_flag in the VPS from the lossless decoding unit 212.

In step S492, the extension layer reception unit 282 determines whether or not layer_extension_flag is 1. When layer_extension_flag is determined to be 1 in step S492, the process proceeds to step S493. In step S493, the extension layer reception unit 282 receives the information related to the extension layer in VPS_extension from the lossless decoding unit 212. Then, the extension layer reception unit 282 supplies the received information related to the extension layer to the motion compensation unit 232. Thereafter, the inter-layer information reception process ends, and the process returns to FIG. 30.

On the other hand, when layer_extension_flag is determined to be 0 in step S492, the process skips step S493. Thereafter, the inter-layer information reception process ends, and the process returns to FIG. 30.

In step S455 of FIG. 30, the motion compensation unit 232 performs the motion compensation process based on the information related to the extension layer supplied from the extension layer reception unit 282.

As described above, in the scalable decoding of the present technology, by setting the VPS and VPS_extension, it can be defined for 64 or more layers, and thus it is possible to perform the scalable encoding process including 64 or more layers.

According to the present technology, it is possible to perform an inter-layer associated process smoothly. In other words, a decrease in the image quality of the current image to be output can be suppressed. Alternatively, it is possible to perform the scalable encoding process including 64 or more layers.

### 3. OTHERS

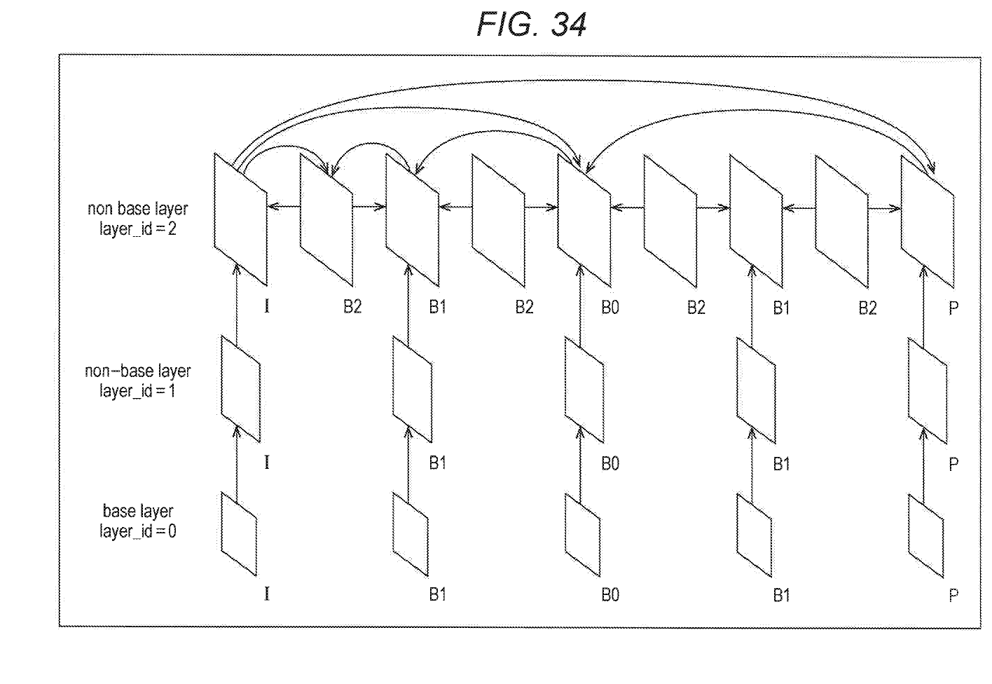

The example of hierarchizing image data into a plurality of layers through the scalable coding has been described above, but the number of layers is arbitrary. For example, some pictures may be hierarchized as illustrated in an example of FIG. 34. Further, the example of processing the enhancement layer using the information of the base layer at the time of encoding and decoding has been described above, but the present technology is not limited to this example, and the enhancement layer may be processed using in formation of another enhancement layer that is processed.

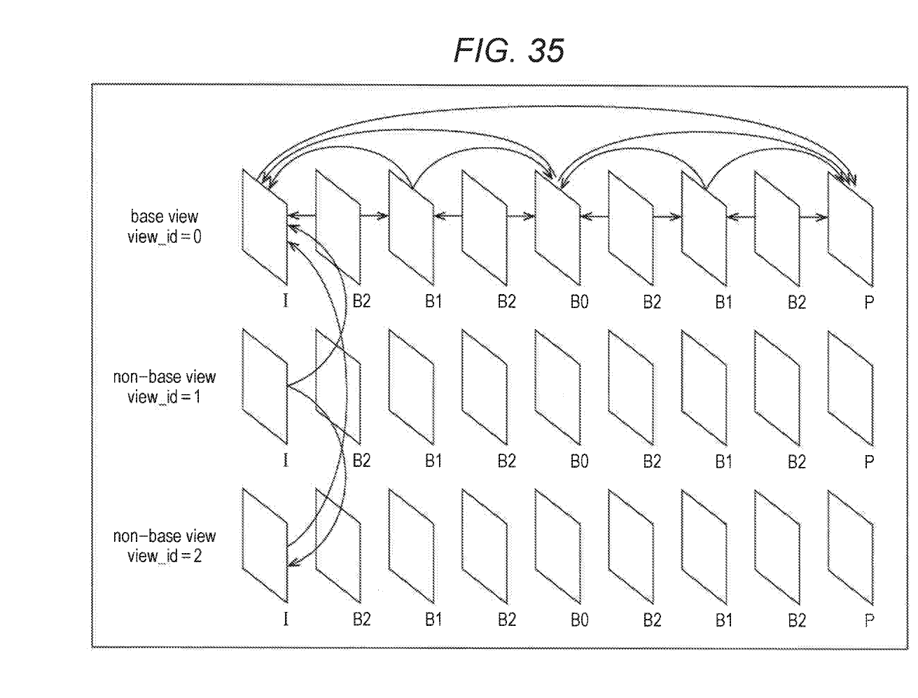

The layer described above includes a view in multi-view image encoding and decoding. In other words, the present technology can be applied to multi-view image encoding and multi-view image decoding. FIG. 35 illustrates an exemplary multi-view image coding scheme.

As illustrated in FIG. 35, a multi-view image includes images of a plurality of views, and an image of a predetermined view among the plurality of views is designated as a base view image. An image of each view other than the base view image is dealt with as a non-base view image.

When the multi-view image illustrated in FIG. 35 is encoded or decoded, an image of each view is encoded or decoded, but the above-described method may be applied to encoding and decoding of each view. In other words, for example, information between layers (views) may be set in a plurality of views in multi-view encoding and decoding.

Accordingly, it is possible to perform an inter-layer associated process smoothly in multi-view encoding and decoding, similarly to the case of the scalable encoding and decoding. In other words, a decrease in the image quality of the current image to be output can be suppressed. Alternatively, it is possible to perform the scalable encoding process including 64 or more layers.

As described above, the present technology can be applied to all image encoding devices and all image decoding devices based on the scalable encoding and decoding schemes.

The present technology can be applied to an image encoding device or an image decoding device used when image information (a bit stream) compressed by orthogonal transform such as discrete cosine transform (DCT) and motion compensation as in MPEG or H.26x is received via a network medium such as satellite broadcasting, a cable television, the Internet, or a mobile telephone. The present technology can be applied to an image encoding device or an image decoding device used when a process is performed on a storage medium such as an optical disk, a magnetic disk, or a flash memory.

### 4. THIRD EMBODIMENT

### Computer

A series of processes described above may be executed by hardware or software. When the series of processes are executed by software, a program configuring the software is installed in a computer. Here, examples of the computer includes a computer incorporated into dedicated hardware and a general purpose personal computer that includes various programs installed therein and is capable of executing various kinds of functions.

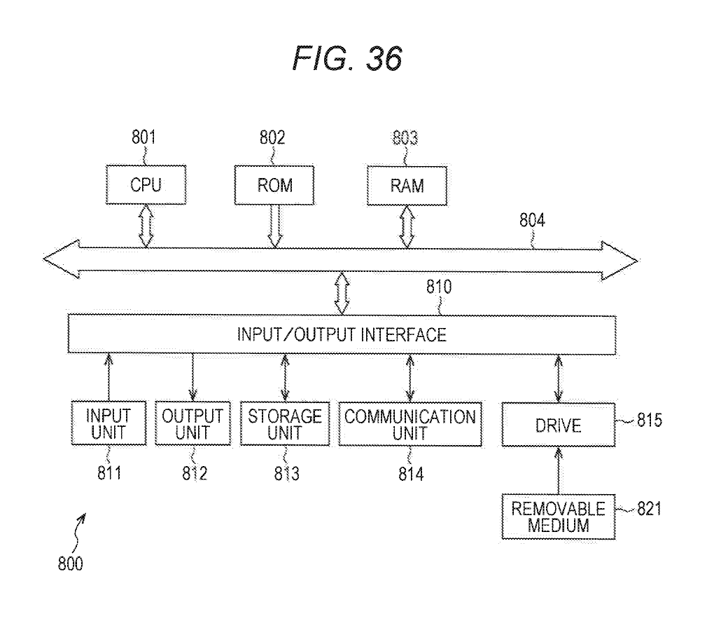

FIG. 36 is a block diagram illustrating an exemplary hardware configuration of a computer that executes the above-described series of processes by a program.

In a computer 800 illustrated in FIG. 36, a central processing unit (CPU) 801, a read only memory (RON) 802, and a random access memory (RAM) 803 are connected with one another via a bus 804.

An input/output (I/O) interface 810 is also connected to the bus 804. An input unit 811, an output unit 812, a storage unit 813, a communication unit 814, and a drive 815 are connected to the input/output interface 810.

For example, the input unit 811 includes a keyboard, a mouse, a microphone, a touch panel, an input terminal, and the like. For example, the output unit 812 includes a display, a speaker, an output terminal, and the like. For example, the storage unit 813 includes a hard disk, a RAM disk, a non-volatile memory, and the like. For example, the communication unit 814 includes a network interface. The drive 815 drives a removable medium 821 such as a magnetic disk, an optical disk, a magneto optical disk, or a semiconductor memory.

In the computer having the above configuration, the CPU 801 executes the above-described series of processes, for example, by loading the program stored in the storage unit 813 onto the RAM 803 through the input/output interface 810 and the bus 804 and executing the program. The RAM 803 also appropriately stores, for example, data necessary when the CPU 801 executes various kinds of processes.

For example, the program executed by the computer (the CPU 801) may be recorded in the removable medium 821 as a package medium or the like and applied. Further, the program may be provided through a wired or wireless transmission medium such as a local area network (LAN), the Internet, or digital satellite broadcasting.

In the computer, the removable medium 821 is mounted to the drive 815, and then the program may be installed in the storage unit 813 through the input/output interface 810. Further, the program may be received by the communication unit 814 via a wired or wireless transmission medium and then installed in the storage unit 813. In addition, the program may be installed in the RON 802 or the storage unit 813 in advance.

Further, the program executed by a computer may be a program in which the processes are chronologically performed in the order described in this specification or may be a program in which the processes are performed in parallel or at necessary timings such as called timings.

Further, in the present specification, steps describing a program recorded in a recording medium include not only processes chronologically performed according to a described order but also processes that are not necessarily chronologically processed but performed in parallel or individually.

In the present specification, a system represents a set of a plurality of components (devices, modules (parts), and the like), and all components need not be necessarily arranged in a single housing. Thus, both a plurality of devices that are arranged in individual housings and connected with one another via a network and a single device including a plurality of modules arranged in a single housing are regarded as a system.

Further, a configuration described as one device (or processing unit) may be divided into a plurality of devices (or processing units). Conversely, a configuration described as a plurality of devices (or processing units) may be integrated into one device (or processing unit). Further, a configuration other than the above-described configuration may be added to a configuration of each device (or each processing unit). In addition, when a configuration or an operation in an entire system is substantially the same, a part of a configuration of a certain device (or processing unit) may be included in a configuration of another device (or another processing unit).

The preferred embodiments of the present disclosure have been described above with reference to the accompanying drawings, whilst the technical scope of the present disclosure is not limited to the above examples. A person skilled in the art of the present disclosure may find various alterations and modifications within the scope of the appended claims, and it should be understood that they will naturally come under the technical scope of the present disclosure.

For example, the present technology may have a configuration of cloud computing in which a plurality of devices share and process one function together via a network.

Further, the steps described in the above flowcharts may be executed by a single device or may be shared and executed by a plurality of devices.

Furthermore, when a plurality of processes are included in a single step, the plurality of processes included in the single step may be executed by a single device or may be shared and executed by a plurality of devices.

The image coding devices and the image decoding devices according to the above embodiments can be applied to satellite broadcasting, cable broadcasting such as cable televisions, transmitters or receivers in delivery on the Internet or delivery to terminals by cellular communications, recording devices that record images in a medium such as an optical disk, a magnetic disk, or a flash memory, or various electronic devices such as reproducing devices that reproduce images from a storage medium. 4 application examples will be described below.

### 5. APPLICATION EXAMPLES

### First Application Example

### Television Receiver

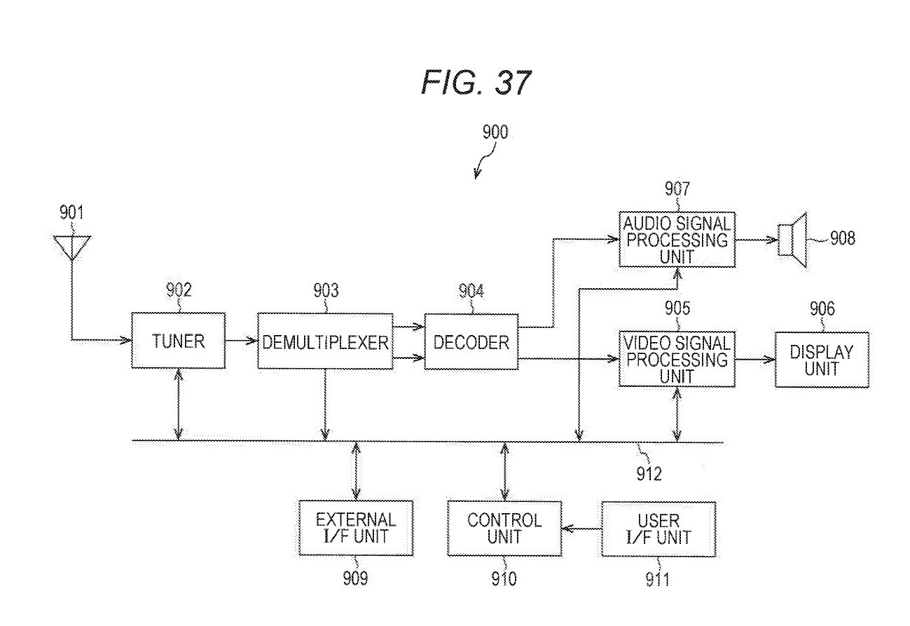

FIG. 37 illustrates an exemplary schematic configuration of a television device to which the above embodiment is applied. A television device 900 includes an antenna 901, a tuner 902, a demultiplexer 903, a decoder 904, a video signal processing unit 905, a display unit 906, an audio signal processing unit 907, a speaker 908, an external interface 909, a control unit 910, a user interface 911, and a bus 912.

The tuner 902 extracts a signal of a desired channel from a broadcast signal received through the antenna 901, and demodulates an extracted signal. Further, the tuner 902 outputs an encoded bit stream obtained by the demodulation to the demultiplexer 903. In other words, the tuner 902 receives an encoded stream including an encoded image, and serves as a transmitting unit in the television device 900.

The demultiplexer 903 demultiplexes a video stream and an audio stream of a program of a viewing target from an encoded bit stream, and outputs each demultiplexed stream to the decoder 904. Further, the demultiplexer 903 extracts auxiliary data such as an electronic program guide (EPG) from the encoded bit stream, and supplies the extracted data to the control unit 910. Further, when the encoded bit stream has been scrambled, the demultiplexer 903 may perform descrambling.

The decoder 904 decodes the video stream and the audio stream input from the demultiplexer 903. The decoder 904 outputs video data generated by the decoding process to the video signal processing unit 905. Further, the decoder 904 outputs audio data generated by the decoding process to the audio signal processing unit 907.

The video signal processing unit 905 reproduces the video data input from the decoder 904, and causes a video to be displayed on the display unit 906. Further, the video signal processing unit 905 may causes an application screen supplied via a network to be displayed on the display unit 906. The video signal processing unit 905 may perform an additional process such as a noise reduction process on the video data according to a setting. The video signal processing unit 905 may generate an image of a graphical user interface (GUI) such as a menu, a button, or a cursor and cause the generated image to be superimposed on an output image.

The display unit 906 is driven by a drive signal supplied from the video signal processing unit 905, and displays a video or an image on a video plane of a display device (for example, a liquid crystal display, a plasma display, or an organic electroluminescence display (OELD) (an organic EL display)).

The audio signal processing unit 907 performs a reproduction process such as D/A conversion and amplification on the audio data input from the decoder 904, and outputs a sound through the speaker 908. The audio signal processing unit 907 may perform an additional process such as a noise reduction process on the audio data.

The external interface 909 is an interface for connecting the television device 900 with an external device or a network. For example, the video stream or the audio stream received through the external interface 909 may be decoded by the decoder 904. In other words, the external interface 909 also undertakes a transmitting unit of the television device 900 that receives an encoded stream including an encoded image.

The control unit 910 includes a processor such as a CPU and a memory such as a RAM or a ROM. For example, the memory stores a program executed by the CPU, program data, EPG data, and data acquired via a network. For example, the program stored in the memory is read and executed by the CPU when the television device 900 is activated. The CPU executes the program, and controls an operation of the television device 900, for example, according to an operation signal input from the user interface 911.

The user interface 911 is connected with the control unit 910. For example, the user interface 911 includes a button and a switch used when the user operates the television device 900 and a receiving unit receiving a remote control signal. The user interface 911 detects the user's operation through the components, generates an operation signal, and outputs the generated operation signal to the control unit 910.

The bus 912 connects the tuner 902, the demultiplexer 903, the decoder 904, the video signal processing unit 905, the audio signal processing unit 907, the external interface 909, and the control unit 910 with one another.

In the television device 900 having the above configuration, the decoder 904 has the function of the scalable decoding device 200 according to the above embodiment. Thus, when an image is decoded in the television device 900, it is possible to perform an inter-layer associated process smoothly. In other words, a decrease in the image quality of the current image to be output can be suppressed. Alternatively, it is possible to perform the scalable encoding process including 64 or more layers.

### Second Application Example

### Mobile Telephone

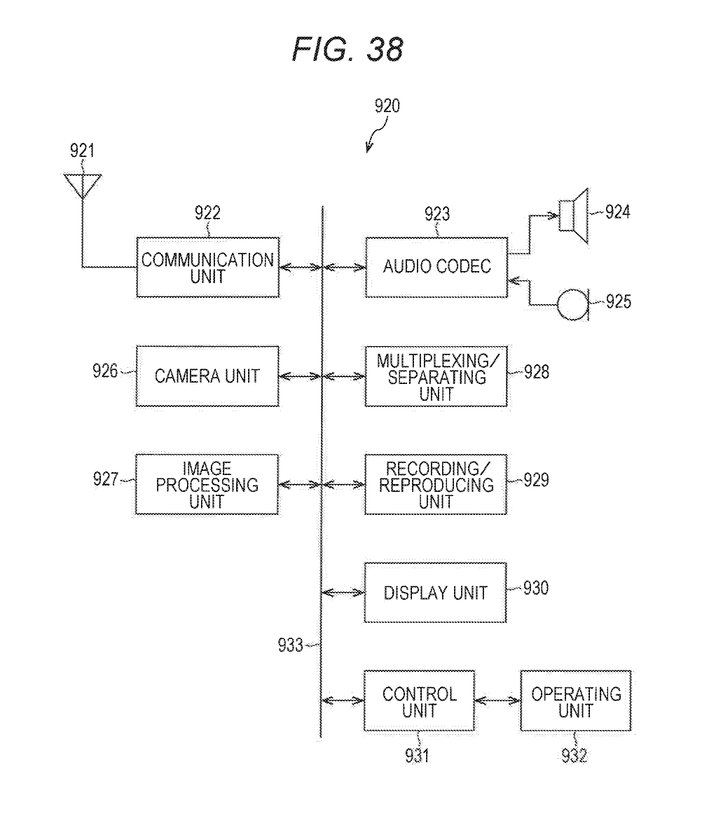

FIG. 38 illustrates an exemplary schematic configuration of a mobile telephone to which the above embodiment is applied. A mobile telephone 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operating unit 932, and a bus 933.

The antenna 921 is connected to the communication unit 922. The speaker 924 and the microphone 925 are connected to the audio codec 923. The operating unit 932 is connected to the control unit 931. The bus 933 connects the communication unit 922, the audio codec 923, the camera unit 926, the image processing unit 927, the multiplexing/separating unit 928, the recording/reproducing unit 929, the display unit 930, and the control unit 931 with one another.

The mobile telephone 920 performs operations such as transmission and reception of an audio signal, transmission and reception of an electronic mail or image data, image imaging, and data recording in various operation modes such as a voice call mode, a data communication mode, a shooting mode, and a video phone mode.

In the voice call mode, an analog audio signal generated by the microphone 925 is supplied to the audio codec 923. The audio codec 923 converts the analog audio signal into audio data, and performs A/D conversion and compression on the converted audio data. Then, the audio codec 923 outputs the compressed audio data to the communication unit 922. The communication unit 922 encodes and modulates the audio data, and generates a transmission signal. Then, the communication unit 922 transmits the generated transmission signal to a base station (not illustrated) through the antenna 921. Further, the communication unit 922 amplifies a wireless signal received through the antenna 921, performs frequency transform, and acquires a reception signal. Then, the communication unit 922 demodulates and decodes the reception signal, generates audio data, and outputs the generated audio data to the audio codec 923. The audio codec 923 decompresses the audio data, performs D/A conversion, and generates an analog audio signal. Then, the audio codec 923 supplies the generated audio signal to the speaker 924 so that a sound is output.

Further, in the data communication mode, for example, the control unit 931 generates text data configuring an electronic mail according to the user's operation performed through the operating unit 932. The control unit 931 causes a text to be displayed on the display unit 930. The control unit 931 generates electronic mail data according to a transmission instruction given from the user through the operating unit 932, and outputs the generated electronic mail data to the communication unit 922. The communication unit 922 encodes and modulates the electronic mail data, and generates a transmission signal. Then, the communication unit 922 transmits the generated transmission signal to base station (not illustrated) through the antenna 921. Further, the communication unit 922 amplifies a wireless signal received through the antenna 921, performs frequency transform, and acquires a reception signal. Then, the communication unit 922 demodulates and decodes the reception signal, restores electronic mail data, and outputs the restored electronic mail data to the control unit 931. The control unit 931 causes content of the electronic mail to be displayed on the display unit 930, and stores the electronic mail data in a storage medium of the recording/reproducing unit 929.

The recording/reproducing unit 929 includes an arbitrary readable/writable storage medium. For example, the storage medium may be a built-in storage medium such as a RAM or a flash memory or a removable storage medium such as a hard disk, a magnetic disk, a magneto optical disk, an optical disk, a universal serial bus (USB) memory, or a memory card.

In the shooting mode, for example, the camera unit 926 images a subject, generates image data, and outputs the generated image data to the image processing unit 927. The image processing unit 927 encodes the image data input from the camera unit 926, and stores the encoded stream in a storage medium of the recording/reproducing unit 929.

In the video phone mode, for example, the multiplexing/separating unit 928 multiplexes the video stream encoded by the image processing unit 927 and the audio stream input from the audio codec 923, and outputs the multiplexed stream to the communication unit 922. The communication unit 922 encodes and modulates the stream, and generates a transmission signal. Then, the communication unit 922 transmits the generated transmission signal to a base station (not illustrated) through the antenna 921. Further, the communication unit 922 amplifies a wireless signal received through the antenna 921, performs frequency transform, and acquires a reception signal. The transmission signal and the reception signal may include an encoded bit stream. Then, the communication unit 922 demodulates and decodes the reception signal, and restores a stream, and outputs the restore stream to the multiplexing/separating unit 928. The multiplexing/separating unit 928 separates a video stream and an audio stream from the input stream, and outputs the video stream and the audio stream to the image processing unit 927 and the audio codec 923, respectively. The image processing unit 927 decodes the video stream, and generates video data. The video data is supplied to the display unit 930, and a series of images are displayed by the display unit 930. The audio codec 923 decompresses the audio stream, performs D/A conversion, and generates an analog audio signal. Then, the audio codec 923 supplies the generated audio signal to the speaker 924 so that a sound is output.

In the mobile telephone 920 having the above configuration, the image processing unit 927 has the functions of the scalable encoding device 100 and the scalable decoding device 200 according to the above embodiment. Thus, when the mobile telephone 920 encodes and decodes an image, it is possible to perform an inter-layer associated process smoothly. In other words, a decrease in the image quality of the current image to be output can be suppressed. Alternatively, it is possible to perform the scalable encoding process including 64 or more layers.

### Third Application Example

### Recording/Reproducing Device

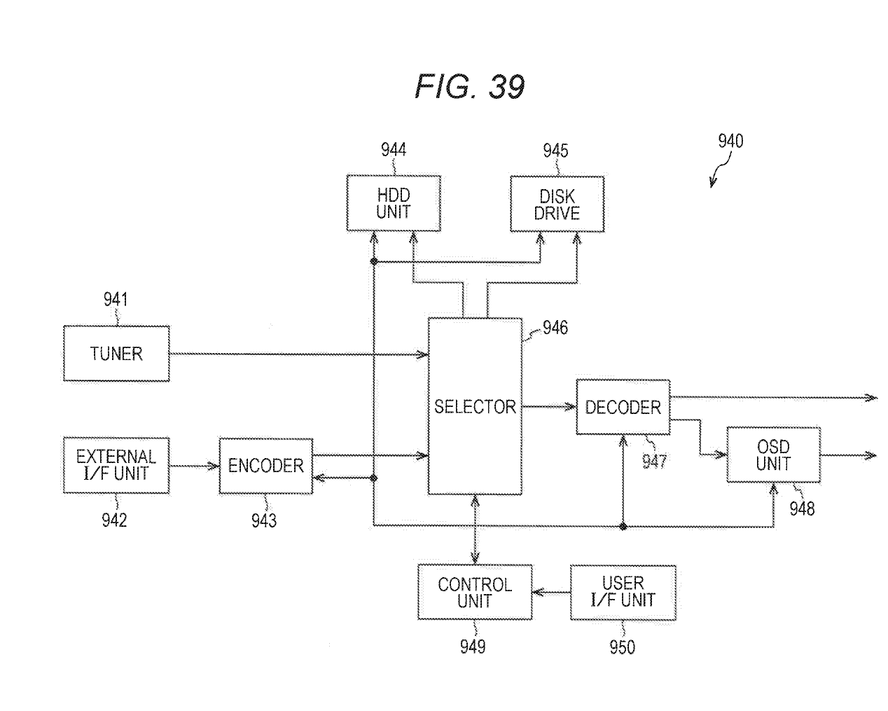

FIG. 39 illustrates an exemplary schematic configuration of a recording/reproducing device to which the above embodiment is applied. For example, a recording/reproducing device 940 encodes audio data and video data of a received broadcast program, and stores the encoded data in a recording medium. For example, the recording/reproducing device 940 may encode audio data and video data acquired from another device and record the encoded data in a recording medium. For example, the recording/reproducing device 940 reproduces data recorded in a recording medium through a monitor and a speaker according to the user's instruction. At this time, the recording/reproducing device 940 decodes the audio data and the video data.

The recording/reproducing device 940 includes a tuner 941, an external I/F 942, an encoder 943, a hard disk drive (HDD) 944, a disk drive 945, a selector 946, a decoder 947, an on-screen display (OSD) 948, a control unit 949, and a user I/F 950.

The tuner 941 extracts of a signal of a desired channel from a broadcast signal received through an antenna (not illustrated), and demodulates the extracted signal. Then, the tuner 941 outputs an encoded bit stream obtained by the demodulation to the selector 946. In other words, the tuner 941 undertakes a transmitting unit in the recording/reproducing device 940.

The external interface 942 is an interface for connecting the recording/reproducing device 940 with an external device or a network. For example, the external interface 942 may be an IEEE1394 interface, a network interface, a USB interface, or a flash memory interface. For example, video data and audio data received via the external interface 942 are input to the encoder 943. In other words, the external interface 942 undertakes a transmitting unit in the recording/reproducing device 940.

When video data and audio data input from the external interface 942 are not encoded, the encoder 943 encodes the video data and the audio data. Then, the encoder 943 outputs an encoded bit stream to the selector 946.

The HDD 944 records an encoded bit stream in which content data such as a video or a sound is compressed, various kinds of programs, and other data in an internal hard disk. The HDD 944 reads the data from the hard disk when a video or a sound is reproduced.

The disk drive 945 records or reads data in or from a mounted recording medium. For example, the recording medium mounted in the disk drive 945 may be a DVD disk (DVD-Video, DVD-RAM, DVD-R, DVD-RW, DVD+R, DVD+RW, or the like), a Blu-ray (a registered trademark) disk, or the like.

When a video or a sound is recorded, the selector 946 selects an encoded bit stream input from the tuner 941 or the encoder 943, and outputs the selected encoded bit stream to the HDD 944 or the disk drive 945. Further, when a video or a sound is reproduced, the selector 946 outputs an encoded bit stream input from the HDD 944 or the disk drive 945 to the decoder 947.

The decoder 947 decodes the encoded bit stream, and generates video data and audio data. Then, the decoder 947 outputs the generated video data to the OSD 948. The decoder 904 outputs the generated audio data to an external speaker.

The OSD 948 reproduces the video data input from the decoder 947, and displays a video. For example, the OSD 948 may cause an image of a GUI such as a menu, a button, or a cursor to be superimposed on a displayed video.

The control unit 949 includes a processor such as a CPU and a memory such as a RAM or a RON. The memory stores a program executed by the CPU, program data, and the like. For example, the program stored in the memory is read and executed by the CPU when the recording/reproducing device 940 is activated. The CPU executes the program, and controls an operation of the recording/reproducing device 940, for example, according to an operation signal input from the user interface 950.

The user interface 950 is connected with the control unit 949. For example, the user interface 950 includes a button and a switch used when the user operates the recording/reproducing device 940 and a receiving unit receiving a remote control signal. The user interface 950 detects the user's operation through the components, generates an operation signal, and outputs the generated operation signal to the control unit 949.

In the recording/reproducing device 940 having the above configuration, the encoder 943 has the function of the scalable encoding device 100 according to the above embodiment. The decoder 947 has the function of the scalable decoding device 200 according to the above embodiment. Thus, when the recording/reproducing device 940 encodes and decodes an image, it is possible to perform an inter-layer associated process smoothly. In other words, a decrease in the image quality of the current image to be output can be suppressed. Alternatively, it is possible to perform the scalable encoding process including 64 or more layers.

### Fourth Application Example

### Imaging Device

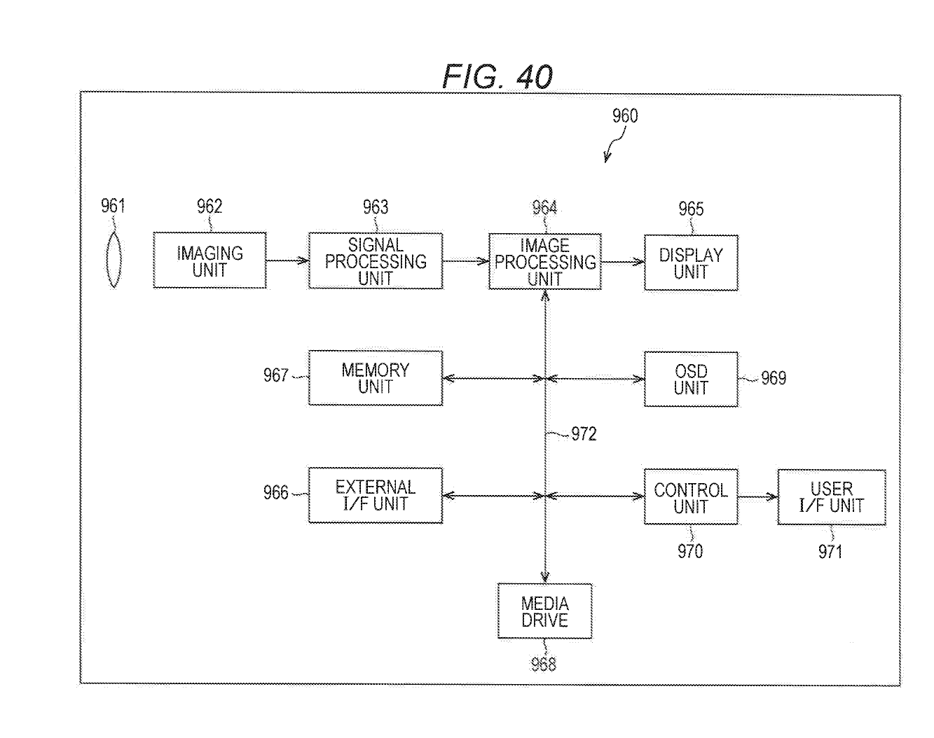

FIG. 40 illustrates an exemplary schematic configuration of an imaging device to which the above embodiment is applied. An imaging device 960 images a subject, generates an image, encodes image data, and records the image data in a recording medium.

The imaging device 960 includes an optical block 961, an imaging unit 962, a signal processing unit 963, an image processing unit 964, a display unit 965, an external I/F 966, a memory 967, a media drive 968, an OSD 969, a control unit 970, a user I/F 971, and a bus 972.

The optical block 961 is connected to the imaging unit 962. The imaging unit 962 is connected to the signal processing unit 963. The display unit 965 is connected to the image processing unit 964. The user interface 971 is connected to the control unit 970. The bus 972 connects the image processing unit 964, the external interface 966, the memory 967, the medium drive 968, the OSD 969, and the control unit 970 with one another.

The optical block 961 includes a focus lens and a diaphragm mechanism. The optical block 961 forms an optical image of a subject on an imaging plane of the imaging unit 962. The imaging unit 962 includes a CCD (charge coupled device) image sensor or a CMOS (complementary metal oxide semiconductor) image sensor, or the like, and converts the optical image formed on the imaging plane into an image signal serving as an electric signal by photoelectric conversion. Then, the imaging unit 962 outputs the image signal to the signal processing unit 963.

The signal processing unit 963 performs various kinds of camera signal processes such as knee correction, gamma correction, and color correction on the image signal input from the imaging unit 962. The signal processing unit 963 outputs the image data that has been subjected to the camera signal processes to the image processing unit 964.

The image processing unit 964 encodes the image data input from the signal processing unit 963, and generates encoded data. Then, the image processing unit 964 outputs the generated encoded data to the external interface 966 or the medium drive 968. Further, the image processing unit 964 decodes encoded data input from the external interface 966 or the medium drive 968, and generates image data. Then, the image processing unit 964 outputs the generated image data to the display unit 965. The image processing unit 964 may output the image data input from the signal processing unit 963 to the display unit 965 so that an image is displayed. The image processing unit 964 may cause display data acquired from the OSD 969 to be superimposed on an image output to the display unit 965.

The OSD 969 generates an image of a GUI such as a menu, a button, or a cursor, and outputs the generated image to the image processing unit 964.

For example, the external interface 966 is configured as an USB I/O terminal. For example, the external interface 966 connects the imaging device 960 with a printer when an image is printed. Further, a drive is connected to the external interface 966 as necessary. For example, a removable medium such as a magnetic disk or an optical disk may be mounted in the drive, and a program read from the removable medium may be installed in the imaging device 960. Further, the external interface 966 may be configured as a network interface connected to a network such as an LAN or the Internet. In other words, the external interface 966 undertakes a transmitting unit in the imaging device 960.

The recording medium mounted in the medium drive 968 may be an arbitrary readable/writable removable medium such as a magnetic disk, a magneto optical disk, an optical disk, or a semiconductor memory. Further, a recording medium may be fixedly mounted in the medium drive 968, and for example, a non-transitory storage unit such as a built-in hard disk drive or a solid state drive (SSD) may be configured.

The control unit 970 includes a processor such as a CPU and a memory such as a RAM or a RON. For example, the memory stores a program executed by the CPU, program data, and the like. For example, the program stored in the memory is read and executed by the CPU when the imaging device 960 is activated. The CPU executes the program, and controls an operation of the imaging device 960, for example, according to an operation signal input from the user interface 971.

The user interface 971 is connected with the control unit 970. For example, the user interface 971 includes a button, a switch, or the like which is used when the user operates the imaging device 960. The user interface 971 detects the user's operation through the components, generates an operation signal, and outputs the generated operation signal to the control unit 970.

In the imaging device 960 having the above configuration, the image processing unit 964 has the functions of the scalable encoding device 100 and the scalable decoding device 200 according to the above embodiment. Thus, when the imaging device 960 encodes and decodes an image, it is possible to perform an inter-layer associated process smoothly. In other words, a decrease in the image quality of the current image to be output can be suppressed. Alternatively, it is possible to perform the scalable encoding process including 64 or more layers.

### 6. APPLICATIONS OF SCALABLE CODING

<First System>

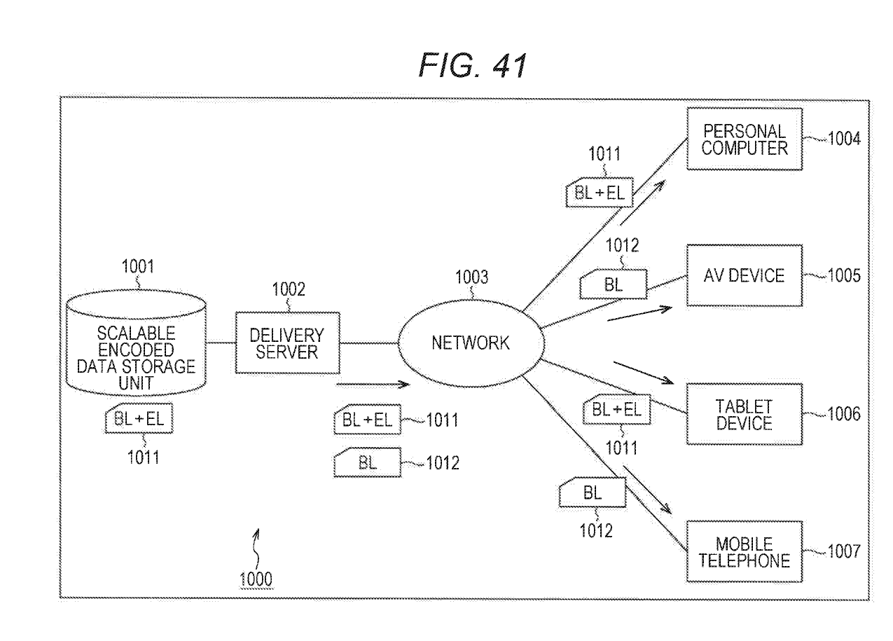

Next, specific application examples of scalable encoded data generated by scalable coding will be described. The scalable coding is used for selection of data to be transmitted, for example, as illustrated in FIG. 41.

In a data transmission system 1000 illustrated in FIG. 41, a delivery server 1002 reads scalable encoded data stored in a scalable encoded data storage unit 1001, and delivers the scalable encoded data to terminal devices such as a personal computer 1004, an AV device 1005, a tablet device 1006, and a mobile telephone 1007 via a network 1003.

At this time, the delivery server 1002 selects an appropriate high-quality encoded data according to the capabilities of the terminal devices or a communication environment, and transmits the selected high-quality encoded data. Although the delivery server 1002 transmits unnecessarily high-quality data, the terminal devices do not necessarily obtain a high-quality image, and a delay or an overflow may occur. Further, a communication band may be unnecessarily occupied, and a load of a terminal device may be unnecessarily increased. On the other hand, although the delivery server 1002 transmits unnecessarily low-quality data, the terminal devices are unlikely to obtain an image of a sufficient quality. Thus, the delivery server 1002 reads scalable encoded data stored in the scalable encoded data storage unit 1001 as encoded data of a quality appropriate for the capability of the terminal device or a communication environment, and then transmits the read data.

For example, the scalable encoded data storage unit 1001 is assumed to store scalable encoded data (BL+EL) 1011 that is encoded by the scalable coding. The scalable encoded data (BL+EL) 1011 is encoded data including both of a base layer and an enhancement layer, and both an image of the base layer and an image of the enhancement layer can be obtained by decoding the scalable encoded data (BL+EL) 1011.

The delivery server 1002 selects an appropriate layer according to the capability of a terminal device to which data is transmitted or a communication environment, and reads data of the selected layer. For example, for the personal computer 1004 or the tablet device 1006 having a high processing capability, the delivery server 1002 reads the high-quality scalable encoded data (BL+EL) 1011 from the scalable encoded data storage unit 1001, and transmits the scalable encoded data (BL+EL) 1011 without change. On the other hand, for example, for the AV device 1005 or the mobile telephone 1007 having a low processing capability, the delivery server 1002 extracts data of the base layer from the scalable encoded data (BL+EL) 1011, and transmits a scalable encoded data (BL) 1012 that is the same content as the scalable encoded data (BL+EL) 1011 but lower in quality than the scalable encoded data (BL+EL) 1011.

As described above, an amount of data can be easily adjusted using scalable encoded data, and thus it is possible to prevent the occurrence of a delay or an overflow and prevent a load of a terminal device or a communication medium from being unnecessarily increased. Further, the scalable encoded data (BL+EL) 1011 is reduced in redundancy between layers, and thus it is possible to reduce an amount of data to be smaller than when individual data is used as encoded data of each layer. Thus, it is possible to more efficiently use a memory area of the scalable encoded data storage unit 1001.

Further, various devices such as the personal computer 1004 to the mobile telephone 1007 can be applied as the terminal device, and thus the hardware performance of the terminal devices differ according to each device. Further, since various applications can be executed by the terminal devices, software has various capabilities. Furthermore, all communication line networks including either or both of a wired network and a wireless network such as the Internet or a local area network (LAN), can be applied as the network 1003 serving as a communication medium, and thus various data transmission capabilities are provided. In addition, a change may be made by another communication or the like.

In this regard, the delivery server 1002 may be configured to perform communication with a terminal device serving as a transmission destination of data before starting data transmission and obtain information related to a capability of a terminal device such as hardware performance of a terminal device or a performance of an application (software) executed by a terminal device and information related to a communication environment such as an available bandwidth of the network 1003. Then, the delivery server 1002 may select an appropriate layer based on the obtained information.

Further, the extracting of the layer may be performed in a terminal device. For example, the personal computer 1004 may decode the transmitted scalable encoded data (BL+EL) 1011 and display the image of the base layer or the image of the enhancement layer. Further, for example, the personal computer 1004 may extract the scalable encoded data (BL) 1012 of the base layer from the transmitted scalable encoded data (BL+EL) 1011, store the scalable encoded data (BL) 1012 of the base layer, transfer the scalable encoded data (BL) 1012 of the base layer to another device, decode the scalable encoded data (BL) 1012 of the base layer, and display the image of the base layer.

Of course, the number of the scalable encoded data storage units 1001, the number of the delivery servers 1002, the number of the networks 1003, and the number of terminal devices are arbitrary. The above description has been made in connection with the example in which the delivery server 1002 transmits data to the terminal devices, but the application example is not limited to this example. The data transmission system 1000 can be applied to any system in which when encoded data generated by the scalable coding is transmitted to a terminal device, an appropriate layer is selected according to a capability of a terminal device or a communication environment, and the encoded data is transmitted.

In the data transmission system 1000, the present technology is applied, similarly to the application to the scalable encoding and the scalable decoding described above in the first and second embodiments, and thus the same effects as the effects described above in the first and second embodiments can be obtained.

<Second System>

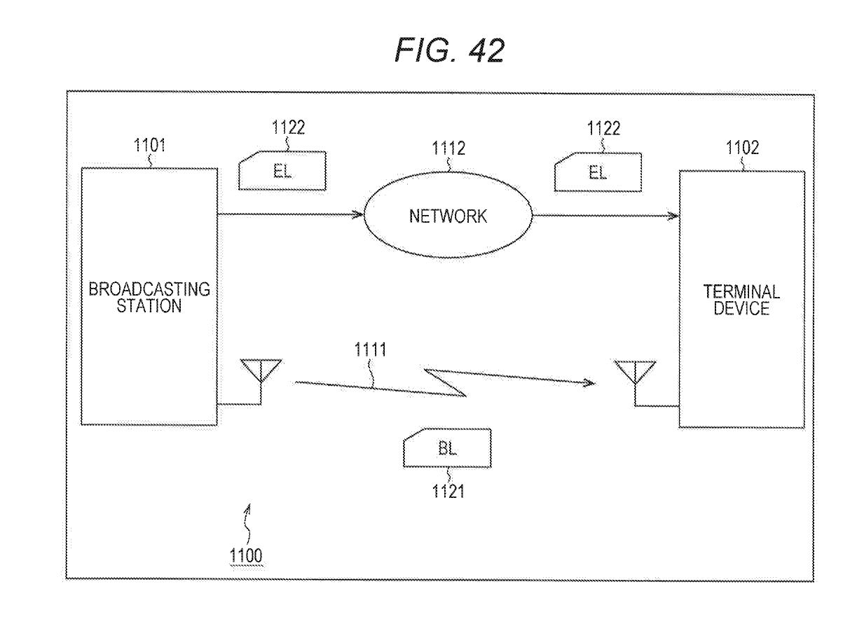

The scalable coding is used for transmission using a plurality of communication media, for example, as illustrated in FIG. 42.

In a data transmission system 1100 illustrated in FIG. 42, a broadcasting station 1101 transmits scalable encoded data (BL) 1121 of abase layer through terrestrial broadcasting 1111. Further, the broadcasting station 1101 transmits scalable encoded data (EL) 1122 of an enhancement layer (for example, packetizes the scalable encoded data (EL) 1122 and then transmits resultant packets) via an arbitrary network 1112 configured with a communication network including either or both of a wired network and a wireless network.

A terminal device 1102 has a reception function of receiving the terrestrial broadcasting 1111 broadcast by the broadcasting station 1101, and receives the scalable encoded data (BL) 1121 of the base layer transmitted through the terrestrial broadcasting 1111. The terminal device 1102 further has a communication function of performing communication via the network 1112, and receives the scalable encoded data (EL) 1122 of the enhancement layer transmitted via the network 1112.

The terminal device 1102 decodes the scalable encoded data (BL) 1121 of the base layer acquired through the terrestrial broadcasting 1111, for example, according to the user's instruction or the like, obtains the image of the base layer, stores the obtained image, and transmits the obtained image to another device.

Further, the terminal device 1102 combines the scalable encoded data (BL) 1121 of the base layer acquired through the terrestrial broadcasting 1111 with the scalable encoded data (EL) 1122 of the enhancement layer acquired through the network 1112, for example, according to the user's instruction or the like, obtains the scalable encoded data (BL+EL), decodes the scalable encoded data (BL+EL) to obtain the image of the enhancement layer, stores the obtained image, and transmits the obtained image to another device.

As described above, it is possible to transmit scalable encoded data of respective layers, for example, through different communication media. Thus, it is possible to distribute a load, and it is possible to prevent the occurrence of a delay or an overflow.

Further, it is possible to select a communication medium used for transmission for each layer according to the situation. For example, the scalable encoded data (BL) 1121 of the base layer having a relative large amount of data may be transmitted through a communication medium having a large bandwidth, and the scalable encoded data (EL) 1122 of the enhancement layer having a relative small amount of data may be transmitted through a communication medium having a small bandwidth. Further, for example, a communication medium for transmitting the scalable encoded data (EL) 1122 of the enhancement layer may be switched between the network 1112 and the terrestrial broadcasting 1111 according to an available bandwidth of the network 1112. Of course, the same applies to data of an arbitrary layer.

As control is performed as described above, it is possible to further suppress an increase in a load in data transmission.

Of course, the number of layers is arbitrary, and the number of communication media used for transmission is also arbitrary. Further, the number of the terminal devices 1102 serving as a data delivery destination is also arbitrary. The above description has been made in connection with the example of broadcasting from the broadcasting station 1101, and the application example is not limited to this example. The data transmission system 1100 can be applied to any system in which encoded data generated by the scalable coding is divided into two or more in units of layers and transmitted through a plurality of lines.

In the data transmission system 1100, the present technology is applied, similarly to the application to the scalable encoding and the scalable decoding described above in the first and second embodiments, and thus the same effects as the effects described above in the first and second embodiments can be obtained.

<Third System>

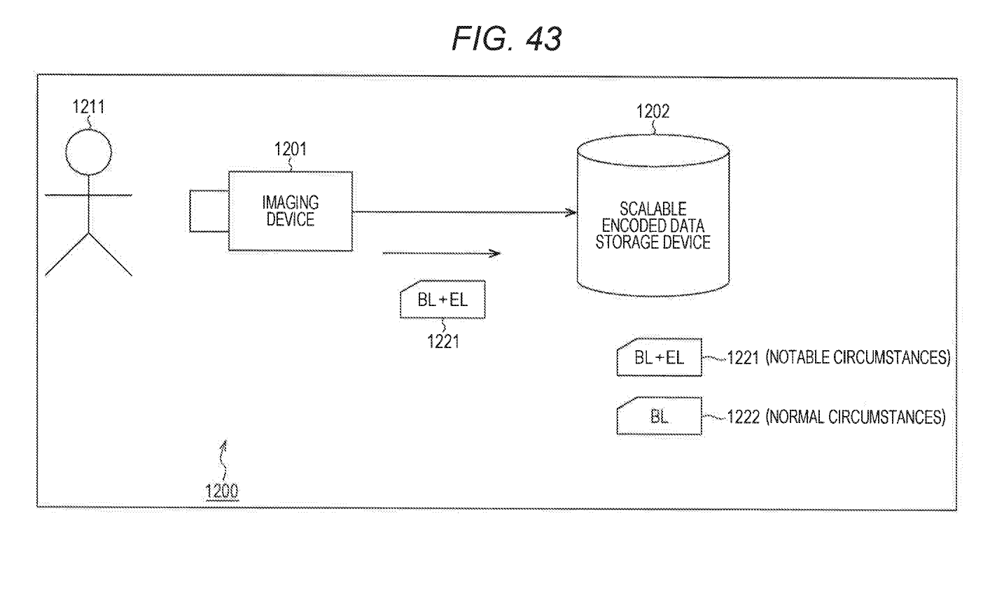

The scalable coding is used for storage of encoded data, for example, as illustrated in FIG. 43.

In an imaging system 1200 illustrated in FIG. 43, an imaging device 1201 photographs a subject 1211, performs the scalable coding on obtained image data, and provides scalable encoded data (BL+EL) 1221 to a scalable encoded data storage device 1202.

The scalable encoded data storage device 1202 stores the scalable encoded data (BL+EL) 1221 provided from the imaging device 1201 in a quality according to the situation. For example, during a normal time, the scalable encoded data storage device 1202 extracts data of the base layer from the scalable encoded data (BL+EL) 1221, and stores the extracted data as scalable encoded data (BL) 1222 of the base layer having a small amount of data in a low quality. On the other hand, for example, during an observation time, the scalable encoded data storage device 1202 stores the scalable encoded data (BL+EL) 1221 having a large amount of data in a high quality without change.

Accordingly, the scalable encoded data storage device 1202 can store an image in a high quality only when necessary, and thus it is possible to suppress an increase in an amount of data and improve use efficiency of a memory area while suppressing a reduction in a value of an image caused by quality deterioration.

For example, the imaging device 1201 is a monitoring camera. When monitoring target (for example, intruder) is not shown on a photographed image (during a normal time), content of the photographed image is likely to be inconsequential, and thus a reduction in an amount of data is prioritized, and image data (scalable encoded data) is stored in a low quality. On the other hand, when a monitoring target is shown on a photographed image as the subject 1211 (during an observation time), content of the photographed image is likely to be consequential, and thus an image quality is prioritized, and image data (scalable encoded data) is stored in a high quality.

It may be determined whether it is the normal time or the observation time, for example, by analyzing an image through the scalable encoded data storage device 1202. Further, the imaging device 1201 may perform the determination and transmit the determination result to the scalable encoded data storage device 1202.

Further, a determination criterion as to whether it is the normal time or the observation time is arbitrary, and content of an image serving as the determination criterion is arbitrary. Of course, a condition other than content of an image may be a determination criterion. For example, switching may be performed according to the magnitude or a waveform of a recorded sound, switching may be performed at certain time intervals, or switching may be performed according an external instruction such as the user's instruction.

The above description has been made in connection with the example in which switching is performed between two states of the normal time and the observation time, but the number of states is arbitrary. For example, switching may be performed among three or more states such as a normal time, a low-level observation time, an observation time, a high-level observation time, and the like. Here, an upper limit number of states to be switched depends on the number of layers of scalable encoded data.

Further, the imaging device 1201 may decide the number of layers for the scalable coding according to a state. For example, during the normal time, the imaging device 1201 may generate the scalable encoded data (BL) 1222 of the base layer having a small amount of data in a low quality and provide the scalable encoded data (BL) 1222 of the base layer to the scalable encoded data storage device 1202. Further, for example, during the observation time, the imaging device 1201 may generate the scalable encoded data (BL+EL) 1221 of the base layer having a large amount of data in a high quality and provide the scalable encoded data (BL+EL) 1221 of the base layer to the scalable encoded data storage device 1202.

The above description has been made in connection with the example of a monitoring camera, but the purpose of the imaging system 1200 is arbitrary and not limited to a monitoring camera.

In the imaging system 1200, the present technology is applied, similarly to the application to the scalable encoding and the scalable decoding described above in the first and second embodiments, and thus the same effects as the effects described above in the first and second embodiments can be obtained.

### 7. FOURTH EMBODIMENT

### Other Embodiments

The above embodiments have been described in connection with the example of the device, the system, or the like according to the present technology, but the present technology is not limited to the above examples and may be implemented as any component mounted in the device or the device configuring the system, for example, a processor serving as a system (large scale integration) LSI or the like, a module using a plurality of processors or the like, a unit using a plurality of modules or the like, a set (that is, some components of the device) in which any other function is further added to a unit, or the like.

<Video Set>

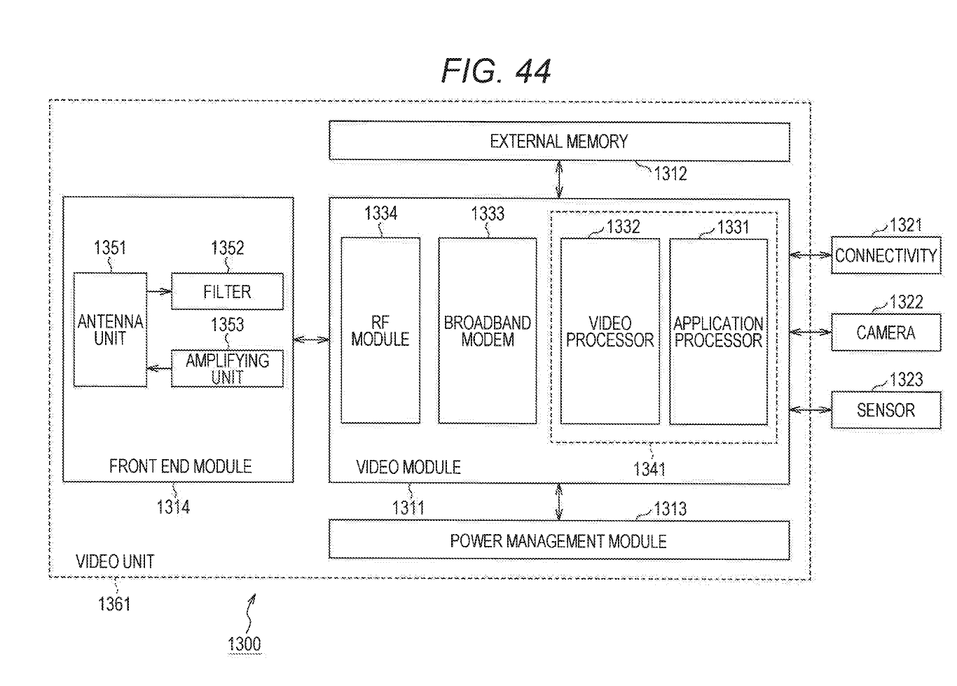

An example in which the present technology is implemented as a set will be described with reference to FIG. 44. FIG. 44 illustrates an exemplary schematic configuration of a video set to which the present technology is applied.

In recent years, functions of electronic devices have become diverse, and when some components are implemented as sale, provision, or the like in development or manufacturing, there are many cases in which a plurality of components having relevant functions are combined and implemented as a set having a plurality of functions as well as cases in which an implementation is performed as a component having a single function.

A video set 1300 illustrated in FIG. 44 is a multi-functionalized configuration in which a device having a function related to image encoding and/or image decoding is combined with a device having any other function related to the function.

As illustrated in FIG. 44, the video set 1300 includes a module group such as a video module 1311, an external memory 1312, a power management module 1313, and a front end module 1314 and a device having relevant functions such as a connectivity 1321, a camera 1322, and a sensor 1323.

A module is a part having multiple functions into which several relevant part functions are integrated. A specific physical configuration is arbitrary, but, for example, it is configured such that a plurality of processes having respective functions, electronic circuit elements such as a resistor and a capacitor, and other devices are arranged and integrated on a wiring substrate. Further, a new module may be obtained by combining another module or a processor with a module.

In the case of the example of FIG. 44, the video module 1311 is a combination of components having functions related to image processing, and includes an application processor, a video processor, a broadband modem 1333, and a radio frequency (RF) module 1334.

A processor is one in which a configuration having a certain function is integrated into a semiconductor chip through System On a Chip (SoC), and also refers to, for example, a system LSI or the like. The configuration having the certain function may be a logic circuit (hardware configuration), may be a CPU, a ROM, a RAM, and a program (software configuration) executed using the CPU, the RON, and the RAM, and may be a combination of a hardware configuration and a software configuration. For example, a processor may include a logic circuit, a CPU, a RON, a RAN, and the like, some functions may be implemented through the logic circuit (hardware configuration), and the other functions may be implemented through a program (software configuration) executed by the CPU.

The application processor 1331 of FIG. 44 is a processor that executes an application related to image processing. An application executed by the application processor 1331 can not only perform a calculation process but also control components inside and outside the video module 1311 such as the video processor 1332 as necessary in order to implement a certain function.

The video processor 1332 is a process having a function related to image encoding and/or image decoding.

The broadband modem 1333 is a processor (or module) that performs a process related to wired and/or wireless broadband communication that is performed via broadband line such as the Internet or a public telephone line network. For example, the broadband modem 1333 converts data (digital signal) to be transmitted into an analog signal, for example, through digital modulation, demodulates a received analog signal, and converts the analog signal into data (digital signal). For example, the broadband modem 1333 can perform digital modulation and demodulation on arbitrary information such as image data processed by the video processor 1332, a stream in which image data is encoded, an application program, or setting data.

The RF module 1334 is a module that performs a frequency transform process, a modulation/demodulation process, an amplification process, a filtering process, and the like on an RF signal transceived through an antenna. For example, the RF module 1334 performs, for example, frequency transform on a baseband signal generated by the broadband modem 1333, and generates an RF signal. Further, for example, the RF module 1334 performs, for example, frequency transform on an RF signal received through the front end module 1314, and generates a baseband signal.

Further, a dotted line 1341, that is, the application processor 1331 and the video processor 1332 may be integrated into a single processor as illustrated in FIG. 44.

The external memory 1312 is installed outside the video module 1311, and a module having a storage device used by the video module 1311. The storage device of the external memory 1312 can be implemented by any physical configuration, but is commonly used to store large capacity data such as image data of frame units, and thus it is desirable to implement the storage device of the external memory 1312 using a relatively cheap large-capacity semiconductor memory such as a dynamic random access memory (DRAM).

The power management module 1313 manages and controls power supply to the video module 1311 (the respective components in the video module 1311).

The front end module 1314 is a module that provides a front end function (a circuit of a transceiving end at an antenna side) to the RF module 1334. As illustrated in FIG. 44, the front end module 1314 includes, for example, an antenna unit 1351, a filter 1352, and an amplifying unit 1353.

The antenna unit 1351 includes an antenna that transceives a radio signal and a peripheral configuration. The antenna unit 1351 transmits a signal provided from the amplifying unit 1353 as a radio signal, and provides a received radio signal to the filter 1352 as an electrical signal (RF signal). The filter 1352 performs, for example, a filtering process on an RF signal received through the antenna unit 1351, and provides a processed RF signal to the RF module 1334. The amplifying unit 1353 amplifies the RF signal provided from the RF module 1334, and provides the amplified RF signal to the antenna unit 1351.

The connectivity 1321 is a module having a function related to a connection with the outside. A physical configuration of the connectivity 1321 is arbitrary. For example, the connectivity 1321 includes a configuration having a communication function other than a communication standard supported by the broadband modem 1333, an external I/O terminal, or the like.

For example, the connectivity 1321 may include a module having a communication function based on a wireless communication standard such as Bluetooth (a registered trademark), IEEE 802.11 (for example, Wireless Fidelity (Wi-Fi) (a registered trademark)), Near Field Communication (NFC), InfraRed Data Association (IrDA), an antenna that transceives a signal satisfying the standard, or the like. Further, for example, the connectivity 1321 may include a module having a communication function based on a wired communication standard such as Universal Serial Bus (USB), or High-Definition Multimedia Interface (HDMI) (a registered trademark) or a terminal that satisfies the standard. Furthermore, for example, the connectivity 1321 may include any other data (signal) transmission function or the like such as an analog I/O terminal.

Further, the connectivity 1321 may include a device of a transmission destination of data (signal). For example, the connectivity 1321 may include a drive (including a hard disk, a solid state drive (SSD), a Network Attached Storage (NAS), or the like as well as a drive of a removable medium) that reads/writes data from/in a recording medium such as a magnetic disk, an optical disk, a magneto optical disk, or a semiconductor memory. Furthermore, the connectivity 1321 may include an output device (a monitor, a speaker, or the like) that outputs an image or a sound.

The camera 1322 is a module having a function of photographing a subject and obtaining image data of the subject. For example, image data obtained by the photographing of the camera 1322 is provided to and encoded by the video processor 1332.

The sensor 1323 is a module having an arbitrary sensor function such as a sound sensor, an ultrasonic sensor, an optical sensor, an illuminance sensor, an infrared sensor, an image sensor, a rotation sensor, an angle sensor, an angular velocity sensor, a velocity sensor, an acceleration sensor, an inclination sensor, a magnetic identification sensor, a shock sensor, or a temperature sensor. For example, data detected by the sensor 1323 is provided to the application processor 1331 and used by an application or the like.

A configuration described above as a module may be implemented as a processor, and a configuration described as a processor may be implemented as a module.

In the video set 1300 having the above configuration, the present technology can be applied to the video processor 1332 as will be described later. Thus, the video set 1300 can be implemented as a set to which the present technology is applied.

<Exemplary Configuration of Video Processor>

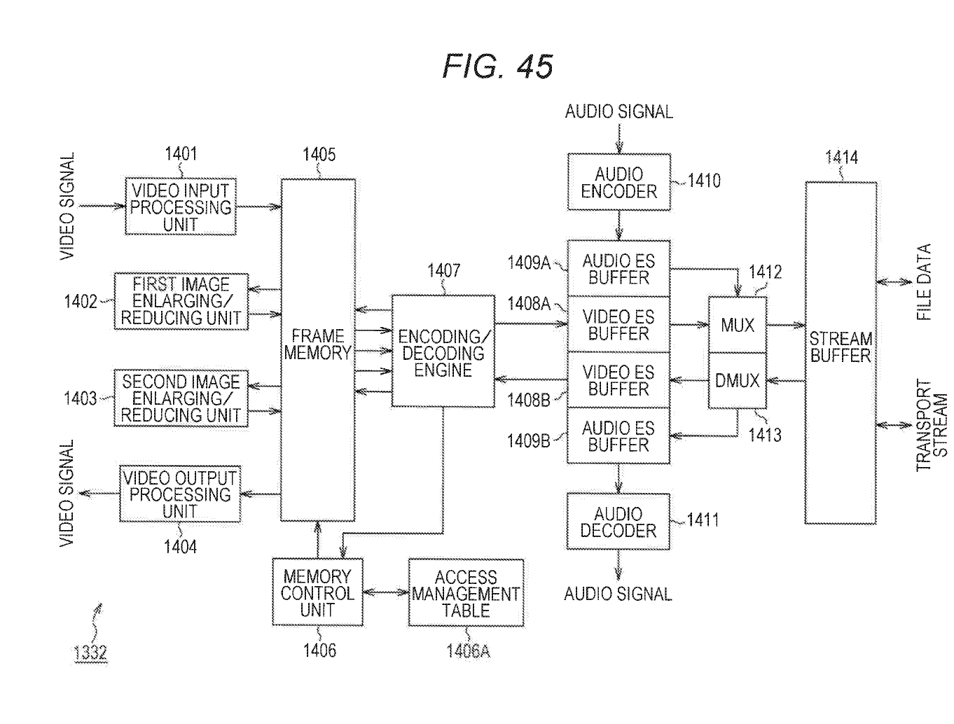

FIG. 45 illustrates an exemplary schematic configuration of the video processor 1332 (FIG. 44) to which the present technology is applied.

In the case of the example of FIG. 45, the video processor 1332 has a function of receiving an input of a video signal and an audio signal and encoding the video signal and the audio signal according to a certain scheme and a function of decoding encoded video data and audio data, and reproducing and outputting a video signal and an audio signal.

The video processor 1332 includes a video input processing unit 1401, a first image enlarging/reducing unit 1402, a second image enlarging/reducing unit 1403, a video output processing unit 1404, a frame memory 1405, and a memory control unit 1406 as illustrated in FIG. 45. The video processor 1332 further includes an encoding/decoding engine 1407, video elementary stream (ES) buffers 1408A and 1408B, and audio ES buffers 1409A and 1409B. The video processor 1332 further includes an audio encoder 1410, an audio decoder 1411, a multiplexer (multiplexer (MUX)) 1412, a demultiplexer (demultiplexer (DMUX)) 1413, and a stream buffer 1414.

For example, the video input processing unit 1401 acquires a video signal input from the connectivity 1321 (FIG. 44) or the like, and converts the video signal into digital image data. The first image enlarging/reducing unit 1402 performs, for example, a format conversion process and an image enlargement/reduction process on the image data. The second image enlarging/reducing unit 1403 performs an image enlargement/reduction process on the image data according to a format of a destination to which the image data is output through the video output processing unit 1404 or performs the format conversion process and the image enlargement/reduction process which are identical to those of the first image enlarging/reducing unit 1402 on the image data. The video output processing unit 1404 performs format conversion and conversion into an analog signal on the image data, and outputs a reproduced video signal to, for example, the connectivity 1321 (FIG. 44) or the like.

The frame memory 1405 is an image data memory that is shared by the video input processing unit 1401, the first image enlarging/reducing unit 1402, the second image enlarging/reducing unit 1403, the video output processing unit 1404, and the encoding/decoding engine 1407. The frame memory 1405 is implemented as, for example, a semiconductor memory such as a DRAM.

The memory control unit 1406 receives a synchronous signal from the encoding/decoding engine 1407, and controls writing/reading access to the frame memory 1405 according to an access schedule for the frame memory 1405 written in an access management table 1406A. The access management table 1406A is updated through the memory control unit 1406 according to processing executed by the encoding/decoding engine 1407, the first image enlarging/reducing unit 1402, the second image enlarging/reducing unit 1403, or the like.

The encoding/decoding engine 1407 performs an encoding process of encoding image data and a decoding process of decoding a video stream that is data obtained by encoding image data. For example, the encoding/decoding engine 1407 encodes image data read from the frame memory 1405, and sequentially writes the encoded image data in the video ES buffer 1408A as a video stream. Further, for example, the encoding/decoding engine 1407 sequentially reads the video stream from the video ES buffer 1408B, sequentially decodes the video stream, and sequentially writes the decoded image data in the frame memory 1405. The encoding/decoding engine 1407 uses the frame memory 1405 as a working area at the time of the encoding or the decoding. Further, the encoding/decoding engine 1407 outputs the synchronous signal to the memory control unit 1406, for example, at a timing at which processing of each macroblock starts.

The video ES buffer 1408A buffers the video stream generated by the encoding/decoding engine 1407, and then provides the video stream to the multiplexer (MUX) 1412. The video ES buffer 1408B buffers the video stream provided from the demultiplexer (DMUX) 1413, and then provides the video stream to the encoding/decoding engine 1407.

The audio ES buffer 1409A buffers an audio stream generated by the audio encoder 1410, and then provides the audio stream to the multiplexer (MUX) 1412. The audio ES buffer 1409B buffers an audio stream provided from the demultiplexer (DMUX) 1413, and then provides the audio stream to the audio decoder 1411.

For example, the audio encoder 1410 converts an audio signal input from, for example, the connectivity 1321 (FIG. 44) or the like into a digital signal, and encodes the digital signal according to a certain scheme such as an MPEG audio scheme or an AudioCode number 3 (AC3) scheme. The audio encoder 1410 sequentially writes the audio stream that is data obtained by encoding the audio signal in the audio ES buffer 1409A. The audio decoder 1411 decodes the audio stream provided from the audio ES buffer 1409B, performs, for example, conversion into an analog signal, and provides a reproduced audio signal to, for example, the connectivity 1321 (FIG. 44) or the like.

The multiplexer (MUX) 1412 performs multiplexing of the video stream and the audio stream. A multiplexing method (that is, a format of a bitstream generated by multiplexing) is arbitrary. Further, at the time of multiplexing, the multiplexer (MUX) 1412 may add certain header information or the like to the bitstream. In other words, the multiplexer (MUX) 1412 may convert a stream format by multiplexing. For example, the multiplexer (MUX) 1412 multiplexes the video stream and the audio stream to be converted into a transport stream that is a bitstream of a transfer format. Further, for example, the multiplexer (MUX) 1412 multiplexes the video stream and the audio stream to be converted into data (file data) of a recording file format.

The demultiplexer (DMUX) 1413 demultiplexes the bitstream obtained by multiplexing the video stream and the audio stream by a method corresponding to the multiplexing performed by the multiplexer (MUX) 1412. In other words, the demultiplexer (DMUX) 1413 extracts the video stream and the audio stream (separates the video stream and the audio stream) from the bitstream read from the stream buffer 1414. In other words, the demultiplexer (DMUX) 1413 can perform conversion (inverse conversion of conversion performed by the multiplexer (MUX) 1412) of a format of a stream through the demultiplexing. For example, the demultiplexer (DMUX) 1413 can acquire the transport stream provided from, for example, the connectivity 1321 or the broadband modem 1333 (both FIG. 44) through the stream buffer 1414 and convert the transport stream into a video stream and an audio stream through the demultiplexing. Further, for example, the demultiplexer (DMUX) 1413 can acquire file data read from various kinds of recording media (FIG. 44) by, for example, the connectivity 1321 through the stream buffer 1414 and converts the file data into a video stream and an audio stream by the demultiplexing.

The stream buffer 1414 buffers the bitstream. For example, the stream buffer 1414 buffers the transport stream provided from the multiplexer (MUX) 1412, and provides the transport stream to, for example, the connectivity 1321 or the broadband modem 1333 (both FIG. 44) at a certain timing or based on an external request or the like.

Further, for example, the stream buffer 1414 buffers file data provided from the multiplexer (MUX) 1412, provides the file data to, for example, the connectivity 1321 (FIG. 44) or the like at a certain timing or based on an external request or the like, and causes the file data to be recorded in various kinds of recording media.

Furthermore, the stream buffer 1414 buffers the transport stream acquired through, for example, the connectivity 1321 or the broadband modem 1333 (both FIG. 44), and provides the transport stream to the demultiplexer (DMUX) 1413 at a certain timing or based on an external request or the like.

Further, the stream buffer 1414 buffers file data read from various kinds of recording media in, for example, the connectivity 1321 (FIG. 44) or the like, and provides the file data to the demultiplexer (DMUX) 1413 at a certain timing or based on an external request or the like.

Next, an operation of the video processor 1332 having the above configuration will be described. The video signal input to the video processor 1332, for example, from the connectivity 1321 (FIG. 44) or the like is converted into digital image data according to a certain scheme such as a 4:2:2Y/Cb/Cr scheme in the video input processing unit 1401 and sequentially written in the frame memory 1405. The digital image data is read out to the first image enlarging/reducing unit 1402 or the second image enlarging/reducing unit 1403, subjected to a format conversion process of performing a format conversion into a certain scheme such as a 4:2:0Y/Cb/Cr scheme and an enlargement/reduction process, and written in the frame memory 1405 again. The image data is encoded by the encoding/decoding engine 1407, and written in the video ES buffer 1408A as a video stream.

Further, an audio signal input to the video processor 1332 from the connectivity 1321 (FIG. 44) or the like is encoded by the audio encoder 1410, and written in the audio ES buffer 1409A as an audio stream.

The video stream of the video ES buffer 1408A and the audio stream of the audio ES buffer 1409A are read out to and multiplexed by the multiplexer (MUX) 1412, and converted into a transport stream, file data, or the like. The transport stream generated by the multiplexer (MUX) 1412 is buffered in the stream buffer 1414, and then output to an external network through, for example, the connectivity 1321 or the broadband modem 1333 (both FIG. 44). Further, the file data generated by the multiplexer (MUX) 1412 is buffered in the stream buffer 1414, then output to, for example, the connectivity 1321 (FIG. 44) or the like, and recorded in various kinds of recording media.

Further, the transport stream input to the video processor 1332 from an external network through, for example, the connectivity 1321 or the broadband modem 1333 (both FIG. 44) is buffered in the stream buffer 1414 and then demultiplexed by the demultiplexer (DMUX) 1413. Further, the file data that is read from various kinds of recording media in, for example, the connectivity 1321 (FIG. 44) or the like and then input to the video processor 1332 is buffered in the stream buffer 1414 and then demultiplexed by the demultiplexer (DMUX) 1413. In other words, the transport stream or the file data input to the video processor 1332 is demultiplexed into the video stream and the audio stream through the demultiplexer (DMUX) 1413.

The audio stream is provided to the audio decoder 1411 through the audio ES buffer 1409B and decoded, and so an audio signal is reproduced. Further, the video stream is written in the video ES buffer 1408B, sequentially read out to and decoded by the encoding/decoding engine 1407, and written in the frame memory 1405. The decoded image data is subjected to the enlargement/reduction process performed by the second image enlarging/reducing unit 1403, and written in the frame memory 1405. Then, the decoded image data is read out to the video output processing unit 1404, subjected to the format conversion process of performing format conversion to a certain scheme such as a 4:2:2Y/Cb/Cr scheme, and converted into an analog signal, and so a video signal is reproduced.

When the present technology is applied to the video processor 1332 having the above configuration, it is preferable that the above embodiments of the present technology be applied to the encoding/decoding engine 1407. In other words, for example, the encoding/decoding engine 1407 preferably has the function of the scalable encoding device 100 (FIG. 9) according to the first embodiment or the scalable decoding device 200 (FIG. 24) according to the second embodiment. Accordingly, the video processor 1332 can obtain the same effects as the effects described above with reference to FIGS. 1 to 33.

Further, in the encoding/decoding engine 1407, the present technology (that is, the functions of the scalable encoding devices or the scalable decoding devices according to the above embodiments) may be implemented by either or both of hardware such as a logic circuit or software such as an embedded program.

<Another Exemplary Configuration of Video Processor>

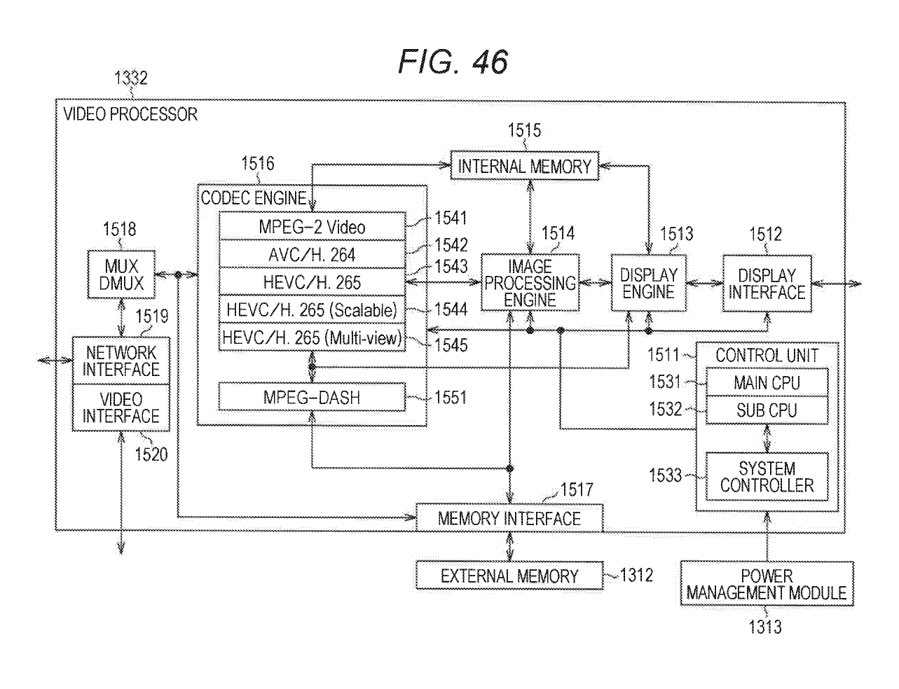

FIG. 46 illustrates another exemplary schematic configuration of the video processor 1332 (FIG. 44) to which the present technology is applied. In the case of the example of FIG. 46 the video processor 1332 has a function of encoding and decoding video data according to a certain scheme.

More specifically, the video processor 1332 includes a control unit 1511, a display interface 1512, a display engine 1513, an image processing engine 1514, and an internal memory 1515 as illustrated in FIG. 46. The video processor 1332 further includes a codec engine 1516, a memory interface 1517, a multiplexing/demultiplexing unit (MUX DMUX) 1518, a network interface 1519, and a video interface 1520.

The control unit 1511 controls an operation of each processing unit in the video processor 1332 such as the display interface 1512, the display engine 1513, the image processing engine 1514, and the codec engine 1516.

The control unit 1511 includes, for example, a main CPU 1531, a sub CPU 1532, and a system controller 1533 as illustrated in FIG. 46. The main CPU 1531 executes, for example, a program for controlling an operation of each processing unit in the video processor 1332. The main CPU 1531 generates a control signal, for example, according to the program, and provides the control signal to each processing unit (that is, controls an operation of each processing unit). The sub CPU 1532 plays a supplementary role of the main CPU 1531. For example, the sub CPU 1532 executes a child process or a subroutine of a program executed by the main CPU 1531. The system controller 1533 controls operations of the main CPU 1531 and the sub CPU 1532, for example, designates a program executed by the main CPU 1531 and the sub CPU 1532.

The display interface 1512 outputs image data to, for example, the connectivity 1321 (FIG. 44) or the like under control of the control unit 1511. For example, the display interface 1512 converts image data of digital data into an analog signal, and outputs the analog signal to, for example, the monitor device of the connectivity 1321 (FIG. 44), as a reproduced video signal or the image data of the digital data without change.

The display engine 1513 performs various kinds of conversion processes such as a format conversion process, a size conversion process, and a color gamut conversion process on the image data under control of the control unit 1511 to comply with, for example, a hardware specification of the monitor device that displays the image.

The image processing engine 1514 performs certain image processing such as a filtering process for improving an image quality on the image data under control of the control unit 1511.

The internal memory 1515 is a memory that is installed in the video processor 1332 and shared by the display engine 1513, the image processing engine 1514, and the codec engine 1516. The internal memory 1515 is used for data transfer performed among, for example, the display engine 1513, the image processing engine 1514, and the codec engine 1516. For example, the internal memory 1515 stores data provided from the display engine 1513, the image processing engine 1514, or the codec engine 1516, and provides the data to the display engine 1513, the image processing engine 1514, or the codec engine 1516 as necessary (for example, according to a request). The internal memory 1515 can be implemented by any storage device, but since the internal memory 1515 is mostly used for storage of small-capacity data such as image data of block units or parameters, it is desirable to implement the internal memory 1515 using a semiconductor memory that is relatively small in capacity (for example, compared to the external memory 1312) and fast in response speed such as a static random access memory (SRAM).

The codec engine 1516 performs processing related to encoding and decoding of image data. An encoding/decoding scheme supported by the codec engine 1516 is arbitrary, and one or more schemes may be supported by the codec engine 1516. For example, the codec engine 1516 may have a codec function of supporting a plurality of encoding/decoding schemes and perform encoding of image data or decoding of encoded data using a scheme selected from among the schemes.

In the example illustrated in FIG. 46, the codec engine 1516 includes, for example, an MPEG-2 Video 1541, an AVC/H.264 1542, a HEVC/H.265 1543, a HEVC/H.265 (Scalable) 1544, a HEVC/H.265 (Multi-view) 1545, and an MPEG-DASH 1551 as functional blocks of processing related to a codec.

The MPEG-2 Video 1541 is a functional block of encoding or decoding image data according to an MPEG-2 scheme. The AVC/H.264 1542 is a functional block of encoding or decoding image data according to an AVC scheme. The HEVC/H.265 1543 is a functional block of encoding or decoding image data according to a HEVC scheme. The HEVC/H.265 (Scalable) 1544 is a functional block of performing scalable coding or scalable decoding on image data according to a HEVC scheme. The HEVC/H.265 (Multi-view) 1545 is a functional block of performing multi-view encoding or multi-view decoding on image data according to a HEVC scheme.

The MPEG-DASH 1551 is a functional block of transmitting and receiving image data according to an MPEG-Dynamic Adaptive Streaming over HTTP (MPEG-DASH) scheme. The MPEG-DASH is a technique of streaming a video using a HyperText Transfer Protocol (HTTP), and has a feature of selecting appropriate one from among a plurality of pieces of encoded data that differ in a previously prepared resolution or the like in units of segments and transmitting a selected one. The MPEG-DASH 1551 performs generation of a stream complying with a standard, transmission control of the stream, and the like, and uses the MPEG-2 Video 1541 to the HEVC/H.265 (Multi-view) 1545 for encoding and decoding of image data.

The memory interface 1517 is an interface for the external memory 1312. Data provided from the image processing engine 1514 or the codec engine 1516 is provided to the external memory 1312 through the memory interface 1517. Further, data read from the external memory 1312 is provided to the video processor 1332 (the image processing engine 1514 or the codec engine 1516) through the memory interface 1517.

The multiplexing/demultiplexing unit (MUX DMUX) 1518 performs multiplexing and demultiplexing of various kinds of data related to an image such as a bitstream of encoded data, image data, and a video signal. The multiplexing/demultiplexing method is arbitrary. For example, at the time of multiplexing, the multiplexing/demultiplexing unit (MUX DMUX) 1518 can not only combine a plurality of data into one but also add certain header information or the like to the data. Further, at the time of demultiplexing, the multiplexing/demultiplexing unit (MUX DMUX) 1518 can not only divide one data into a plurality of data but also add certain header information or the like to each divided data. In other words, the multiplexing/demultiplexing unit (MUX DMUX) 1518 can converts a data format through multiplexing and demultiplexing. For example, the multiplexing/demultiplexing unit (MUX DMUX) 1518 can multiplex a bitstream to be converted into a transport stream serving as a bitstream of a transfer format or data (file data) of a recording file format. Of course, inverse conversion can be also performed through demultiplexing.

The network interface 1519 is an interface for, for example, the broadband modem 1333 or the connectivity 1321 (both FIG. 44). The video interface 1520 is an interface for, for example, the connectivity 1321 or the camera 1322 (both FIG. 44).

Next, an exemplary operation of the video processor 1332 will be described. For example, when the transport stream is received from the external network through, for example, the connectivity 1321 or the broadband modem 1333 (both FIG. 44), the transport stream is provided to the multiplexing/demultiplexing unit (MUX DMUX) 1518 through the network interface 1519, demultiplexed, and then decoded by the codec engine 1516. Image data obtained by the decoding of the codec engine 1516 is subjected to certain image processing performed, for example, by the image processing engine 1514, subjected to certain conversion performed by the display engine 1513, and provided to, for example, the connectivity 1321 (FIG. 44) or the like through the display interface 1512, and so the image is displayed on the monitor. Further, for example, image data obtained by the decoding of the codec engine 1516 is encoded by the codec engine 1516 again, multiplexed by the multiplexing/demultiplexing unit (MUX DMUX) 1518 to be converted into file data, output to, for example, the connectivity 1321 (FIG. 44) or the like through the video interface 1520, and then recorded in various kinds of recording media.

Furthermore, for example, file data of encoded data obtained by encoding image data read from a recording medium (not illustrated) through the connectivity 1321 (FIG. 44) or the like is provided to the multiplexing/demultiplexing unit (MUX DMUX) 1518 through the video interface 1520, and demultiplexed, and decoded by the codec engine 1516. Image data obtained by the decoding of the codec engine 1516 is subjected to certain image processing performed by the image processing engine 1514, subjected to certain conversion performed by the display engine 1513, and provided to, for example, the connectivity 1321 (FIG. 44) or the like through the display interface 1512, and so the image is displayed on the monitor. Further, for example, image data obtained by the decoding of the codec engine 1516 is encoded by the codec engine 1516 again, multiplexed by the multiplexing/demultiplexing unit (MUX DMUX) 1518 to be converted into a transport stream, provided to, for example, the connectivity 1321 or the broadband modem 1333 (both FIG. 44) through the network interface 1519, and transmitted to another device (not illustrated).

Further, transfer of image data or other data between the processing units in the video processor 1332 is performed, for example, using the internal memory 1515 or the external memory 1312. Furthermore, the power management module 1313 controls, for example, power supply to the control unit 1511.

When the present technology is applied to the video processor 1332 having the above configuration, it is desirable to apply the above embodiments of the present technology to the codec engine 1516. In other words, for example, it is preferable that the codec engine 1516 have a functional block of implementing the scalable encoding device 100 (FIG. 9) according to the first embodiment and the scalable decoding device 200 (FIG. 24) according to the second embodiment. By operating as described above, the video processor 1332 can have the same effects as the effects described above with reference to FIGS. 1 to 33.

Further, in the codec engine 1516, the present technology (that is, the functions of the image encoding devices or the image decoding devices according to the above embodiments) may be implemented by either or both of hardware such as a logic circuit or software such as an embedded program.

The two exemplary configurations of the video processor 1332 have been described above, but the configuration of the video processor 1332 is arbitrary and may have any configuration other than the above two exemplary configurations. Further, the video processor 1332 may be configured with a single semiconductor chip or may be configured with a plurality of semiconductor chips. For example, the video processor 1332 may be configured with a three-dimensionally stacked LSI in which a plurality of semiconductors are stacked. Further, the video processor 1332 may be implemented by a plurality of LSIs.

### Application Examples to Devices

The video set 1300 may be incorporated into various kinds of devices that process image data. For example, the video set 1300 may be incorporated into the television device 900 (FIG. 37), the mobile telephone 920 (FIG. 38), the recording/reproducing device 940 (FIG. 39), the imaging device 960 (FIG. 40), or the like. As the video set 1300 is incorporated, the devices can have the same effects as the effects described above with reference to FIGS. 1 to 33.

Further, the video set 1300 may be also incorporated into a terminal device such as the personal computer 1004, the AV device 1005, the tablet device 1006, or the mobile telephone 1007 in the data transmission system 1000 of FIG. 41, the broadcasting station 1101 or the terminal device 1102 in the data transmission system 1100 of FIG. 42, or the imaging device 1201 or the scalable encoded data storage device 1202 in the imaging system 1200 of FIG. 43. As the video set 1300 is incorporated, the devices can have the same effects as the effects described above with reference to FIGS. 1 to 33.

Further, even each component of the video set 1300 can be implemented as a component to which the present technology is applied when the component includes the video processor 1332. For example, only the video processor 1332 can be implemented as a video processor to which the present technology is applied. Further, for example, the processors indicated by the dotted line 1341 as described above, the video module 1311, or the like can be implemented as, for example, a processor or a module to which the present technology is applied. Further, for example, a combination of the video module 1311, the external memory 1312, the power management module 1313, and the front end module 1314 can be implemented as a video unit 1361 to which the present technology is applied. These configurations can have the same effects as the effects described above with reference to FIGS. 1 to 33.

In other words, a configuration including the video processor 1332 can be incorporated into various kinds of devices that process image data, similarly to the case of the video set 1300. For example, the video processor 1332, the processors indicated by the dotted line 1341, the video module 1311, or the video unit 1361 can be incorporated into the television device 900 (FIG. 37), the mobile telephone 920 (FIG. 38), the recording/reproducing device 940 (FIG. 39), the imaging device 960 (FIG. 40), the terminal device such as the personal computer 1004, the AV device 1005, the tablet device 1006, or the mobile telephone 1007 in the data transmission system 1000 of FIG. 41, the broadcasting station 1101 or the terminal device 1102 in the data transmission system 1100 of FIG. 42, the imaging device 1201 or the scalable encoded data storage device 1202 in the imaging system 1200 of FIG. 43, or the like. Further, as the configuration to which the present technology is applied, the devices can have the same effects as the effects described above with reference to FIGS. 1 to 33, similarly to the video set 1300.

The present technology can be also applied to a system of selecting an appropriate data from among a plurality of pieces of encoded data having different resolutions that are prepared in advance in units of segments and using the selected data, for example, a content reproducing system of HTTP streaming or a wireless communication system of the Wi-Fi standard such as MPEG DASH which will be described later.

In the present specification, the description has been made in connection with the example in which various kinds of information is multiplexed into encoded stream and transmitted from an encoding side to a decoding side. However, the technique of transmitting the information is not limited to this example. For example, the information may be transmitted or recorded as individual data associated with encoded bit stream without being multiplexed into encoded bit stream. Here, a term “associated” means that an image (or a part of an image such as a slice or a block) included in a bitstream can be linked with information corresponding to the image at the time of decoding. In other words, the information may be transmitted through a transmission path different from that for the image (or bit stream). Further, the information may be recorded in a recording medium (or a different recording area of the same recording medium) different from that for the image (orbit stream). Furthermore, the information and the image (or bit stream) may be associated with each other, for example, in units of a plurality of frames, a frame, or arbitrary units such as parts of a frame.

The preferred embodiments of the present disclosure have been described above with reference to the accompanying drawings, whilst the present invention is not limited to the above examples. A person skilled in the art may find various alterations and modifications within the scope of the appended claims, and it should be understood that they will naturally come under the technical scope of the present disclosure.

The present technology can have the following configurations as well.

(1)

An image encoding device, including:

an acquisition unit that acquires inter-layer information indicating whether or not an image of a reference layer referred to by a current image that is subject to an encoding process is a skip mode when the encoding process is performed on an image including three or more layers; and

an inter-layer information setting unit that sets the current image as the skip mode when the image of the reference layer is the skip mode with reference to the inter-layer information acquired by the acquisition unit, and prohibits execution of the encoding process.

(2)

The image encoding device according to (1),

wherein the acquisition unit acquires inter-layer information indicating whether or not a picture of a reference layer referred to by a current picture that is subject to the encoding process is a skip picture, and

the inter-layer information setting unit sets the current picture as the skip picture when the picture of the reference layer is the skip picture, and prohibits execution of the encoding process.

(3)

The image encoding device according to (1),

wherein the acquisition unit acquires inter-layer information indicating whether or not a slice of a reference layer referred to by a current slice that is subject to the encoding process is a skip slice, and

the inter-layer information setting unit sets the current slice as the skip slice when the slice of the reference layer is the skip slice, and prohibits execution of the encoding process.

(4)

The image encoding device according to (1),

wherein the acquisition unit acquires inter-layer information indicating whether or not a tile of a reference layer referred to by a current tile that is subject to the encoding process is a skip tile, and

the inter-layer information setting unit sets the current tile as the skip tile when the tile of the reference layer is the skip tile, and prohibits execution of the encoding process.

(5)

The image encoding device according to any one of (1) to (4)

wherein, only when the reference layer and a current layer that is subject to the encoding process are subject to spatial scalability, if the image of reference layer is the skip mode, the inter-layer information setting unit sets the current image as the skip mode, and prohibits execution of the encoding process.

(6)

The image encoding device according to any one of (1) to (5)

wherein, when the reference layer and a current layer that is subject to the encoding process are subject to spatial scalability, but the reference layer and a layer referred to by the reference layer are subject to SNR scalability, although the image of the reference layer is the skip mode, the inter-layer information setting unit sets the current image as the skip mode, and permits execution of the encoding process.

(7)

An image encoding method, including:

acquiring, by an image encoding device, inter-layer information indicating whether or not an image of a reference layer referred to by a current image that is subject to an encoding process is a skip mode when the encoding process is performed on an image including three or more layers, and setting, by the image encoding device, the current image as the skip mode when the image of the reference layer is the skip mode with reference to the acquired inter-layer information and prohibiting execution of the encoding process.

(8)

An image decoding device, including:

an acquisition unit that acquires inter-layer information indicating whether or not an image of a reference layer referred to by a current image that is subject to a decoding process is a skip mode when the decoding process is performed on a bit stream including an encoded image including three or more layers; and

an inter-layer information setting unit that sets the current image as the skip mode when the image of the reference layer is the skip mode with reference to the inter-layer information acquired by the acquisition unit, and prohibits execution of the decoding process.

(9)

The image decoding device according to (8)

wherein the acquisition unit acquires inter-layer information indicating whether or not a picture of a reference layer referred to by a current picture that is subject to the decoding process is a skip picture, and

the inter-layer information setting unit sets the current picture as the skip picture when the picture of the reference layer is the skip picture, and prohibits execution of the decoding process.

(10)

The image decoding device according to (8)

wherein the acquisition unit acquires inter-layer information indicating whether or not a slice of a reference layer referred to by a current slice that is subject to the decoding process is a skip slice, and

the inter-layer information setting unit sets the current slice as the skip slice when the slice of the reference layer is the skip slice, and prohibits execution of the decoding process.

(11)

The image decoding device according to (8)

wherein the acquisition unit acquires inter-layer information indicating whether or not a tile of a reference layer referred to by a current tile that is subject to the decoding process is a skip tile, and

the inter-layer information setting unit sets the current tile as the skip tile when the tile of the reference layer is the skip tile, and prohibits execution of the decoding process.

(12)

The image decoding device according to any one of (8) to (11)

wherein, only when the reference layer and a current layer that is subject to the decoding process are subject to spatial scalability, if the image of reference layer is the skip mode, the inter-layer information setting unit sets the current image as the skip mode, and prohibits execution of the decoding process.

(13)

The image decoding device according to any one of (8) to (11)

wherein, when the reference layer and a current layer that is subject to the decoding process are subject to spatial scalability, but the reference layer and a layer referred to by the reference layer are subject to SNR scalability, although the image of the reference layer is the skip mode, the inter-layer information setting unit sets the current image as the skip mode, and permits execution of the decoding process.

(14)

An image decoding method, including:

acquiring, by an image decoding device, inter-layer information indicating whether or not an image of a reference layer referred to by a current image that is subject to a decoding process is a skip mode when the encoding process is performed on a bit stream including an encoded image including three or more layers; and

setting, by the image decoding device, the current image as the skip mode when the image of the reference layer is the skip mode with reference to the acquired inter-layer information and prohibiting execution of the decoding process.

(15)

An image encoding device, including:

an acquisition unit that acquires inter-layer information indicating the number of layers of an image including 64 or more layers when an encoding process is performed on the image; and

an inter-layer information setting unit that sets information related to an extended number of layers in VPS_extension with reference to the inter-layer information acquired by the acquisition unit.

(16)

The image encoding device according to (15)

wherein the inter-layer information setting unit sets a syntax element layer_extension_factor_minus1 in VPS_extension, and (vps_max_layers_minus1+1)*(layer_extension_factor_minus1+1) is the number of layers of the image.

(17)

The image encoding device according to (16)

wherein the inter-layer information setting unit sets information related to a layer set in VPS_extension when a value of layer_extension_factor_minus1 is not 0.

(18)

The image encoding device according to (16)

wherein the inter-layer information setting unit sets layer_extension_flag in a video parameter set (VPS), and sets a syntax element layer_extension_factor_minus1 in VPS_extension only when a value of layer_extension_flag is 1.

(19)

An image encoding method, including:

acquiring, by an image encoding device, inter-layer information indicating the number of layers of an image including 64 or more layers when an encoding process is performed on the image; and

setting, by the image encoding device, information related to the extended number of layers in VPS_extension with reference to the acquired inter-layer information.

(20)

An image decoding device, including:

a reception unit that receives information related to an extended number of layers set in VPS_extension from a bit stream including an encoded image including 64 or more layers; and

a decoding unit that performs a decoding process with reference to the information related to the extended number of layers received by the reception unit.

(21)

The image decoding device according to (20)

wherein the reception unit receives a syntax element layer_extension_factor_minus1 in VPS_extension, and (vps_max_layers_minus1+1)*(layer_extension_factor_minus1+1) is the number of layers of the image.

(22)

The image decoding device according to (21)

wherein the reception unit receives information related to a layer set in VPS_extension when a value of layer_extension_factor_minus1 is not 0.

(23)

The image decoding device according to (21)

wherein the reception unit receives layer_extension_flag in a video parameter set (VPS), and receives a syntax element layer_extension_factor_minus1 in VPS_extension only when a value of layer_extension_flag is 1.

(24)

An image decoding method, including:

receiving, by an image decoding device, information related to an extended number of layers set in VPS_extension from a bit stream including an encoded image including 64 or more layers; and

performing, by the image decoding device, a decoding process with reference to the information related to the received extended number of layers.

### REFERENCE SIGNS LIST

100 Scalable encoding device
101 Common information generation unit
102 Encoding control unit
103 Base layer image encoding unit
104 Motion information encoding unit
104, 104-1, 104-2 Enhancement layer image encoding unit
116 Lossless encoding unit
125 Motion prediction/compensation unit
135 Motion prediction/compensation unit
140 Inter-layer information setting unit
151 Reference layer picture type buffer
152 Skip picture setting unit
181 Layer dependency relation buffer
182 Extension layer setting unit
200 Scalable decoding device
201 Common information acquisition unit
202 Decoding control unit
203 Base layer image decoding unit
204, 204-1, 204-2 Enhancement layer image decoding unit
212 Lossless decoding unit
222 Motion compensation unit
232 Motion compensation unit
240 Inter-layer information reception unit
251 Reference layer picture type buffer
252 Skip picture reception unit
281 Layer dependency relation buffer
282 Extension layer reception unit

1. An image encoding device, comprising:
an acquisition unit that acquires inter-layer information indicating whether or not an image of a reference layer referred to by a current image that is subject to an encoding process is a skip mode when the encoding process is performed on an image including three or more layers; and
an inter-layer information setting unit that sets the current image as the skip mode when the image of the reference layer is the skip mode with reference to the inter-layer information acquired by the acquisition unit, and prohibits execution of the encoding process.

2. The image encoding device according to claim 1,
wherein the acquisition unit acquires inter-layer information indicating whether or not a picture of a reference layer referred to by a current picture that is subject to the encoding process is a skip picture, and
the inter-layer information setting unit sets the current picture as the skip picture when the picture of the reference layer is the skip picture, and prohibits execution of the encoding process.

3. The image encoding device according to claim 1,
wherein the acquisition unit acquires inter-layer information indicating whether or not a slice of a reference layer referred to by a current slice that is subject to the encoding process is a skip slice, and
the inter-layer information setting unit sets the current slice as the skip slice when the slice of the reference layer is the skip slice, and prohibits execution of the encoding process.

4. The image encoding device according to claim 1,
wherein the acquisition unit acquires inter-layer information indicating whether or not a tile of a reference layer referred to by a current tile that is subject to the encoding process is a skip tile, and
the inter-layer information setting unit sets the current tile as the skip tile when the tile of the reference layer is the skip tile, and prohibits execution of the encoding process.

5. The image encoding device according to claim 1,
wherein, only when the reference layer and a current layer that is subject to the encoding process are subject to spatial scalability, if the image of reference layer is the skip mode, the inter-layer information setting unit sets the current image as the skip mode, and prohibits execution of the encoding process.

6. The image encoding device according to claim 1,
wherein, when the reference layer and a current layer that is subject to the encoding process are subject to spatial scalability, but the reference layer and a layer referred to by the reference layer are subject to SNR scalability, although the image of the reference layer is the skip mode, the inter-layer information setting unit sets the current image as the skip mode, and permits execution of the encoding process.

7. An image encoding method, comprising:
acquiring, by an image encoding device, inter-layer information indicating whether or not an image of a reference layer referred to by a current image that is subject to an encoding process is a skip mode when the encoding process is performed on an image including three or more layers, and
setting, by an image encoding device, the current image as the skip mode when the image of the reference layer is the skip mode with reference to the acquired inter-layer information and prohibiting execution of the encoding.

8. An image decoding device, comprising:
an acquisition unit that acquires inter-layer information indicating whether or not an image of a reference layer referred to by a current image that is subject to a decoding process is a skip mode when the decoding process is performed on a bit stream including an encoded image including three or more layers; and
an inter-layer information setting unit that sets the current image as the skip mode when the image of the reference layer is the skip mode with reference to the inter-layer information acquired by the acquisition unit, and prohibits execution of the decoding process.

9. The image decoding device according to claim 8,
wherein the acquisition unit acquires inter-layer information indicating whether or not a picture of a reference layer referred to by a current picture that is subject to the decoding process is a skip picture, and
the inter-layer information setting unit sets the current picture as the skip picture when the picture of the reference layer is the skip picture, and prohibits execution of the decoding process.

10. The image decoding device according to claim 8,
wherein the acquisition unit acquires inter-layer information indicating whether or not a slice of a reference layer referred to by a current slice that is subject to the decoding process is a skip slice, and
the inter-layer information setting unit sets the current slice as the skip slice when the slice of the reference layer is the skip slice, and prohibits execution of the decoding process.

11. The image decoding device according to claim 8,
wherein the acquisition unit acquires inter-layer information indicating whether or not a tile of a reference layer referred to by a current tile that is subject to the decoding process is a skip tile, and
the inter-layer information setting unit sets the current tile as the skip tile when the tile of the reference layer is the skip tile, and prohibits execution of the decoding process.

12. The image decoding device according to claim 8,
wherein, only when the reference layer and a current layer that is subject to the decoding process are subject to spatial scalability, if the image of reference layer is the skip mode, the inter-layer information setting unit sets the current image as the skip mode, and prohibits execution of the decoding process.

13. The image decoding device according to claim 8,
wherein, when the reference layer and a current layer that is subject to the decoding process are subject to spatial scalability, but the reference layer and a layer referred to by the reference layer are subject to SNR scalability, although the image of the reference layer is the skip mode, the inter-layer information setting unit sets the current image as the skip mode, and permits execution of the decoding process.

14. An image decoding method, comprising:
acquiring, by an image decoding device, inter-layer information indicating whether or not an image of a reference layer referred to by a current image that is subject to a decoding process is a skip mode when the decoding process is performed on a bit stream including an encoded image including three or more layers; and
setting, by the image decoding device, the current image as the skip mode when the image of the reference layer is the skip mode with reference to the acquired inter-layer information and prohibiting execution of the decoding process.

15. An image encoding device, comprising:
an acquisition unit that acquires inter-layer information indicating the number of layers of an image including 64 or more layers when an encoding process is performed on the image; and
an inter-layer information setting unit that sets information related to an extended number of layers in VPS_extension with reference to the inter-layer information acquired by the acquisition unit.

16. The image encoding device according to claim 15,
wherein the inter-layer information setting unit sets a syntax element layer_extension_factor_minus1 in VPS_extension, and (vps_max_layers_minus1+1)*(layer_extension_factor_minus1+1) is the number of layers of the image.

17. The image encoding device according to claim 16,
wherein the inter-layer information setting unit sets information related to a layer set in VPS_extension when a value of layer_extension_factor_minus1 is not 0.

18. The image encoding device according to claim 16,
wherein the inter-layer information setting unit sets layer_extension_flag in a video parameter set (VPS), and sets a syntax element layer_extension_factor_minus1 in VPS_extension only when a value of layer_extension_flag is 1.

19. An image encoding method, comprising:
acquiring, by an image encoding device, inter-layer information indicating the number of layers of an image including 64 or more layers when an encoding process is performed on the image; and
setting, by the image encoding device, information related to the extended number of layers in VPS_extension with reference to the acquired inter-layer information.

20. An image decoding device, comprising:
a reception unit that receives information related to an extended number of layers set in VPS_extension from a bit stream including an encoded image including 64 or more layers; and
a decoding unit that performs a decoding process with reference to the information related to the extended number of layers received by the reception unit.

21. The image decoding device according to claim 20,
wherein the reception unit receives a syntax element layer_extension_factor_minus1 in VPS_extension, and (vps_max_layers_minus1+1)*(layer_extension_factor_minus1+1) is the number of layers of the image.

22. The image decoding device according to claim 21,
wherein the reception unit receives information related to a layer set in VPS_extension when a value of layer_extension_factor_minus1 is not 0.

23. The image decoding device according to claim 21,
wherein the reception unit receives layer_extension_flag in a video parameter set (VPS), and receives a syntax element layer_extension_factor_minus1 in VPS_extension only when a value of layer_extension_flag is 1.

24. An image decoding method, comprising:
receiving, by an image decoding device, information related to an extended number of layers set in VPS_extension from a bit stream including an encoded image including 64 or more layers; and
performing, by the image decoding device, a decoding process with reference to the information related to the received extended number of layers.
